(19) United States
(12) Patent Application Publication
(10) Pub. No.: US 2016/0280607 A1
(43) Pub. Date: Sep. 29, 2016

(54) METHODS OF MANUFACTURING POLYMER DERIVED CERAMIC PARTICLES.

(71) Applicant: Melior Innovations, Inc., Houston, TX (US)

(72) Inventors: Mark S. Land, Houston, TX (US); Ashish Diwanji, New Albany, OH (US); Walter J. Sherwood, Glenville, NY (US); Andrew Hopkins, Houston, TX (US); Glenn Sandgren, Ambler, PA (US); Michael J. Mueller, Katy, TX (US); Yi Tan, Houston, TX (US); Charles C. Rinzler, Cambridge, MA (US); Douglas Dukes, Troy, NY (US)

(73) Assignee: Melior Innovations, Inc., Houston, TX (US)

(21) Appl. No.: 15/002,773

(22) Filed: Jan. 21, 2016

Related U.S. Application Data
(63) Continuation-in-part of application No. 14/268,150, filed on May 2, 2014.
Application No. 14/268,150 is a continuation of application No. 14/634,814, filed on Feb. 28, 2015.
(60) Provisional application No. 62/106,094, filed on Jan. 21, 2015.
(60) Provisional application No. 61/818,906, filed on May 2, 2013.
(60) Provisional application No. 61/818,981, filed on May 3, 2013.
(60) Provisional application No. 61/843,014, filed on Jul. 4, 2013.
(60) Provisional application No. 61/946,598, filed on Feb. 28, 2014.

(51) Int. Cl. C04B 35/65; B01J 2/04; B01J 2/06; C04B 35/571

(52) U.S. Cl. CPC C04B 35/65; C04B 35/571; B01J 2/04; B01J 2/06

(57) ABSTRACT

Methods for forming small volumetric shapes of polymer derived ceramic materials, including liquid-liquid forming methods, tower forming methods, and methods using high intensity electromagnetic radiation to cure the liquid to a cured preform material. Systems and apparatus for forming small volumetric shapes of polymer derived ceramic materials, cured materials and pyrolized materials, including liquid-liquid forming methods, tower forming methods, and methods using high intensity electromagnetic radiation to cure thin films of liquid polymer derived ceramic materials. Polysilocarb polymer derived ceramic precursor formulations.

This application: (i) claims under 35 U.S.C. §119(e)(1) the benefit of the filing date of Jan. 21, 2015 of U.S. provisional application Ser. No. 62/106,094; (ii) is a continuation-in-part of U.S. patent application Ser. No. 14/268,150 filed May 2, 2014, which claims, under 35 U.S.C. §119(e)(1), the benefit of the filing date of May 2, 2013 of U.S. provisional application Ser. No. 61/818,906 and the benefit of the filing date of May 3, 2013 of U.S. provisional application Ser. No. 61/818,981; (iii) is a continuation-in-part of U.S. patent application Ser. No. 14/324,056 filed Jul. 3, 2014, which claims under 35 U.S.C. §119(e)(1) the benefit of the filing date of Jul. 4, 2013 of U.S. provisional application Ser. No. 61/843,014; and, (iv) is a continuation-in-part U.S. patent application Ser. No. 14/634,814 filed Feb. 28, 2015, which claims under 35 U.S.C. §119(e)(1) the benefit of the filing date of Feb. 28, 2014 of U.S. provisional application Ser. No. 61/946,598, the entire disclosures of each of which are incorporated herein by reference.

### BACKGROUND OF THE INVENTION

### Field of the Invention

The present inventions relate to methods and systems for manufacturing polymeric derived ceramic materials in small volumetric shapes.

Polymer derived ceramics (PDC) are ceramic materials that are derived from, e.g., obtained by, the pyrolysis of polymeric materials. These materials are typically in a solid or semi-solid state that is obtained by curing an initial liquid polymeric precursor, e.g., PDC precursor, PDC precursor formulation, precursor batch, and precursor. The cured, but unpyrolized, polymer derived material can be referred to as a preform, a PDC preform, the cured material, and similar such terms. Polymer derived ceramics may be derived from many different kinds of precursor formulations, e.g., starting materials, starting formulations. PDCs may be made of, or derived from, carbosilane or polycarbosilane (Si—C), silane or polysilane (Si—Si), silazane or polysilazane (Si—N—Si), silicon carbide (SiC), carbosilazane or polycarbosilazane (Si—N—Si—C—Si), siloxane or polysiloxanes (Si—O), to name a few.

A preferred PDC is “polysilocarb”, e.g., material containing silicon (Si), oxygen (O) and carbon (C). Polysilocarb materials may also contain other elements. Polysilocarb materials can be made from one or more polysilocarb precursor formulation or precursor formulation. The polysilocarb precursor formulations can contain, for example, one or more functionalized silicon polymers, other polymers, non-silicon based cross linking agents, monomers, as well as, potentially other ingredients, such as for example, inhibitors, catalysts, initiators, modifiers, dopants, fillers, reinforcers and combinations and variations of these and other materials and additives. Silicon oxycarbide materials, SiOC compositions, and similar such terms, unless specifically stated otherwise, refer to polysilocarb materials, and would include liquid materials, solid uncured materials, cured materials, and ceramic materials.

Examples of PDCs, PDC formulations and starting materials, are found in U.S. patent application Ser. Nos., 14/864,539, 14/634,819, and US Patent Publication Nos. 2014/0343220, 2014/0274658, 2014/0326453, 2015/0175750, 2008/0095942, 2008/0093185, 2006/0069176, 2006/0004169, and 2005/0276961, and U.S. Pat. Nos. 8,742,008, 8,119,057, 7,714,092, 7,087,656, 5,153,295, and 4,657,991, the entire disclosures of each of which are incorporated herein by reference.

Generally, the term “about” as used herein, unless specified otherwise, is meant to encompass a variance or range of ±10%, the experimental or instrument error associated with obtaining the stated value, and preferably the larger of these.

As used herein, unless specified otherwise the terms %, weight % and mass % are used interchangeably and refer to the weight of a first component as a percentage of the weight of the total, e.g., formulation, mixture, material or product. As used herein, unless specified otherwise “volume %” and “% volume” and similar such terms refer to the volume of a first component as a percentage of the volume of the total, e.g., formulation, material or product.

### SUMMARY

Accordingly, there has been a long-standing, unmeet and increasing need for small polymer derived ceramics and solids, methods of making these volumetric structures, and in particular methods of making predetermined shapes and volumes of these structures. The present inventions, among other things, solve these needs by providing the articles of manufacture, devices and processes taught, disclosed and claimed herein.

Accordingly, there is provided there is provided a system for making small volumetric structures from a polymer derived ceramic precursor, the system including: a polymer derived ceramic precursor delivery apparatus, the apparatus including a chamber in fluid communication with a delivery port; wherein the chamber is capable of delivering a liquid polymer derived ceramic precursor; a forming apparatus, the forming apparatus including a forming chamber having an opening; the chamber defining a cavity; wherein the cavity is in fluid communication with the chamber opening; the chamber opening in fluid communication with the delivery port; whereby the system is capable of delivering the liquid polymer derived ceramic from the delivery port to the cavity as a liquid; a temperature control apparatus thermally associated with the forming apparatus; wherein the cavity is capable of being maintained at a predetermined temperature; and, whereby, the system is capable of providing a liquid polymer derived ceramic precursor to the cavity in a predetermined volumetric shape; and wherein the system is capable of curing the polymer derived ceramic precursor in the cavity.

Yet further there is provided systems and methods having one or more of the following features: wherein the delivery apparatus has a nozzle; wherein the delivery apparatus has a pressure-driven droplet forming device; wherein the delivery apparatus has a flow driven droplet forming device; wherein the delivery apparatus has an acoustic droplet ejection device; wherein the forming apparatus has a shear induced droplet creation device; wherein the delivery apparatus has a droplet creation device; wherein the delivery apparatus has a droplet creation device; and the droplet creation device has an actuator; wherein the actuator is selected from the group consisting of piezo-electric, pressure reservoir, syringe, positive displacement, vibratory, electromagnetic, and phase change; wherein the delivery apparatus has a droplet creation device selected from the group consisting of piezo-electric, pressure reservoir, syringe, positive displacement, vibratory, electromagnetic, and phase change; wherein the forming apparatus has a droplet creation device; wherein the forming apparatus has a droplet creation device; and the droplet creation device has an actuator; and wherein the actuator is selected from the group consisting of piezo-electric, pressure reservoir, aerosol, syringe, positive displacement, vibratory, electromagnetic, and phase change.

Still further there is provided systems and methods having one or more of the following features: wherein the forming apparatus has a droplet creation device selected from the group consisting of piezo-electric, pressure reservoir, syringe, aerosol, positive displacement, vibratory, electromagnetic, and phase change; including a droplet creation device; including a droplet creation device; and the droplet creation device has an actuator; wherein the actuator is selected from the group consisting of piezo-electric, pressure reservoir, syringe, positive displacement, aerosol, vibratory, electromagnetic, and phase change; including a droplet creation device selected from the group consisting of piezo-electric, pressure reservoir, syringe, positive displacement, aerosol, vibratory, electromagnetic, and phase change; including a droplet creation device selected from the group consisting of water-atomizer, gas-blast atomizer, atomizer, gas-assist atomizer, ultrasonic nebulizer, ultrasonic extruder, inkjet, and fogger; wherein, the port is configured to deliver a volumetric shape of precursor having a volume of less than about 0.25 inch³; wherein, the port is configured to deliver a volumetric shape of precursor having a volume of less than about 500 mm³; wherein, the port is configured to deliver a volumetric shape of precursor having a volume of less than about 100 mm³; wherein, the port is configured to deliver a volumetric shape of precursor having a volume of less than about 4,000 microns³; wherein, the port is configured to deliver a volumetric shape of precursor having a volume of less than about 50 microns³; wherein the port is configured to deliver a volumetric shape of precursor having a volume of less than about 10 microns³; wherein, the delivery apparatus is configured to deliver a volumetric shape of precursor having a volume of less than about 0.25 inch³; wherein, the delivery apparatus is configured to deliver a volumetric shape of precursor having a volume of less than about 500 mm³; wherein, the delivery apparatus is configured to deliver a volumetric shape of precursor having a volume of less than about 100 mm³; the delivery apparatus is configured to deliver a volumetric shape of precursor having a volume of less than about 4,000 microns³; wherein, the delivery apparatus is configured to deliver a volumetric shape of precursor having a volume of less than about 50 microns³; wherein, the delivery apparatus is configured to deliver a volumetric shape of precursor having a volume of less than about 10 microns³; wherein, the forming apparatus is configured to cure a volumetric shape of precursor having a volume of less than about 0.25 inch³; wherein, the forming apparatus is configured to cure a volumetric shape of precursor having a volume of less than about 500 mm³; wherein, the forming apparatus is configured to cure a volumetric shape of precursor having a volume of less than about 100 mm³; wherein, the forming apparatus is configured to cure a volumetric shape of precursor having a volume of less than about 4,000 microns³; wherein, the forming apparatus is configured to cure volumetric shape of precursor having a volume of less than about 50 microns³; and wherein, the forming apparatus is configured to cure a volumetric shape of precursor having a volume of less than about 10 microns³.

Additionally, there is provided systems and methods having one or more of the following features: wherein the forming apparatus has a forming liquid.

The system of claim 1, wherein the forming apparatus has a forming liquid consisting essentially of water and a surfactant; wherein the forming apparatus has a forming liquid and a mixer; wherein the temperature control apparatus has a controller for providing a predetermined temperature profile; and, wherein the temperature control apparatus has a controller for providing a predetermined temperature profile, the temperature profile including a first heating rate, a first hold time, a second heating rate and a second hold time.

Moreover there is provided a system for making volumetric structures from a polymer derived ceramic precursor, the system including: a polymer derived ceramic delivery apparatus, the apparatus including a liquid polymer derived ceramic precursor, a chamber and a port, wherein the chamber is capable of holding a liquid polymer derived ceramic precursor for delivery by the port into a volumetric shape having a predetermined volume; a precursor solidifying apparatus, the solidifying apparatus including: a cavity; a temperature control apparatus; wherein the cavity is maintained at a predetermined temperature sufficient to cure the volumetric shape of polymer derived ceramic precursor to form a preform; and the port in fluid communication with the cavity; whereby, the system is capable of forming and curing the liquid polymer derived ceramic precursor into a predetermined volumetric shape structure.

Yet further there are provided systems and methods having one or more of the following features: wherein the chamber is a tube; wherein the port is a nozzle; wherein the port is located inside of the cavity; wherein the cavity contains a forming liquid; wherein the cavity contains a forming liquid, having a surface; and the port is located below the surface; wherein the volumetric shape is a shape selected from the group consisting of spheres, pellets, rings, lenses, disks, panels, cones, frustoconical shapes, squares, rectangles, trusses, and angles; wherein the volumetric shape is a shape selected from the group consisting of channels, hollow sealed chambers, hollow spheres, blocks, sheets, coatings, balls, squares, and prolate spheroids; and wherein the volumetric shape is a shape selected from the group consisting of ellipsoids, spheroids, eggs, cones, multifaceted structures, films, skins, particulates, beams, rods, angles, columns, fibers, staple fibers, tubes, cups, pipes, and polyhedrons.

In addition there are provided systems and methods having one or more of the following features: being configured to provide preforms having a predetermined size and to provide at least about 90% of the preforms at the predetermined size; being configured to provide preforms having a predetermined size and to provide at least about 95% of the preforms at the predetermined size; and, being configured to provide preforms having a predetermined size and to provide at least about 99% of the preforms at the predetermined size.

Moreover, there is provided systems and methods having one of more of the following features: wherein the system has an extruder; wherein the delivery apparatus and the forming apparatus are components of the extruder; and, wherein the system has an extruder; wherein the delivery apparatus and the solidifying apparatus are components of the extruder.

Still further there is provided a system for making volumetric structures from a polymer derived ceramic precursor material, the system including: a polymer derived ceramic delivery apparatus, the apparatus including a first chamber in fluid communication with a delivery port, and an amount of a liquid polymer derived ceramic precursor; a forming and curing apparatus, the forming and curing apparatus including a forming chamber having an opening; and the chamber defining a cavity, wherein the cavity is in fluid communication with the chamber opening and contains a volumetric shape of a polymer derived ceramic precursor; the chamber opening in fluid communication with the delivery port; a temperature control source thermally associated with the forming apparatus; wherein the cavity is maintained at a predetermined temperature sufficient to cure the volumetric shape of the polymer derived ceramic precursor; and, whereby, the system is capable of providing a liquid polymer derived ceramic precursor material into the cavity in a predetermined volumetric shape, and wherein the polymer derived ceramic precursor material is cured in the cavity.

There is also provided systems and methods that have one or more of the following features: wherein the liquid polymer derived ceramic precursor is selected from the group consisting of silanes, polysilanes, silazanes, polysilazanes, carbosilanes, polycarbosilanes, siloxanes, and polysiloxanes; wherein the liquid polymer derived ceramic precursor is a polysilocarb; wherein the liquid polymer derived ceramic precursor is a net polysilocarb; wherein the liquid polymer derived ceramic precursor is a reinforced polysilocarb; wherein the liquid polymer derived ceramic precursor is a polysilocarb; wherein the liquid polymer derived ceramic precursor has a polysilocarb and contains hydride groups; wherein the liquid polymer derived ceramic precursor has a polysilocarb, is solvent free, and contains hydride groups; wherein the liquid polymer derived ceramic precursor has a polysilocarb and contains vinyl groups; wherein the liquid polymer derived ceramic precursor has a polysilocarb, is solvent free, and contains vinyl groups; wherein the liquid polymer derived ceramic precursor has a polysilocarb and contains vinyl groups and hydride groups; wherein the liquid polymer derived ceramic precursor has a polysilocarb having hydride and vinyl groups and wherein the molar ratio of hydride groups to vinyl groups is about 1.50 to 1; wherein the liquid polymer derived ceramic precursor has a polysilocarb having hydride and vinyl groups and wherein the molar ratio of hydride groups to vinyl groups is about 3.93 to 1; wherein the liquid polymer derived ceramic precursor has a polysilocarb having hydride and vinyl groups and wherein the molar ratio of hydride groups to vinyl groups is about 0.08 to 1 to about 24.00 to 1; wherein the liquid polymer derived ceramic precursor has a polysilocarb having hydride and vinyl groups and wherein the molar ratio of hydride groups to vinyl groups is about 0.08 to 1 to about 1.82 to 1; wherein the liquid polymer derived ceramic precursor has a polysilocarb having hydride and vinyl groups and wherein the molar ratio of hydride groups to vinyl groups is about 1.12 to 1 to about 2.36 to 1; wherein the liquid polymer derived ceramic precursor has a polysilocarb having hydride and vinyl groups and wherein the molar ratio of hydride groups to vinyl groups is about 1.75 to 1 to about 23.02 to 1; wherein the liquid polymer derived ceramic precursor has a polysilocarb having hydride and vinyl groups and wherein the molar ratio of hydride groups to vinyl groups is about 1.50 to 1 to about 3.93 to 1; and wherein the liquid polymer derived ceramic precursor has a polysilocarb having hydride and vinyl groups and wherein the molar ratio of hydride groups to vinyl groups is about 1.26 to 1 to about 4.97 to 1.

Yet additionally there is provided a system for making small volumetric structures from a polymer derived ceramic precursor material, the system including: a polymer derived ceramic delivery apparatus, the apparatus including a first chamber in fluid communication with a delivery port, and an amount of a liquid polymer derived ceramic precursor; a forming apparatus, the forming apparatus including a chamber having an opening; and the chamber defining a cavity, wherein the cavity is in fluid communication with the chamber opening and contains a volumetric shape of a polymer derived ceramic precursor; the chamber opening in fluid communication with the delivery port; and, whereby, the system is capable of providing a liquid polymer derived ceramic precursor into the cavity.

Yet still further, there is provide a system for making small volumetric structures from a polymer derived ceramic precursor, the system including: a means for delivering a liquid polymer derived ceramic; a forming apparatus, the forming apparatus including a forming chamber having an opening; and the chamber defining a cavity, wherein the cavity is in fluid communication with the chamber opening; the chamber opening in fluid communication with the delivery means, whereby the delivery means is capable of delivering the liquid polymer derived ceramic into the cavity; and, a temperature control source thermally associated with the forming apparatus, wherein the cavity is maintained at a predetermined temperature; whereby, the system is capable of providing a liquid polymer derived ceramic precursor material into the cavity in a predetermined shape, and fixing the polymer derived ceramic in the predetermined shape; thereby making a volumetrically shaped polymer derived ceramic preform.

Additionally there is provided a system for making small volumetric structures from a polymer derived ceramic precursor, the system including: a polymer derived ceramic delivery apparatus, the apparatus including a first chamber in fluid communication with a delivery port; wherein the first chamber is capable of holding a liquid polymer derived ceramic precursor; a means for forming a volumetric shaped structure, the forming means including a forming chamber having an opening; and the chamber defining a cavity, wherein the cavity is in fluid communication with the chamber opening; the chamber opening in fluid communication with the delivery port, whereby the system is capable of delivering the liquid polymer derived ceramic from the delivery port into the cavity, as a liquid; a temperature control source thermally associated with the forming apparatus, wherein the cavity is maintained at a predetermined temperature; and, whereby, the system is capable of providing a liquid polymer derived ceramic precursor material into the cavity in a predetermined volumetric shape, and wherein the polymer derived ceramic precursor material is cured in the cavity.

Moreover, there is provided a system for making small volumetric structures from a polymer derived ceramic precursor, the system including: a means for delivering a liquid polymer derived ceramic; a means for forming a volumetric shaped structure, the forming means including a forming chamber having an opening; and the chamber defining a cavity, wherein the cavity is in fluid communication with the chamber opening; the chamber opening in fluid communication with the delivery port, whereby the system is capable of delivering the liquid polymer derived ceramic from the delivery port into the cavity, as a liquid; a temperature control source thermally associated with the forming apparatus, wherein the cavity is maintained at a predetermined temperature; and, whereby, the system is capable of providing a liquid polymer derived ceramic precursor material into the cavity in a predetermined volumetric shape, and wherein the polymer derived ceramic precursor material is cured in the cavity.

Still additionally there is provided a system for making small volumetric structures from a polymer derived ceramic precursor, the system including: a means for forming a small volumetric shaped structure of polymer derived ceramic precursor; and, a means for curing the small volumetric shaped structure of polymer derived ceramic precursor material into a volumetric shaped preform.

Yet still further there is provided a system for making small volumetric structures from a polymer derived ceramic precursor, the system including: a means for forming a small volumetric shaped structure of polymer derived ceramic precursor; a means for curing the small volumetric shaped structure of polymer derived ceramic precursor material into a volumetric shaped preform; and, a means for pyrolizing the preform.

In addition there is provided a system for making small volumetric structures from a polymer derived ceramic precursor, the system including: a liquid holding receptacle; the liquid holding receptacle containing a forming liquid; a precursor delivery apparatus, including a precursor, a channel, and a delivery port, the channel in fluid communication with the delivery port, whereby the precursor can be delivered from the delivery port; and, the delivery port in fluid communication with the liquid holding receptacle.

Yet further there is provided a method for making small volumetric structures from a polymer derived ceramic precursor, the method including: providing a liquid polymer derived ceramic precursor to a delivery apparatus, the apparatus including a chamber in fluid communication with a delivery port; forming the liquid precursor into a predetermined liquid volumetric shape; and delivering the liquid volumetric shape to a chamber defining a cavity; and, curing the liquid volumetric shape in the cavity to form a polymer derived ceramic preform.

Still further there is provided methods and systems including one or more of the following features: wherein the preform is the same shape as the volumetric shape; wherein the preform is substantially the same shape as the volumetric shape; wherein the preform is green cured; wherein the preform is hard cured; wherein the preform is final cured; including pyrolizing the preform to form a polymer derived ceramic; wherein the delivery apparatus has a nozzle; and wherein the delivery apparatus has a pressure-driven droplet forming device.

In addition there is provided systems and methods having one or more of the following features: wherein the cure is conducted with a predetermined cure temperature profile; wherein the cure is conducted with a predetermined cure temperature profile including a first heating rate, a first hold time, a second heating rate and a second hold time; wherein the volumetric shape is a shape selected from the group consisting of spheres, pellets, rings, lenses, disks, panels, cones, frustoconical shapes, squares, rectangles, trusses, and angles; wherein the volumetric shape is a shape selected from the group consisting of channels, hollow sealed chambers, hollow spheres, blocks, sheets, coatings, balls, squares, and prolate spheroids; and wherein the volumetric shape is a shape selected from the group consisting of ellipsoids, spheroids, eggs, cones, multifaceted structures, films, skins, particulates, beams, rods, angles, columns, fibers, staple fibers, tubes, cups, pipes, and polyhedrons.

Yet additionally there is provided a method for making small volumetric structures from a polymer derived ceramic precursor, the system including: a step for forming a liquid polymer derived ceramic to a liquid predetermined volumetric shape; and, a step for curing the liquid predetermined volumetric shape into a preform having essentially the same volumetric shape.

Furthermore there is provided a method for making small volumetric structures from a polymer derived ceramic precursor, the system including: a step for forming a small volumetric shaped structure of polymer derived ceramic precursor; a step for curing the small volumetric shaped structure of polymer derived ceramic precursor material into a volumetric shaped preform; and, a step for pyrolizing the preform.

Yet further, there is provided a method for making small volumetric structures from a polymer derived ceramic precursor, the system including: forming a net small volumetric shaped structure of polymer derived ceramic precursor; curing the net small volumetric shaped structure of polymer derived ceramic precursor material into a volumetric shaped preform; and, pyrolizing the preform.

Further there is provided a method for making small volumetric structures from a polymer derived ceramic precursor, the system including: providing a polymer derived ceramic precursor to a liquid holding receptacle; the liquid holding receptacle containing a forming liquid; the precursor forming essentially upon contact with the forming liquid a predetermined volumetric shape; and curing the volumetric shape to form a preform.

Additionally there is provided a system for forming polymer derived ceramic platelets, the system having: a means for forming a thin film of liquid polymer derived ceramic precursor material on a substrate means; and, a means for providing electromagnetic radiation to the thin film of liquid polymer derived ceramic.

Yet further there is provided systems and methods having one or more of the following features: wherein the means for forming the thin film is a distribution header; wherein the means for forming the thin film is a distribution roller assembly; wherein the means for forming the thin film is an air knife assembly; wherein the electromagnetic radiation is white light; and wherein the electromagnetic radiation is broad band light, having a wavelength band of at least about 100 nm, between the wavelengths of about 300 nm and about 800 nm.

Yet additionally there is provided a method of forming a cured polymer derived ceramic from a liquid polymer derived ceramic precursors, the method having: a step for forming a thin layer of a liquid polymer derived ceramic precursor on a substrate; and, a step for curing the thin layer with electromagnetic radiation.

### BRIEF DESCRIPTION OF THE DRAWINGS

FIG. 1 is schematic diagram of an embodiment of a process and forming system in accordance with the present inventions.

FIG. 1A is a perspective view of an embodiment of a forming plate for a forming system in accordance with the present inventions.

FIG. 2 is a schematic diagram of an embodiment of a process and forming system in accordance with the present inventions.

FIG. 3 is a schematic diagram of an embodiment of an impingent jet forming system and process in accordance with the present inventions.

FIG. 4 is a schematic diagram of an embodiment of a collinear high pressure jet forming system and process in accordance with the present inventions.

FIG. 5 is a schematic diagram of an embodiment of an ultrasonic high frequency forming system and process in accordance with the present inventions.

FIG. 6 is a schematic diagram of an embodiment of an ultrasonic nozzle forming system and process in accordance with the present inventions.

FIG. 7 is a schematic diagram of an embodiment of a spray jet reflection forming system and process in accordance with the present inventions.

FIG. 8 is a schematic diagram of an embodiment of a forming table forming system and process in accordance with the present inventions.

FIG. 9 is a schematic diagram of an embodiment of a foam forming system and process in accordance with the present inventions.

FIG. 10 is a schematic diagram of an embodiment of a spray pyrolysis forming system and process in accordance with the present inventions.

FIG. 11 is a flow chart diagram of an embodiment of a spray curing system and process in accordance with the present inventions.

FIG. 11A is a schematic of an embodiment of a curing chamber providing a combination of co-current and counter-current flow for use in spray curing methods in accordance with the present inventions.

FIG. 11B is a schematic of an embodiment of a curing chamber providing a co-current flow for use in spray curing methods in accordance with the present inventions.

FIG. 12 is a cross-sectional view of an embodiment of an injection molding machine and process for molding small PDC cured preforms in accordance with the present inventions.

FIG. 12A is a cross-sectional view of the embodiment of the injection molding machine of FIG. 12 at a stage in the molding cycle in accordance with the present inventions.

FIG. 12B is a cross-sectional view of the embodiment of the injection molding machine of FIG. 12 at a stage in the molding cycle in accordance with the present inventions.

FIG. 12C is a cross-sectional view of the injection molding machine of FIG. 12 illustrating axial movement of the mold portion from the injection portion and the opening of the mold to eject the molded micro cured PDC preform in accordance with the present invention.

FIG. 12D is an enlarged fragmentary view of a component of the embodiment of FIG. 12 illustrating an embodiment of the valve member closed between the liquid PDC portion and the injection portion of the injection molding machine in accordance with the present inventions.

FIG. 12E is an enlarged fragmentary view of a component of the embodiment of FIG. 12 illustrating an embodiment of the valve member opened between the liquid PDC portion and the injection portion to permit the flow of a predetermined shot volume of PDC formulation into the injection portion in accordance with the present inventions.

FIG. 12F is an enlarged fragmentary view of a component of the embodiment of FIG. 12 illustrating an embodiment of the position of the injection pin during filling of the resin flow channel with PDC formulation from the PDC formulation portion in accordance with the present inventions.

FIG. 12G is an enlarged fragmentary view of a component of the embodiment of FIG. 12 illustrating an embodiment of the positioning of a valve member between the formulation portion and the injection portion in accordance with an embodiment of the present inventions.

FIG. 13 is an perspective view of an embodiment of a nip type forming system and process in accordance with an embodiment of the present inventions.

FIG. 13A is a perspective enlarged view of a section of a roller from the embodiment of FIG. 13.

FIG. 14 is a schematic view of an embodiment of a solution formation system and process in accordance with the present inventions.

FIG. 15 is a schematic view of an embodiment of a solution formation system and process in accordance with the present inventions.

FIG. 16 is an perspective view of an embodiment of a solution forming system and process in accordance with the present inventions.

FIG. 17 is a process flow diagram of an embodiment of solution forming system and processes in accordance with the present inventions.

FIG. 18 is a graph representing an embodiment of coalescence in accordance with the present inventions.

FIG. 19 is a graph representing an embodiment of Van-der-Waals forces in accordance with the present inventions.

FIG. 20 is a graph representing an embodiment of Free Energy as a function of separation curve in accordance with the present inventions.

FIG. 21 is a graph representing an embodiment of kinetic paths to coalescence in accordance with the present inventions.

FIG. 22 is a graph representing an embodiment of droplet size as a function of viscosity in accordance with the present inventions.

FIG. 23 is a graph representing an embodiment of an isothermal and non-isothermal processes in accordance with the present inventions.

FIG. 24 is a graph representing an embodiment of particle size for two different surfactant concentrations in accordance with the present inventions.

FIG. 25 is a graph representing an embodiment of particle distribution as a function of time in accordance with the present inventions.

FIG. 26 is a graph representing an embodiment of speed and species adsorption in accordance with the present inventions.

### DESCRIPTION OF THE PREFERRED EMBODIMENTS

In general, the present inventions relate to methods, systems, apparatus, and process for making small volumetric shapes from PDC precursors, and to provide small volumetric shaped PDC preforms and polymer derived ceramics. In particular, among other things, embodiments of the present inventions make small shapes from PDC precursors with, good, high, and exceeding high uniformity and reproducibility. Embodiments of the present inventions, among other things, make volumetric shapes of PDC precursors, PDC preforms, PDC plastics, PDC cured materials, and polymer derived ceramics, at high rates of production, in large quantities, and with long run times.

In general the volumetric shapes made by embodiments of the present invention are small, e.g., having cross sections from about 2 inches to 0.01 microns (μm), of less than about 1 inch, less than about ¾ inch, less than about ⅓ inch, less than about 5,000 microns, less than about 4,000 microns, less than about 2,000 microns, less than about 1,000 microns, less than about 500 microns, less than about 100 microns, less than about 10 microns, less than about 1 micron, less than about 0.5 microns and about 0.1 micron. The volumetric shapes may have volumes of from about 4.25 inch³to about 0.0004 microns³, of less than about 0.25 inch³, of less than about 525 mm³, of less than about 100 mm³, of less than about 50 mm³, of less than about 4,000 microns³, of less than about 2,000 microns³, of less than about 100 microns³, of less than about 50 microns³, of less than about 0.5 microns³ and of less than about 0.00005 microns³. The small volumetric shapes, made by embodiments of the present inventions, may individually weight, less than about 30 grams, less than about 15 grams, less than about 10 grams, less than about 1 gram, less than about 0.5 grams, less than about 0.1 grams, and less than about 0.01 grams, less than about 0.0001 grams, less than about 0.00001 grams, less then about 10⁻⁸g, less than about 10⁻¹⁰ g and less than about 10⁻¹⁵ g. The small volumetric shapes, made by embodiments of the present inventions, may be substantially uniform, they may be entirely random, they may be within a predetermined range, for one of more physical property, e.g., shape, size, weight, roughness, density, porosity, strength, electrical, conductivity, optical, thermodynamic, ionic, etc., and combinations and variations of these.

The volumetric shapes may be any shape, including for example, spheres, platelets, sheets, flakes, pellets, rings, lenses, disks, panels, cones, frustoconical shapes, squares, rectangles, trusses, angles, channels, hollow sealed chambers, hollow spheres, blocks, sheets, coatings, balls, squares, prolate spheroids, ellipsoids, spheroids, eggs, cones, multifaceted structures, films, skins, particulates, beams, rods, angles, columns, fibers, staple fibers, tubes, cups, pipes, polyhedrons (e.g., octahedron, dodecahedron, icosidodecahedron, rhombic triacontahedron, and prism), and combinations and various of these and other more complex shapes, both engineering and architectural.

Generally, the polymer derived ceramics and their cured preforms may be any volumetric shape, and preferably are any predetermined volumetric shape. The cured preforms may be the same shape, or a different volumetric shape, from the ceramics. Thus, a precursor batch may be shaped into, for example, platelets, sheets, flakes, balls, spheres, squares, prolate spheroids, ellipsoids, spheroids, eggs, cones, rods, boxes, multifaceted structures, and polyhedrons (e.g., octahedron, dodecahedron, icosidodecahedron, rhombic triacontahedron, and prism), as well as, other such structures for, or upon, curing, and pyrolysis. The polymeric derived ceramics may be made into the shape of any particle, that is used as, or suggested to be used as, for example, a pigment, an additive, an abrasive, a filler, and an hydraulic fracturing proppant. Spherical type structures are examples of a presently preferred shape for proppants.

Sphere and spherical shall mean, and include unless expressly stated otherwise, any structure that has at least about 90% of its total volume within a “perfect sphere,” i.e., all points along the surface of the structure have radii of equal distance. An essentially perfect sphere has at least about 98% of its total volume within a perfect sphere. A substantially perfect sphere has at least about 95% of its total volume within a perfect sphere.

This terminology, “known shape”—90% perfect, “substantially perfect shape”—95% of the perfect shape, and “essentially perfect”—98% of the perfect shape, is applicable to other know, defined, geometric shapes (and will be used herein unless stated otherwise). Thus, a “known geometric shape”, e.g., a “cube,” means that at least about 90% of the total volume of the shape is within the perfect known, defined, geometric shape, e.g., for a cube—six sides of equal length, width and height, all connecting at right angles. A “substantially perfect shape,” e.g., a “substantially perfect cube” is at least 95% within the shape of a perfect cube, and an “essentially perfect shape”, e.g., an “essentially perfect cube” is at least 95% within the shape of a perfect cube.

Embodiments of the systems, apparatus and methods provide the ability to make highly random sized particles of the same type, e.g., all shapes are substantially perfect spheres but have random and varied volumes, to make highly random shapes with high random particle sizes, e.g., many different shapes with varied volumes, and combinations and variations of these.

Embodiments of the systems, apparatus and methods, preferably provide the ability to make highly uniform shapes, as to type, as to volume and both. Thus, for example, embodiments of the process produce spheres that are within at least 90% of the targeted size, at least 95% of the targeted size, and at least 99% of the targeted size, or more. For example, embodiments of the process can produce spherical beads, spherical type beads, essentially perfect spherical beads, and substantially perfect spherical beads, each of which can have at least about 90% of their size within a 10 mesh range, at least about 95% of their size within a 10 mesh range, at least about 98% of their size within a 10 mesh range, and at least about 99% of their size within a 10 mesh range. Further, and for example, the process can produce spherical beads, spherical type beads, essentially perfect spherical beads, and substantially perfect spherical beads, each of which can have at least about 90% of their size within a 5 mesh range, at least about 95% of their size within a 5 mesh range, at least about 98% of their size within a 5 mesh range, and at least about 99% of their size within a 5 mesh range. Preferably, these levels of uniformity in the production of the volumetric shapes, both the ceramic and cured preform, is obtained without the need for filtering, sorting or screening the cured shapes, and without the need for filtering, sorting or screening the pyrolized shapes. In addition to having the ability to tightly control size distribution, embodiments of the present processes provide the ability to make a large number of highly uniform predetermined shapes, e.g., at least about 90%, at least about 95% and at least about 99% of the shapes produced meet the targeted or predetermined shape. For example, at least about 98% of the beads, e.g., proppants, made from a precursor batch can be essentially spherical.

Generally, the precursor formulation is initially a liquid, or if not, it is liquefied. This liquid precursor formulation is then cured to form a solid or semi-sold material, e.g., a plastic, which is also called the preform or cured preform. The preform is then pyrolized into a ceramic.

It should be understood that the use of headings in this specification is for the purpose of clarity, reference, and is not limiting in any way. Thus, the processes compositions, and disclosures described under a heading should be read in context with the entirely of this specification, including the various examples. The use of headings in this specification should not limit the scope of protection afford the present inventions.

General Processes for Obtaining a Polysilocarb Precursor

Typically polymer derived ceramic precursor formulations, and in particular polysilocarb precursor formulations can generally be made by three types of processes, although other processes, and variations and combinations of these processes may be utilized. These processes generally involve combining precursors to form a precursor formulation. One type of process generally involves the mixing together of precursor materials in preferably a solvent free process with essentially no chemical reactions taking place, e.g., “the mixing process.” The other type of process generally involves chemical reactions, e.g., “the reaction type process,” to form specific, e.g., custom, precursor formulations, which could be monomers, dimers, trimers and polymers. A third type of process has a chemical reaction of two or more components in a solvent free environment, e.g., “the reaction blending type process.” Generally, in the mixing process essentially all, and preferably all, of the chemical reactions take place during subsequent processing, such as during curing, pyrolysis and both.

It should be understood that these terms—reaction type process, reaction blending type process, and the mixing type process—are used for convenience and as a short hand reference. These terms are not, and should not be viewed as, limiting. For example, the reaction process can be used to create a precursor material that is then used in the mixing process with another precursor material. These three processes and PDC precursor formulations are disclosed and taught in US Patent Publication Nos. 2014/0343220, 2014/0274658, 2014/0326453, and 2015/0175750 the entire disclosures of each of which are incorporated herein by reference.

These process types are described in this specification, among other places, under their respective headings. It should be understood that the teachings for one process, under one heading, and the teachings for the other processes, under the other headings, can be applicable to each other, as well as, being applicable to other sections, embodiments and teachings in this specification, and vice versa. The starting or precursor materials for one type of process may be used in the other type of processes. Further, it should be understood that the processes described under these headings should be read in context with the entirely of this specification, including the various examples and embodiments.

It should be understood that combinations and variations of these processes may be used in reaching a precursor formulation, and in reaching intermediate, end and final products. Depending upon the specific process and desired features of the product the precursors and starting materials for one process type can be used in the other. A formulation from the mixing type process may be used as a precursor, or component in the reaction type process, or the reaction blending type process. Similarly, a formulation from the reaction type process may be used in the mixing type process and the reaction blending process. Similarly, a formulation from the reaction blending type process may be used in the mixing type process and the reaction type process. Thus, and preferably, the optimum performance and features from the other processes can be combined and utilized to provide a cost effective and efficient process and end product. These processes provide great flexibility to create custom features for intermediate, end, and final products, and thus, any of these processes, and combinations of them, can provide a specific predetermined product. In selecting which type of process is preferable, factors such as cost, controllability, shelf life, scale up, manufacturing ease, etc., can be considered.

In addition to being commercially available the precursors may be made by way of an alkoxylation type process, e.g., an ethoxylation process. Precursor materials may also be obtained by way of an acetylene reaction route. In general there are several known paths for adding acetylene to Si—H. Thus, for example, tetramethylcyclotetrasiloxane can be reacted with acetylene in the presence of a catalyst to produce tetramethyltetravinylcyclotetrasiloxane. This product can then be ring opened and polymerized in order to form linear vinyl,methylsiloxanes. Alternatively, typical vinyl silanes can be produced by reacting methyl,dichlorosilane (obtained from the direct process or Rochow process) with acetylene. These monomers can then be purified (because there maybe some scrambling) to form vinyl, methyl, dichlorosilane. Then the vinyl monomer can be polymerized via hydrolysis to form many cyclic, and linear siloxanes, having various chain lengths, including for example various cyclotetrasiloxanes (e.g., D₄′) and various cyclopentasiloxanes (e.g., D₅′).

The Mixing Type Process

Precursor materials may be methyl hydrogen, and substituted and modified methyl hydrogens, siloxane backbone additives, reactive monomers, reaction products of a siloxane backbone additive with a silane modifier or an organic modifier, and other similar types of materials, such as silane based materials, silazane based materials, carbosilane based materials, phenol/formaldehyde based materials, and combinations and variations of these. The precursors are preferably liquids at room temperature, although they may be solids that are melted, or that are soluble in one of the other precursors.

The precursors are mixed together in a vessel, preferably at room temperature. Preferably, little, and more preferably no solvents, e.g., water, organic solvents, polar solvents, non-polar solvents, hexane, THF, toluene, are added to this mixture of precursor materials. Preferably, each precursor material is miscible with the others, e.g., they can be mixed at any relative amounts, or in any proportions, and will not separate or precipitate. At this point the “precursor mixture” or “polysilocarb precursor formulation” is compete (noting that if only a single precursor is used the material would simply be a “polysilocarb precursor” or a “polysilocarb precursor formulation” or a “formulation”). Although complete, fillers and reinforcers may be added to the formulation. In preferred embodiments of the formulation, essentially no, and more preferably no chemical reactions, e.g., crosslinking or polymerization, takes place within the formulation, when the formulation is mixed, or when the formulation is being held in a vessel, on a prepreg, or over a time period, prior to being cured.

The precursors can be mixed under numerous types of atmospheres and conditions, e.g., air, inert, N₂, Argon, flowing gas, static gas, reduced pressure, elevated pressure, ambient pressure, and combinations and variations of these.

Additionally, inhibitors such as cyclohexane, 1-Ethynyl-1-cyclohexanol (which may be obtained from ALDRICH), Octamethylcyclotetrasiloxane, and tetramethyltetravinylcyclotetrasiloxane, may be added to the polysilocarb precursor formulation, e.g., an inhibited polysilocarb precursor formulation. It should be noted that tetramethyltetravinylcyclotetrasiloxane may act as both a reactant and a reaction retardant (e.g., an inhibitor), depending upon the amount present and temperature, e.g., at room temperature it is a retardant and at elevated temperatures it is a reactant. Other materials, as well, may be added to the polysilocarb precursor formulation, e.g., a filled polysilocarb precursor formulation, at this point in processing, including fillers such as SiC powder, carbon black, sand, polymer derived ceramic particles, pigments, particles, nano-tubes, whiskers, or other materials, discussed in this specification or otherwise known to the arts. Further, a formulation with both inhibitors and fillers would be considered an inhibited, filled polysilocarb precursor formulation.

A catalyst or initiator may be used, and can be added at the time of, prior to, shortly before, or at an earlier time before the precursor formulation is formed or made into a structure, prior to curing. The catalysis assists in, advances, and promotes the curing of the precursor formulation to form a preform.

The time period where the precursor formulation remains useful for curing after the catalysis is added is referred to as “pot life”, e.g., how long can the catalyzed formulation remain in its holding vessel before it should be used. Depending upon the particular formulation, whether an inhibitor is being used, and if so the amount being used, storage conditions, e.g., temperature, low O₂ atmosphere, and potentially other factors, precursor formulations can have pot lives, for example, of from about 5 minutes to about 10 days, about 1 day to about 6 days, about 4 to 5 days, about 30 minutes, about 15 minutes, about 1 hour to about 24 hours, and about 12 hours to about 24 hours.

The catalyst can be any platinum (Pt) based catalyst, which can, for example, be diluted to a ranges of: about 0.01 parts per million (ppm) Pt to about 250 ppm Pt, about 0.03 ppm Pt, about 0.1 ppm Pt, about 0.2 ppm Pt, about 0.5 ppm Pt, about 0.02 to 0.5 ppm Pt, about 1 ppm to 200 ppm Pt and preferably, for some applications and embodiments, about 5 ppm to 50 ppm Pt. The catalyst can be a peroxide based catalyst with, for example, a 10 hour half life above 90 C at a concentration of between 0.1%to 3% peroxide, and about 0.5% and 2% peroxide. It can be an organic based peroxide. It can be any organometallic catalyst capable of reacting with Si—H bonds, Si—OH bonds, or unsaturated carbon bonds, these catalysts may include: dibutyltin dilaurate, zinc octoate, peroxides, organometallic compounds of for example titanium, zirconium, rhodium, iridium, palladium, cobalt or nickel. Catalysts may also be any other rhodium, rhenium, iridium, palladium, nickel, and ruthenium type or based catalysts. Combinations and variations of these and other catalysts may be used. Catalysts may be obtained from ARKEMA under the trade name LUPEROX, e.g., LUPEROX 231; and from Johnson Matthey under the trade names: Karstedt's catalyst, Ashby's catalyst, Speier's catalyst.

Further, custom and specific combinations of these and other catalysts may be used, such that they are matched to specific formulations, and in this way selectively and specifically catalyze the reaction of specific constituents. Moreover, the use of these types of matched catalyst-formulations systems may be used to provide predetermined product features, such as for example, pore structures, porosity, densities, density profiles, high purity, ultra high purity, and other morphologies or features of cured structures and ceramics.

In this mixing type process for making a precursor formulation, preferably chemical reactions or molecular rearrangements only take place during the making of the starting materials, the curing process, and in the pyrolizing process. Chemical reactions, e.g., polymerizations, reductions, condensations, substitutions, take place or are utilized in the making of a starting material or precursor. In making a polysilocarb precursor formulation by the mixing type process, preferably no and essentially no, chemical reactions and molecular rearrangements take place. These embodiments of the present mixing type process, which avoid the need to, and do not, utilize a polymerization or other reaction during the making of a precursor formulation, provides significant advantages over prior methods of making polymer derived ceramics. Preferably, in the embodiments of these mixing type of formulations and processes, polymerization, crosslinking or other chemical reactions take place primarily, preferably essentially, and more preferably solely during the curing process.

The precursor may be a siloxane backbone additive, such as, methyl hydrogen (MH), which formula is shown below.

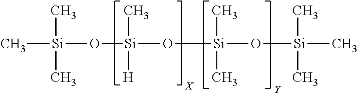

The MH may have a molecular weight (“mw” which can be measured as weight averaged molecular weight in amu or as g/mol) from about 400 mw to about 10,000 mw, from about 600 mw to about 3,000 mw, and may have a viscosity preferably from about 20 cps to about 60 cps. The percentage of methylsiloxane units “X” may be from 1% to 100%. The percentage of the dimethylsiloxane units “Y” may be from 0% to 99%. This precursor may be used to provide the backbone of the cross-linked structures, as well as, other features and characteristics to the cured preform and ceramic material. This precursor may also, among other things, be modified by reacting with unsaturated carbon compounds to produce new, or additional, precursors. Typically, methyl hydrogen fluid (MHF) has minimal amounts of “Y”, and more preferably “Y” is for all practical purposes zero.

The precursor may be a siloxane backbone additive, such as vinyl substituted polydimethyl siloxane, which formula is shown below.

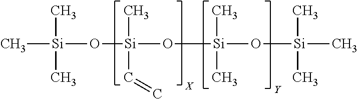

This precursor may have a molecular weight (mw) from about 400 mw to about 10,000 mw, and may have a viscosity preferably from about 50 cps to about 2,000 cps. The percentage of methylvinylsiloxane units “X” may be from 1% to 100%. The percentage of the dimethylsiloxane units “Y” may be from 0% to 99%. Preferably, Xis about 100%. This precursor may be used to decrease cross-link density and improve toughness, as well as, other features and characteristics to the cured preform and ceramic material.

The precursor may be a siloxane backbone additive, such as vinyl substituted and vinyl terminated polydimethyl siloxane, vinyl substituted and hydrogen terminated polydimethyl siloxane, allyl terminated polydimethyl siloxane, vinyl terminated polydimethyl siloxane (“VT”), silanol(hydroxy) terminated polydimethyl siloxane, silanol(hydroxy) terminated vinyl substituted dimethyl siloxane, and hydrogen(hydride) terminated polydimethyl siloxane, di-phenyl terminated siloxane, a mono-phenyl terminated siloxane, diphenyl dimethyl polysiloxane, vinyl terminated diphenyl dimethyl polysiloxane, and hydroxy terminated diphenyl dimethyl polysiloxane.

A variety of cyclosiloxanes can be used as reactive molecules in the formulation. They can be described by the following nomenclature system or formula: DₓD*_{y}, where “D” represents a dimethyl siloxy unit and “D*” represents a substituted methyl siloxy unit, where the “*” group could be vinyl, allyl, hydride, hydroxy, phenyl, styryl, alkyl, cyclopentadienyl, or other organic group, x is from 0-8, y is >=1, and x+y is from 3-8.

The precursor batch may also contain non-silicon based cross-linking agents, be the reaction product of a non-silicon based cross linking agent and a siloxane backbone additive, and combinations and variation of these. The non-silicon based cross-linking agents are intended to, and provide, the capability to cross-link during curing. For example, non-silicon based cross-linking agents that can be used include: cyclopentadiene (CP), methylcyclopentadiene (MeCP), dicyclopentadiene (“DCPD”), methyldicyclopentadiene (MeDCPD), tricyclopentadiene (TCPD), piperylene, divnylbenzene, isoprene, norbornadiene, vinylnorbornene, propenylnorbornene, isopropenylnorbornene, methylvinylnorbornene, bicyclononadiene, methylbicyclononadiene, propadiene, 4-vinylcyclohexene, 1,3-heptadiene, cycloheptadiene, 1,3-butadiene, cyclooctadiene and isomers thereof. Generally, any hydrocarbon that contains two (or more) unsaturated, C═C, bonds that can react with a Si—H, Si—OH, or other Si bond in a precursor, can be used as a cross-linking agent. Some organic materials containing oxygen, nitrogen, and sulphur may also function as cross-linking moieties.

This precursor may be used, among other things, in a dual-cure system; in this manner the dual-cure can allow the use of multiple cure mechanisms in a single formulation. For example, both condensation type cure and addition type cure can be utilized. This, in turn, provides the ability to have complex cure profiles, which for example may provide for an initial cure via one type of curing and a final cure via a separate type of curing.

The precursor may be a reactive monomer. These would include molecules, such as tetramethyltetravinylcyclotetrasiloxane (“TV”), which formula is shown below.

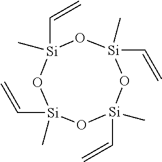 [SMILES: C=C[Si]1(C)O[Si](C)(C=C)O[Si](C)(C=C)O[Si](C)(C=C)O1]

This precursor may be used to provide a branching agent, a three-dimensional cross-linking agent, as well as, other features and characteristics to the cured preform and ceramic material. (It is also noted that in certain formulations, e.g., above 2%, and certain temperatures, e.g., about from about room temperature to about 60° C., this precursor may act as an inhibitor to cross-linking, e.g., in may inhibit the cross-linking of hydride and vinyl groups.)

The precursor may be a reactive monomer, for example, such as trivinyl cyclotetrasiloxane, divinyl cyclotetrasiloxane, trivinyl monohydride cyclotetrasiloxane, divinyl dihydride cyclotetrasiloxane, and a hexamethyl cyclotetrasiloxane.

The precursor may be a silane modifier, such as vinyl phenyl methyl silane, diphenyl silane, diphenyl methyl silane, and phenyl methyl silane (some of which may be used as an end capper or end termination group). These silane modifiers can provide chain extenders and branching agents. They also improve toughness, alter refractive index, and improve high temperature cure stability of the cured material, as well as improving the strength of the cured material, among other things. A precursor, such as diphenyl methyl silane, may function as an end capping agent, that may also improve toughness, alter refractive index, and improve high temperature cure stability of the cured material, as well as, improving the strength of the cured material, among other things.

The precursor may be a reaction product of a silane modifier with a vinyl terminated siloxane backbone additive. The precursor may be a reaction product of a silane modifier with a hydroxy terminated siloxane backbone additive. The precursor may be a reaction product of a silane modifier with a hydride terminated siloxane backbone additive. The precursor may be a reaction product of a silane modifier with TV. The precursor may be a reaction product of a silane. The precursor may be a reaction product of a silane modifier with a cyclosiloxane, taking into consideration steric hindrances. The precursor may be a partially hydrolyzed tertraethyl orthosilicate, such as TES 40 or Silbond 40. The precursor may also be a methylsesquisiloxane such as SR-350 available from General Electric Company, Wilton, Conn. The precursor may also be a phenyl methyl siloxane such as 604 from Wacker Chemie AG. The precursor may also be a methylphenylvinylsiloxane, such as H62 C from Wacker Chemie AG.

The precursors may also be selected from the following: SiSiB® HF2020, TRIMETHYLSILYL TERMINATED METHYL HYDROGEN SILICONE FLUID 63148-57-2; SiSiB® HF2050 TRIMETHYLSILYL TERMINATED METHYLHYDROSILOXANE DIMETHYLSILOXANE COPOLYMER 68037-59-2; SiSiB® HF2060 HYDRIDE TERMINATED METHYLHYDROSILOXANE DIMETHYLSILOXANE COPOLYMER 69013-23-6; SiSiB® HF2038 HYDROGEN TERMINATED POLYDIPHENYL SILOXANE; SiSiB® HF2068 HYDRIDE TERMINATED METHYLHYDROSILOXANE DIMETHYLSILOXANE COPOLYMER 115487-49-5; SiSiB® HF2078 HYDRIDE TERMINATED POLY(PHENYLDIMETHYLSILOXY) SILOXANE PHENYL SILSESQUIOXANE, HYDROGEN-TERMINATED 68952-30-7; SiSiB® VF6060 VINYLDIMETHYL TERMINATED VINYLMETHYL DIMETHYL POLYSILOXANE COPOLYMERS 68083-18-1; SiSiB® VF6862 VINYLDIMETHYL TERMINATED DIMETHYL DIPHENYL POLYSILOXANE COPOLYMER 68951-96-2; SiSiB® VF6872 VINYLDIMETHYL TERMINATED DIMETHYL-METHYLVINYL-DIPHENYL POLYSILOXANE COPOLYMER; SiSiB® PC9401 1,1,3,3-TETRAMETHYL-1,3-DIVINYLDISILOXANE 2627-95-4; SiSiB® PF1070 SILANOL TERMINATED POLYDIMETHYLSILOXANE (0F1070) 70131-67-8; SiSiB® OF1070 SILANOL TERMINATED POLYDIMETHYSILOXANE 70131-67-8; OH-ENDCAPPED POLYDIMETHYLSILOXANE HYDROXY TERMINATED OLYDIMETHYLSILOXANE 73138-87-1; SiSiB® VF6030 VINYL TERMINATED POLYDIMETHYL SILOXANE 68083-19-2; and, SiSiB® HF2030 HYDROGEN TERMINATED POLYDIMETHYLSILOXANE FLUID 70900-21-9.

Thus, in additional to the forgoing type of precursors, it is contemplated that a precursor may be a compound of the following general formula.

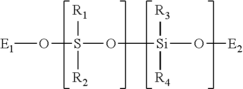

Wherein end cappers E₁ and E₂ are chosen from groups such as trimethyl silicon (—Si(CH₃)₃), dimethyl silicon hydroxy (—Si(CH₃)₂OH), dimethyl silicon hydride (—Si(CH₃)₂H), dimethyl vinyl silicon (—Si(CH₃)₂(CH═CH₂)), (—Si(CH₃)₂(C₆H₅)) and dimethyl alkoxy silicon (—Si(CH₃)₂(OR). The R groups R₁, R₂, R₃, and R₄ may all be different, or one or more may be the same. Thus, for example, R₂ is the same as R₃, R₃ is the same as R₄, R₁ and R₂ are different with R₃ and R₄ being the same, etc. The R groups are chosen from groups such as hydride (—H), methyl(Me)(—C), ethyl (—C—C), vinyl (—C═C), alkyl(—R)(CₙH₂ₙ₊₁), allyl(—C—C═C), aryl(′R), phenyl(Ph)(—C₆H₅), methoxy(—O—C), ethoxy(—O—C—C), siloxy(—O—Si—R₃), alkoxy(—O—R), hydroxy(—O—H), phenylethyl(—C—C—C₆H₅) and methyl,phenyl-ethyl(—C—C(—C)(—C₆H₅).

In general, embodiments of formulations for polysilocarb formulations may for example have from about 0% to 50% MH, about 20% to about 99% MH, about 0% to about 30% siloxane backbone additives, about 1% to about 60% reactive monomers, about 30% to about 100% TV, and, about 0% to about 90% reaction products of a siloxane backbone additives with a silane modifier or an organic modifier reaction products.

In mixing the formulations sufficient time should be used to permit the precursors to become effectively mixed and dispersed. Generally, mixing of about 15 minutes to an hour is sufficient. Typically, the precursor formulations are relatively, and essentially, shear insensitive, and thus the type of pumps or mixing are not critical. It is further noted that in higher viscosity formulations additional mixing time may be required. The temperature of the formulations, during mixing should preferably be kept below about 45° C., and preferably about 10° C. (It is noted that these mixing conditions are for the pre-catalyzed formulations.)

The Reaction Type Process

In the reaction type process, in general, a chemical reaction is used to combine one, two or more precursors, typically in the presence of a solvent, to form a precursor formulation that is essentially made up of a single polymer that can then be, catalyzed, cured and pyrolized. This process provides the ability to build custom precursor formulations that when cured can provide plastics having unique and desirable features such as high temperature, flame resistance and retardation, strength and other features. The cured materials can also be pyrolized to form ceramics having unique features. The reaction type process allows for the predetermined balancing of different types of functionality in the end product by selecting functional groups for incorporation into the polymer that makes up the precursor formulation, e.g., phenyls which typically are not used for ceramics but have benefits for providing high temperature capabilities for plastics, and styrene which typically does not provide high temperature features for plastics but provides benefits for ceramics.

In general a custom polymer for use as a precursor formulation is made by reacting precursors in a condensation reaction to form the polymer precursor formulation. This precursor formulation is then cured into a preform through a hydrolysis reaction. The condensation reaction forms a polymer of the type shown below.

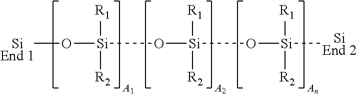

Where R₁ and R₂ in the polymeric units can be a hydride(—H), a methyl(Me)(—C), an ethyl(—C—C), a vinyl(—C═C), an alkyl(—R)(CₙH₂ₙ₊₁), an unsaturated alkyl(—CₙH₂ₙ₋₁), a cyclic alkyl(—CₙH₂ₙ₋₁), an allyl(—C—C═C), a butenyl(—C₄H₇), a pentenyl(—O₅H₉), a cyclopentenyl(—O₅H₇), a methyl cyclopentenyl(—O₅H₆(CH₃)), a norbomenyl(—CₓH_{y}, where X=7-15 and Y=9-18), an aryl(′R), a phenyl(Ph)(—C₆H₅), a cycloheptenyl(—C₇H₁₁), a cyclooctenyl(—C₈H₁₃), an ethoxy(—O—C—C), a siloxy a methoxy(—O—C), an alkoxy, (—O—R), a hydroxy, (—O—H), a phenylethyl(—C—C—C₆H₅) a methyl, phenyl-ethyl(—C—C(—C)(—C₆H₅)) and a vinylphenyl-ethyl(—C—C(C₆H₄(—C═C))). and R₂ may be the same or different. The custom precursor polymers can have several different polymeric units, e.g., A₁, A₂, Aₙ, and may include as many as 10, 20 or more units, or it may contain only a single unit, for example, MHF made by the reaction process may have only a single unit.

Embodiments may include precursors, which include among others, a triethoxy methyl silane, a diethoxy methyl phenyl silane, a diethoxy methyl hydride silane, a diethoxy methyl vinyl silane, a dimethyl ethoxy vinyl silane, a diethoxy dimethyl silane. an ethoxy dimethyl phenyl silane, a diethoxy dihydride silane, a triethoxy phenyl silane, a diethoxy hydride trimethyl siloxane, a diethoxy methyl trimethyl siloxane, a trimethyl ethoxy silane, a diphenyl diethoxy silane, a dimethyl ethoxy hydride siloxane, and combinations and variations of these and other precursors, including other precursors set forth in this specification.

The end units, Si End 1 and Si End 2, can come from the precursors of dimethyl ethoxy vinyl silane, ethoxy dimethyl phenyl silane, and trimethyl ethoxy silane. Additionally, if the polymerization process is properly controlled a hydroxy end cap can be obtained from the precursors used to provide the repeating units of the polymer.

In general, the precursors are added to a vessel with ethanol (or other material to absorb heat, e.g., to provide thermal mass), an excess of water, and hydrochloric acid (or other proton source). This mixture is heated until it reaches its activation energy, after which the reaction typically is exothermic. Generally, in this reaction the water reacts with an ethoxy group of the silicon of the precursor monomer, forming a hydroxy (with ethanol as the byproduct). Once formed this hydroxy becomes subject to reaction with an ethoxy group on the silicon of another precursor monomer, resulting in a polymerization reaction. This polymerization reaction is continued until the desired chain length(s) is built.

Preferably a catalyst is used in the curing process of the polymer precursor formulations from the reaction type process. The same polymers, as used for curing the precursor formulations from the mixing type process can be used. It is noted that, generally unlike the mixing type formulations, a catalyst is not necessarily required to cure a reaction type polymer. Inhibitors may also be used. However, if a catalyst is not used, reaction time and rates will be slower. The curing and the pyrolysis of the cured material from the reaction process is essentially the same as the curing and pyrolysis of the cured material from the mixing process and the reaction blending process.

The reaction type process can be conducted under numerous types of atmospheres and conditions, e.g., air, inert, N₂, Argon, flowing gas, static gas, reduced pressure, ambient pressure, elevated pressure, and combinations and variations of these.

The Reaction Blending Type Process

In the reaction blending type process precursor are reacted to from a precursor formulation, in the absence of a solvent. For example, an embodiment of a reaction blending type process has a precursor formulation that is prepared from MHF and Dicyclopentadiene (“DCPD”). Using the reactive blending process a MHF/DCPD polymer is created and this polymer is used as a precursor formulation. (It can be used alone to form a cured or pyrolized product, or as a precursor in the mixing or reaction processes.) MHF of known molecular weight and hydride equivalent mass; “P01” (P01 is a 2% Pt(0) tetravinylcyclotetrasiloxane complex in tetravinylcyclotetrasiloxane, diluted 20× with tetravinylcyclotetrasiloxane to 0.1% of Pt(0) complex. In this manner 10 ppm Pt is provided for every 1% loading of bulk cat.) catalyst 0.20 wt % of MHF starting material (with known active equivalent weight), from 40 to 90%; and Dicyclopentadiene with ≧83% purity, from 10 to 60% are utilized. In an embodiment of the process, a sealable reaction vessel, with a mixer, can be used for the reaction. The reaction is conducted in the sealed vessel, in air; although other types of atmosphere can be utilized. Preferably, the reaction is conducted at atmospheric pressure, but higher and lower pressures can be utilized. Additionally, the reaction blending type process can be conducted under numerous types of atmospheres and conditions, e.g., air, inert, N₂, Argon, flowing gas, static gas, reduced pressure, ambient pressure, elevated pressure, and combinations and variations of these.

Curing and Pyrolysis

Precursor formulations, including the polysiocarb precursor formulations from the above types of processes, as well as others, can be cured to form a solid, semi-sold, or plastic like material. Typically, the precursor formulations are spread, shaped, or otherwise formed into a preform, which would include any volumetric structure, or shape, including thin and thick films. In curing, the polysilocarb precursor formulation may be processed through an initial cure, to provide a partially cured material, which may also be referred to, for example, as a preform, green material, or green cure (not implying anything about the material's color). The green material may then be further cured. Thus, one or more curing steps may be used. The material may be “end cured,” i.e., being cured to that point at which the material has the necessary physical strength and other properties for its intended purpose. The amount of curing may be to a final cure (or “hard cure”), i.e., that point at which all, or essentially all, of the chemical reaction has stopped (as measured, for example, by the absence of reactive groups in the material, or the leveling off of the decrease in reactive groups over time). Thus, the material may be cured to varying degrees, depending upon its intended use and purpose. For example, in some situations the end cure and the hard cure may be the same. Curing conditions such as atmosphere and temperature may effect the composition of the cured material.

In making the precursor formulation into a structure, or preform, the precursor formulation, e.g., polysilocarb formulation, can be, for example, formed using the following techniques: spraying, spray drying, atomization, nebulization, phase change separation, flowing, thermal spraying, drawing, dripping, forming droplets in liquid and liquid-surfactant systems, painting, molding, forming, extruding, spinning, ultrasound, vibrating, solution polymerization, emulsion polymerization, micro-emuslion polymerization, injecting, injection molding, or otherwise manipulated into essentially any volumetric shape. These volumetric shapes may include for example, the following: spheres, pellets, platelets, sheets, flakes, rings, lenses, disks, panels, cones, frustoconical shapes, squares, rectangles, trusses, angles, channels, hollow sealed chambers, hollow spheres, blocks, sheets, coatings, films, skins, particulates, beams, rods, angles, slabs, columns, fibers, staple fibers, tubes, cups, pipes, and combinations and various of these and other more complex shapes, both engineering and architectural.

The forming step, the curing steps, and the pyrolysis steps may be conducted in batch processes, serially, continuously, with time delays (e.g., material is stored or held between steps), and combinations and variations of these and other types of processing sequences. Further, the precursors can be partially cured, or the cure process can be initiated and on going, prior to the precursor being formed into a volumetric shape. These steps, and their various combinations may be, and in some embodiments preferably are, conducted under controlled and predetermined conditions (e.g., the material is exposed to a predetermined atmosphere, and temperature profile during the entirely of its processing, e.g., reduced oxygen, temperature of cured preform held at about 140° C. prior to pyrolysis). It should be further understood that the system, equipment, or processing steps, for forming, curing and pyrolizing may be the same equipment, continuous equipment, batch and linked equipment, and combinations and variations of these and other types of industrial processes. Thus, for example, a spray drying technique could form cured particles that are feed directly into a fluidized bed reactor for pyrolysis.

The polysilocarb precursor formulations can be made into neat, non-reinforced, non-filled, composite, reinforced, and filled structures, intermediates, end products, and combinations and variations of these and other compositional types of materials. Further, these structures, intermediates and end products can be cured (e.g., green cured, end cured, or hard cured), uncured, pyrolized to a ceramic, and combinations and variations of these (e.g., a cured material may be filled with pyrolized material derived from the same polysilocarb as the cured material).

The precursor formulations may be used to form a “neat” material, (by “neat” material it is meant that all, and essentially all of the structure is made from the precursor material or unfilled formulation; and thus, there are no fillers or reinforcements).

The polysilocarb precursor formulations may be used to coat or impregnate a woven or non-woven fabric, made from for example carbon fiber, glass fibers or fibers made from a polysilocarb precursor formulation (the same or different formulation), to from a prepreg material. Thus, the polysilocarb precursor formulations may be used to form composite materials, e.g., reinforced products. For example, the formulation may be flowed into, impregnated into, absorbed by or otherwise combined with a reinforcing material, such as carbon fibers, glass fiber, woven fabric, grapheme, carbon nanotubes, thin films, precipitates, sand, non-woven fabric, copped fibers, fibers, rope, braided structures, ceramic powders, glass powders, carbon powders, graphite powders, ceramic fibers, metal powders, carbide pellets or components, staple fibers, tow, nanostructures of the above, polymer derived ceramics, any other material that meets the temperature requirements of the process and end product, and combinations and variations of these.

The polysilocarb precursor formulation may be used to form a filled material. A filled material would be any material having other solid, or semi-solid, materials added to the polysilocarb precursor formulation. The filler material may be selected to provide certain features to the cured product, the ceramic product and both. These features may relate to, or be, for example, aesthetic, tactile, thermal, density, radiation, chemical, cost, magnetic, electric, and combinations and variations of these and other features. These features may be in addition to strength. Thus, the filler material may not affect the strength of the cured or ceramic material, it may add strength, or could even reduce strength in some situations. The filler material could impart color, magnetic capabilities, fire resistances, flame retardance, heat resistance, electrical conductivity, anti-static, optical properties (e.g., reflectivity, refractivity and iridescence), aesthetic properties (such as stone like appearance in building products), chemical resistivity, corrosion resistance, wear resistance, reduced cost, abrasions resistance, thermal insulation, UV stability, UV protective, and other features that may be desirable, necessary, and both, in the end product or material. Thus, filler materials could include carbon black, copper lead wires, thermal conductive fillers, electrically conductive fillers, lead, optical fibers, ceramic colorants, pigments, oxides, sand, dyes, powders, ceramic fines, polymer derived ceramic particles, pore-formers, carbosilanes, silanes, silazanes, silicon carbide, carbosilazanes, siloxane, powders, ceramic powders, metals, metal complexes, carbon, tow, fibers, staple fibers, boron containing materials, milled fibers, glass, glass fiber, fiber glass, and nanostructures (including nanostructures of the forgoing) to name a few.

The polysilocarb formulation and products derived or made from that formulation may have metals and metal complexes. Filled materials would include reinforced materials. In many cases, cured, as well as pyrolized polysilocarb filled materials can be viewed as composite materials. Generally, under this view, the polysilocarb would constitute the bulk or matrix phase, (e.g., a continuous, or substantially continuous phase), and the filler would constitute the dispersed (e.g., non-continuous), phase. Depending upon the particular application, product or end use, the filler can be evenly distributed in the precursor formulation, unevenly distributed, distributed over a predetermined and controlled distribution gradient (such as from a predetermined rate of settling), and can have different amounts in different formulations, which can then be formed into a product having a predetermined amounts of filler in predetermined areas (e.g., striated layers having different filler concentration). It should be noted, however, that by referring to a material as “filled” or “reinforced” it does not imply that the majority (either by weight, volume, or both) of that material is the polysilcocarb. Thus, generally, the ratio (either weight or volume) of polysilocarb to filler material could be from about 0.1:99.9 to 99.9:0.1.

The polysilocarb precursor formulations may be used to form non-reinforced materials, which are materials that are made of primarily, essentially, and preferably only from the precursor materials; but may also include formulations having fillers or additives that do not impart strength.

The curing may be done at standard ambient temperature and pressure (“SATP”, 1 atmosphere, 25° C.), at temperatures above or below that temperature, at pressures above or below that pressure, and over varying time periods. The curing can be conducted over various heatings, rate of heating, and temperature profiles (e.g., hold times and temperatures, continuous temperature change, cycled temperature change, e.g., heating followed by maintaining, cooling, reheating, etc.). The time for the curing can be from a few seconds (e.g., less than about 1 second, less than 5 seconds), to less than a minute, to minutes, to hours, to days (or potentially longer). The curing may also be conducted in any type of surrounding environment, including for example, gas, liquid, air, water, surfactant containing liquid, inert atmospheres, N₂, Argon, flowing gas (e.g., sweep gas), static gas, reduced O₂, reduced pressure, elevated pressure, ambient pressure, controlled partial pressure and combinations and variations of these and other processing conditions. For high purity materials, the furnace, containers, handling equipment, atmosphere, and other components of the curing apparatus and process are clean, essentially free from, and do not contribute any elements or materials, that would be considered impurities or contaminants, to the cured material. In an embodiment, the curing environment, e.g., the furnace, the atmosphere, the container and combinations and variations of these can have materials that contribute to or effect, for example, the composition, catalysis, stoichiometry, features, performance and combinations and variations of these in the preform, the ceramic and the final applications or products.

Preferably, in embodiments of the curing process, the curing takes place at temperatures in the range of from about 5° C. or more, from about 20° C. to about 250° C., from about 20° C. to about 150° C., from about 75° C. to about 125° C., and from about 80° C. to 90° C. Although higher and lower temperatures and various heating profiles, (e.g., rate of temperature change over time (“ramp rate”, e.g., Δ degrees/time), hold times, and temperatures) can be utilized.

The cure conditions, e.g., temperature, time, ramp rate, may be dependent upon, and in some embodiments can be predetermined, in whole or in part, by the formulation to match, for example the size of the preform, the shape of the preform, or the mold holding the preform to prevent stress cracking, off gassing, or other phenomena associated with the curing process. Further, the curing conditions may be such as to take advantage of, preferably in a controlled manner, what may have previously been perceived as problems associated with the curing process. Thus, for example, off gassing may be used to create a foam material having either open or closed structure. Similarly, curing conditions can be used to create or control the microstructure and the nanostructure of the material. In general, the curing conditions can be used to affect, control or modify the kinetics and thermodynamics of the process, which can affect morphology, performance, features and functions, among other things.

Upon curing the polysilocarb precursor formulation a cross linking reaction takes place that provides in some embodiments a cross-linked structure having, among other things, an —R₁—Si—C—C—Si—O—Si—C—C—Si—R₂— where R₁ and R₂ vary depending upon, and are based upon, the precursors used in the formulation. In an embodiment of the cured materials they may have a cross-linked structure having 3-coordinated silicon centers to another silicon atom, being separated by fewer than 5 atoms between silicons.

During the curing process some formulations may exhibit an exotherm, i.e., a self heating reaction, that can produce a small amount of heat to assist or drive the curing reaction, or that may produce a large amount of heat that may need to be managed and removed in order to avoid problems, such as stress fractures. During the cure off gassing typically occurs and results in a loss of material, which loss is defined generally by the amount of material remaining, e.g., cure yield. Embodiments of the formulations, cure conditions, and polysilocarb precursor formulations of embodiments of the present inventions can have cure yields of at least about 90%, about 92%, about 100%. In fact, with air cures the materials may have cure yields above 100%, e.g., about 101-105%, as a result of oxygen being absorbed from the air. Additionally, during curing the material typically shrinks, this shrinkage may be, depending upon the formulation, cure conditions, and the nature of the preform shape, and whether the preform is reinforced, filled, neat or unreinforced, from about 20%, less than 20%, less than about 15%, less than about 5%, less than about 1%, less than about 0.5%, less than about 0.25% and smaller.

Curing of the preform may be accomplished by any type of heating apparatus, or mechanisms, techniques, or morphologies that has the requisite level of temperature and environmental control, for example, heated water baths, electric furnaces, microwaves, gas furnaces, furnaces, forced heated air, towers, spray drying, falling film reactors, fluidized bed reactors, lasers, indirect heating elements, direct heating, infrared heating, UV irradiation, RF furnace, in-situ during emulsification via high shear mixing, in-situ during emulsification via ultrasonication.

Further, after the cure, or after an initial cure, the cured material (e.g., green material, initial cure, final cure, or hard cure) may be held under a controlled environment, for example the cured material may be held at a control temperature, in a predetermined environment (e.g., water bath, low O₂ environment, high O₂ environment, liquid bath, liquid bath having additives, inert atmosphere, misting, gaseous atmosphere having additives, etc.). This control hold step can be used to affect the properties of the end product (cured, pyrolized and both), such as strength, and can be used to provide additives, or additional features to the end material or product.

In pyrolizing the preform, or cured structure, or cured material, it is heated to about 600° C. to about 2,300° C.; from about 650° C. to about 1,200° C., from about 800° C. to about 1300° C., from about 900° C. to about 1200° C. and from about 950° C. to 1150° C. At these temperatures typically all organic structures are either removed or combined with the inorganic constituents to form a ceramic. Typically at temperatures in the about 650° C. to 1,200° C. range the resulting material is an amorphous glassy ceramic. When heated above about 1,200° C. the material typically may from nano crystalline structures, or micro crystalline structures, such as SiC, Si3N₄, SiCN, β SiC, and above 1,900° C. an α SiC structure may form, and at and above 2,200° C. α SiC is typically formed. The pyrolized, e.g., ceramic materials can be single crystal, polycrystalline, amorphous, and combinations, variations and subgroups of these and other types of morphologies.

The pyrolysis may be conducted under may different heating and environmental conditions, which preferably include thermo control, kinetic control and combinations and variations of these, among other things. For example, the pyrolysis may have various heating ramp rates, heating cycles and environmental conditions. In some embodiments, the temperature may be raised, and held a predetermined temperature, to assist with known transitions (e.g., gassing, volatilization, molecular rearrangements, etc.) and then elevated to the next hold temperature corresponding to the next known transition. The pyrolysis may take place in reducing atmospheres, oxidative atmospheres, low O₂, gas rich (e.g., within or directly adjacent to a flame), inert, N₂, Argon, air, reduced pressure, ambient pressure, elevated pressure, flowing gas (e.g., sweep gas, having a flow rate for example of from about from about 15.0 GHSV to about 0.1 GHSV, from about 6.3 GHSV to about 3.1 GHSV, and at about 3.9 GHSV), static gas, and combinations and variations of these.

The pyrolysis is conducted over a time period that preferably results in the complete pyrolysis of the preform. For high purity materials, the furnace, containers, handling equipment, and other components of the pyrolysis apparatus are clean, essentially free from, free from and do not contribute any elements or materials, that would be considered impurities or contaminants, to the pyrolized material. A constant flow rate of “sweeping” gas can help purge the furnace during volatile generation. In an embodiment, the pyrolysis environment, e.g., the furnace, the atmosphere, the container and combinations and variations of these, can have materials that contribute to or effect, for example, the composition, stoichiometry, features, performance and combinations and variations of these in the ceramic and the final applications or products.

During pyrolysis material may be lost through off gassing. The amount of material remaining at the end of a pyrolysis step, or cycle, is referred to as char yield (or pyrolysis yield). The formulations and polysilocarb precursor formulations of embodiments of the present formulations can have char yields for SiOC formation of at least about 60%, about 70%, about 80%, and at least about 90%, at least about 91% and greater. In fact, with air pyrolysis the materials may have char yields well above 91%, which can approach 100%. In order to avoid the degradation of the material in an air pyrolysis (noting that typically pyrolysis is conducted in inert atmospheres, reduced oxygen atmosphere, essentially inert atmosphere, minimal oxygen atmospheres, and combinations and variations of these) specifically tailored formulations can be used. For example, formulations high in phenyl content (at least about 11%, and preferably at least about 20% by weight phenyls), formulations high in allyl content (at least about 15% to about 60%) can be used for air pyrolysis to mitigate the degradation of the material.

The pyrolysis may be conducted in any heating apparatus that maintains the request temperature and environmental controls. Thus, for example pyrolysis may be done with gas fired furnaces, electric furnaces, direct heating, indirect heating, fluidized beds, kilns, tunnel kilns, box kilns, shuttle kilns, coking type apparatus, lasers, microwaves, and combinations and variations of these and other heating apparatus and systems that can obtain the request temperatures for pyrolysis.

Custom and predetermined control of when chemical reactions, arrangements and rearrangements, occur in the various stages of the process from raw material to final end product can provide for reduced costs, increased process control, increased reliability, increased efficiency, enhanced product features, increased purity, and combinations and variation of these and other benefits. The sequencing of when these transformations take place can be based upon the processing or making of precursors, and the processing or making of precursor formulations; and may also be based upon cure and pyrolysis conditions. Further, the custom and predetermined selection of these steps, formulations and conditions, can provide enhanced product and processing features through the various transformations, e.g., chemical reactions; molecular arrangements and rearrangements; and microstructure arrangements and rearrangements.

The following specific illustrative embodiments of processes, apparatus, systems and methods for making small volumetric shape PDC preforms and PDCs.

Tower Systems

In general tower type systems typically involve the formation of beads, droplets or particles, of a precursor at, or in, the top of a column having an internal cavity. The cavity's internal environment, can be open to, partially isolated from, or completely isolated from the external environment. The column, and in particular the internal cavity, has a controlled environment, that may contain a vacuum, liquids or gases, and preferably is a gas. The column has a source of heat that heats the environment within the cavity, in particular where the beads are dropped into after forming. The beads are cured as they fall down the heated cavity. The internal cavity environment, may also be controlled for other factors related to curing of the preform. While in general, it is preferred that the beads are dropped down the cavity, they may be carried up it by flowing media (e.g., gas stream) or may be carried up it by density effects. Thus, while top down motion is preferred, bottom up motion, semi-static, and horizontal motion is also contemplated. Sonic devices, lasers, filaments, sprayers, droppers, nozzles, jets, vibrating devices, and other mechanical, non-mechanical and combinations of both types of devices can be used to form the beads at the top of the tower's cavity.

Embodiments of bead, droplet and particle forming apparatus, systems and devices that may be utilized with a tower systems, as well as with other embodiments, include the following general types of droplet forming apparatus, for example, pressure-driven droplet ejection, flow-driven droplet ejection, acoustic droplet ejection; shear-induced droplet creation from secondary flowing media (i.e., shear-flow droplet creation), and combinations and variation of these. In pressure driven systems typically a value is used to start and stop droplet formation. These valves can be, for example, solenoid and piezo types. Actuators that can be used with these forming apparatus and other apparatus for the generation of beads, droplets and particles includes, for example, piezo-electric actuation, pressure reservoir actuation, syringe/positive displacement actuation, vibratory actuation, electromagnetic (E&M) actuation, phase-change actuation and combinations and variations of these.

Embodiments of bead, droplet and particle generation devices using these forming and actuation apparatus include, for example, inkjet apparatus (e.g., discrete flow such that individual drops are produced on demand by a large pressure gradient induced by a rapidly actuated force generator), vibratory Raleigh continuous stream breakup (e.g., continuous flow superimposed with an acoustic wavefront that induces Raleigh-breakup) and aerosol (e.g., reservoir of fluid experiences acoustic energy that induces surface modulation resulting in droplet ejection from surface of reservoir) type devices.

These bead, droplet and particle generation systems have the capability to operate at about 150 Hz and greater, at about 300 Hz and greater, at about 1,000 Hz and greater, about 2,000 Hz and greater, at 3,000 Hz and greater, from about 150 Hz to about 3,000 Hz, from about 3,000 Hz to about 6,000 Hz, from about 50 Hz to about 7,000 Hz, although higher and lower frequencies may be possible. These bead, droplet and particle generation systems have the capability to control size distribution of the formed particles (e.g., variation in particle size during a production run) to less than about 10%, less than about 5%, and preferably less than about 3%, and more preferably less than about 1%, for applications where uniformity is desirable. In a preferred embodiment the bead generation device utilizes forming and actuation apparatus that have little or no sensitivity to the viscosity of the PDC precursor formulation. Thus, in this preferred embodiment changes in viscosity of the formulation, e.g., from the running of different formulations, will have little to no effect on drop generation performance.

Further devices and processes that may be used for bead, particle and droplet generation would include, for example, water atomization, gas-blast atomization, ultrasonic nebulizers, air-assisted ultrasonics, spray foggers, smoke machines, ultrasonic extrusion systems, impeller-emulsion systems, suspension polymerization, coating and flaking systems, microcellular foam systems, chemical foam systems, gas-assisted atomization, aeration foaming systems, frothing systems, spray cooling, spray pyrolysis, centrifugal atomization, spark erosion, direct-spray atomization, and combinations and variations of these.

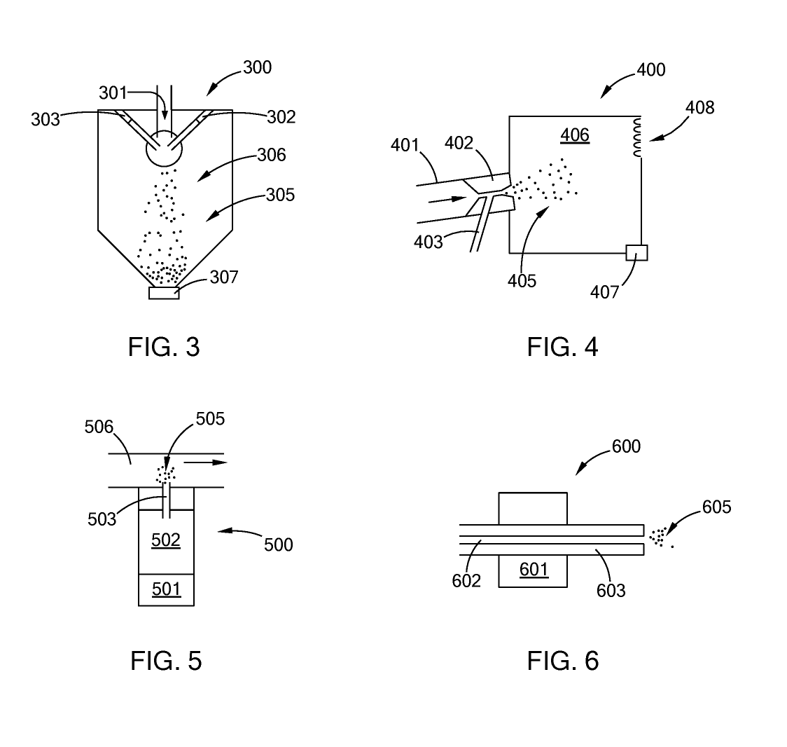

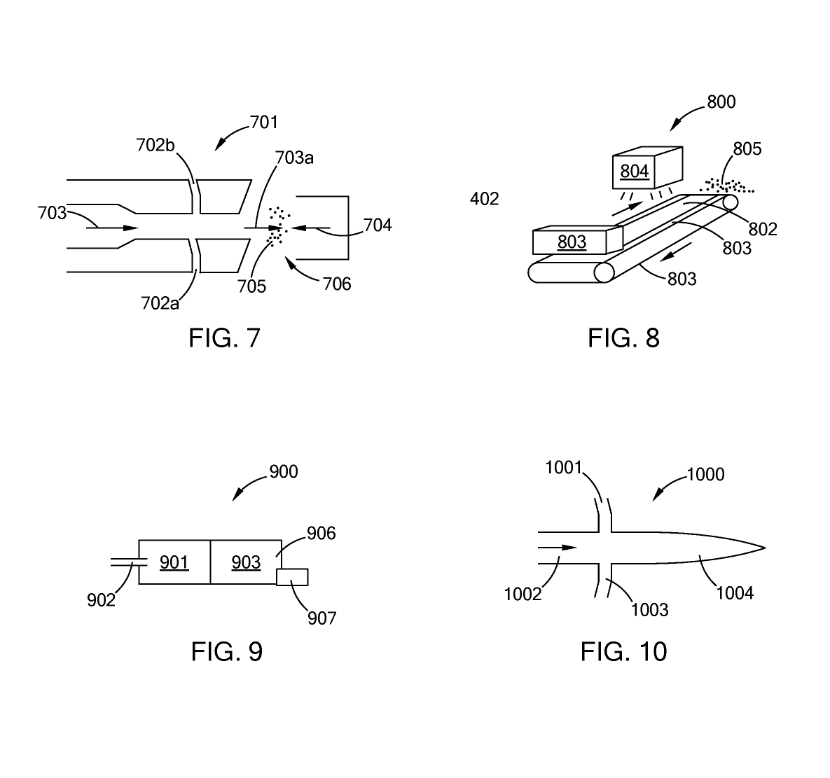

FIGS. 3 to 7, and 9-10 provide examples of embodiments of bead, droplet and particle generation devices and processes. Turning to FIG. 3 there is shown a high pressure jet system 300. The system 300 has a first jet 302 and a second jet 303 that imping upon inflowing PDC precursor 301. The impingement of the jets 302, 303 in the impingement zone (shown by circle 304), causes the PDC precursor to form into particles 306 that are cured 305 and collected and taken away by removal device 307 (which could be a valve, gate, conveyor, etc.). The jets 302, 303 can be high pressure water, steam, high pressure gas, and combinations and variations of these. Turning to FIG. 4, there is shown an atomization system 300. The system 400 has a gas flow line 401, feeding nozzle 402. The nozzle 402 has a PDC precursor in feed line 403. PDC particles 305 are formed and cured in area 306. The cured particles 305 are removed via removal device 407 (which could be a valve, gate, conveyor, etc.). A vent and filter 408 allows for the escape of excess gases, and the management of internal pressures. Turning to FIG. 5, there is shown an ultrasound system 500. The system 500 has an ultrasonic generator 501, that stimulates the PDC precursor 502, causing the PDC precursor to move into and out of fountain nozzle 503, where PDC particles 505 are formed in carrying gas 506, which may also be headed to cure the particles 505. Turning to FIG. 6, there is shown a piezo electric system 600. The system 600 has a piezo generator 601, that surrounds a horn 603, having a channel 602 containing PDC precursor. The horn in conjunction with the piezo cause the generation of PDC particles 605. Turning to FIG. 7, there is shown a reflective resonance system. The system has a nozzle 701 that has PDC precursor in feeds 702a, 702b. The PDC precursor is feed via the in feeds into gas stream 703, which leaves the nozzle 702, as shown by arrow 703a, strikes a reflector, causing a backward, or counter gas flow 704, and the resultant PDC particle 705 formation in zone 706 (where the particles may also be cured). Turning to FIG. 9, there is shown a foam system 900. The system has a foam generator 901 that has a PDC precursor in feed line 902, a foam breaker 903, where PDC particles are formed and cured 906 and a removal device 907. Turning to FIG. 10, there is shown a spray pyrolysis system 1000. The system 1000 has a gas/fuel inflow 1002, a PDC precursor in feed 1001, and a second in feed 1003 (which may be a second PDC precursor formulation, r an O₂ source, fuel, or other gases or materials as additives). The PDC precursor is formed into particles and pyrolized in zone 1004.

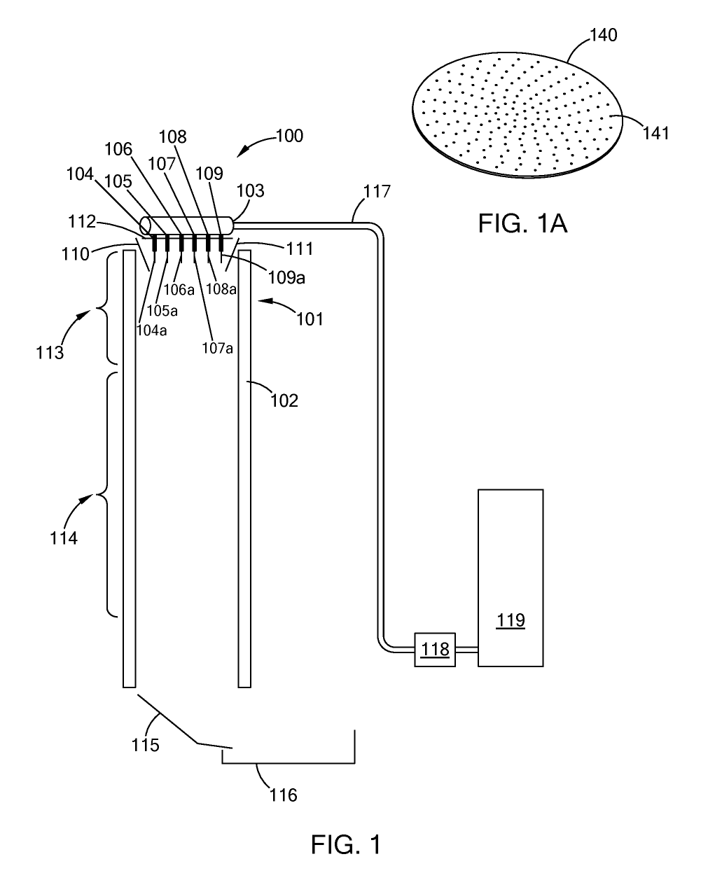

Now turning to FIG. 1 there is provided an embodiment of a tower type bead preform forming and curing system 100. The system 100 has a curing tower 101, a tank 119 for holding the polysiloxane precursor batch, a metering device 118 for transferring the batch along feed line 117 to a distribution header 103. Mixing, agitating, commingling, pumping, flow control, reactor, and regulating devices may also be utilized in transferring, handling and metering of the precursor batch. The distribution header 103 has nozzle assemblies 104, 105, 106, 107, 108, 109 having nozzles 104a, 105a, 106a, 107a, 108a, 109a respectively. Heat shields 110, 111, 112 protect the nozzle assemblies and distribution header from being damaged by the heat of the tower 101, or from overheating or otherwise adversely affecting the temperature of the nozzle assemblies and distribution header. For example, they prevent the temperature to rise to the point where the batch would cure in the distribution header or nozzle assembly thus clogging them. The heat shields may utilize air, such as with an air knife, metallic, ceramic, gas, oil, fluid, chemical, heat exchangers, reflectors, water, and others.

The tower 101 has wall 102 containing heating units, as well as, insolation and control devices for the heating units. In the embodiment of FIG. 1 the tower is configured to have two zones: a first or forming zone 113; and a second or curing zone 114. Depending upon the size, e.g., volume, mass, of the beads, balls, particles or spheroids being formed, the forming zone 113 should have sufficient height, and a temperature selected for that height, that allows the drops of precursor material leaving a nozzle to form a predetermined shape, for example, as perfect a sphere as is possible, before or when the drop transitions (e.g., falls from zone 113 to zone 114) into curing zone 114. Curing zone 114 should have sufficient height, and a temperature selected for that height, to cure the preform proppants into hard enough structures that their striking the diverter 115 and being collected and held in the pan 116 does not adversely affect their shape. Additional curing, e.g., a hard cure can take place in the pan 116, in another furnace, or in a third zone in the tower.

Although two temperature zones and six nozzles are utilized in the embodiment of FIG. 1, more or less zones and nozzles may be used. Thus, there may be a single zone or nozzle, two zones or nozzles, a dozen zones or nozzles, or more, and combinations and variations of these. A distribution plate, such as shown in FIG. 1A may be used. The distribution plate 140 has 10s, 100s or more openings, e.g., 141, through which drops are formed. It is further understood that in addition to nozzles other types of devices may be used at the top of the tower to initially form or shape the drop of precursor material that becomes the bead, ball, sphere. Thus, filaments, vibrating filaments that drip the precursor at a controlled rate and under controlled conditions may be used, as well as, various spraying, dispensing, and forming techniques and apparatus discussed in the specification. Other apparatus may also be employed to form the precursor batch into a spherical type structure and then cure that structure with minimal or no adverse consequences to the shape of the preform.

In general, and for example, for the purposes of making beads, balls or proppants one or more of the process parameters and equipment set forth in table 1 can be used in tower type embodiments, as well as other embodiments.

TABLE 1

| Nozzle | Thermal Heat Exchanger | Curing Process |
|---|---|---|
| Production of proppant beads | Temperature range 0 to 1600 C. | Temperature range 0 to 1600 C. |
| thru the use of internal and | multi zone/range controlled | multi zone/range controlled |
| external orifices, atomization | | (manually or automated - local or |
| mechanically, pressure, and gas | | remote) |
| to produce tight mesh distribution | | |
| (within 1 to 5 mesh sizes of | | |
| target size) beads ranging from | | |
| 2000 micron to 75 micron. | | |
| Produced thru the use of a | Air, Steam, Electrical, Gas, | Phased curing process in part or |
| temperature compensated | Waste Heat, or Solar source of | whole |
| (liquid, air, gas, radiant, or | heat | |
| mechanical) controllable one or | | |
| more active orifices or filament, | | |
| (vibration, heat, pressure, | | |
| pulsation, 20 Hz to 20,000 Hz | | |
| frequency) | | |
| Orifices or filament material; | Material of Construction - | Air or inert gas controlled |
| made from metal, composite, | metallic, composite, fire brick, or | atmosphere |
| plastic, precious metal, jewel, or | ceramic | |
| ceramic, | | |
| Gravity or pressure compensated | Radiant, convection, direct heat, | Air, Steam, Electrical, Gas, |
| orifices or filament | | Waste Heat, or Solar source of |
| | | heat |
| Continuous operation and flow; | Vertical to horizontal orientations | Heat transferring media of air, |
| or batch process | | inert gas, radiant, convection, |
| | | condensing, vapor, or direct heat |
| Viscosity range 1 to 1000 | Up to and including Adiabatic | Multi Chambered or portioned |
| | enabled | |
| Static and dynamic particle | 1′ to 500′ Structure Height | Continuous and batch |
| processing | | |
| | Multi Chambered or portioned | Static and dynamic particle |
| | | processing |
| | Heat transferring media of air, | |
| | inert gas, radiant, convective, | |
| | condensing, vapor, or direct heat | |
| | Static and dynamic particle | |
| | processing | |

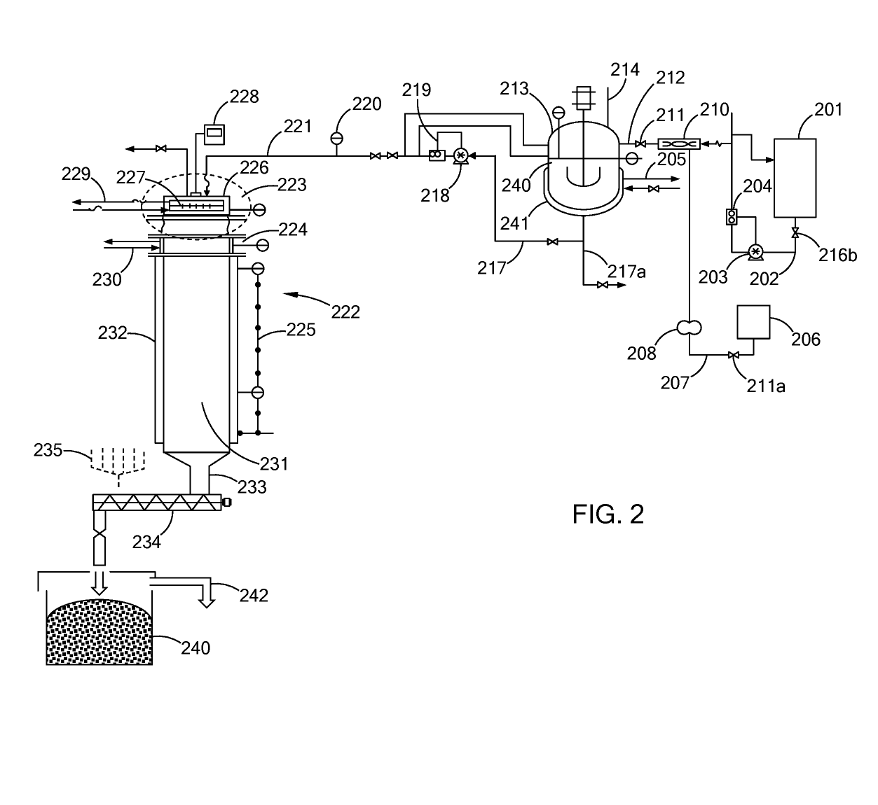

Turning to FIG. 2 there is provided an embodiment of a tower type bead manufacturing system for making spherical and other types of beads, for use, for example, as proppants for hydraulic fracturing, abrasives, additives, etc. The manufacturing process of this embodiment includes several operations such as mixing, blending, dispensing, curing, cooling and storage. It will be understood that not all of the listed operations is required, and additional operations and other combinations of operations may be used, to manufacture the contemplated beads.

In this embodiment, feed material and catalyst are maintained in individual storage tanks 201 and 206, respectively. The feed material generally includes the PDC precursor materials necessary to manufacture a bead with the desired properties.

The feed material may include a single ingredient or a mixture of ingredients. In addition, one or more storage tanks may be employed to contain one or more single ingredients or ingredient mixtures.

Feed material is pumped through line 202 via gear pump 203 to mixer 210. Pumps used in the manufacturing process may be any kind of pump that will sufficiently move the feed material through the lines, and in this instance to the mixer 210. Line 202, has pump 203, controller 204, and valves 211, 216b. For example, pumps used in the process may be a centrifugal or positive displacement design with components, such as impellers and pistons, and operating parameters, such as pressure and flow rate, being selected to sufficiently handle the feed. In this case, gear pump 203.

Pump 203 is controlled by controller 204 which can include any type of feedback loop suitable for the operation. Controller 204, for example, includes an FIC loop that senses the flow of feed in line 202 and adjusts pump 203 in accordance with a predetermined flow setpoint.

Additional controllers may be used in system to control process variables such as flow, pressure, temperature, and level of feed material, liquid or catalyst by fully or partially opening or closing a valve, pump, heater, or other operation in response to signals received from controllers that compare a setpoint to a measured process variable which is detected by and provided by sensors. Pumps 208, valves 211 and tap lines or spouts (not shown) may be deployed throughout the system in locations commonly understood for control, sampling, safety efficiency operation and the like.

Catalyst in catalyst tank 206 is fed through line 207 via metering pump 208 to static mixer 210. There, catalyst and feed material from line 202 join together to form the desired mixed product, normally homogeneous. As with gear pump 203, metering pump 208 need not be of any particular design and may be controlled in any commonly understood manner.

A variety of mixers may be used. For example, mixer 210 may be static, such as a plate type. The mixer may also be dynamic. The mixer may be positioned in a horizontal, vertical or angled position and may include paddles, blenders, impellers and other components and be of sufficient size, shape and operation so as to provide a homogeneous mixture of upstream materials. Preferably the mixer is continuous or semi-continuous, and one or more mixers may be employed.

The mixture of feed and catalyst proceeds through value 211 in line 212 to blending tank 213. Blending tank 213 may comprise any type of mixer and include components such as those already described for suitable mixing of the feed and catalyst mixture introduced. Blending tank 213 also may include appropriate outlets, such as drains 217 and 217a.

The tank holds the mixture 240 and may be operated at a speed, temperature, and pressure to yield a cleansed and desired blended mixture. The blender may be controlled in a manner normally accepted and already described for process variables such as level, temperature, pressure, flow, and viscosity.

Temperature control media, for cooling or heating, may be fed into or adjacent to all or a portion of the blending tank. In this instance, cooling media is circulated through line 205 to a jacket 241 surrounding the exterior of the lower portion of tank 213.

Inside the blending tank, the mixture 240 may be washed with cleaning solution added via line 214. While preferably washed in the blending tank, the catalyst and feed material may be cleansed separately before mixing and once mixed at other locations downstream.

The blended mixture is fed through line 217 by gear pump 218 operating in conjunction with controller 219 in a manner already contemplated. Typically, the pressure of the feed and mixing system is set by a back pressure or pressure control system known to the art and monitored through one or more pressure indicators, such as pressure indicator 220.

The blended mixture is fed in line 221 to column 222, which generally includes feed zone 223 cooling zone 224 and curing zone 225.

Feed zone 223 includes nozzle header 226 including one or more nozzles (not shown) set in nozzle manifold 227. Feed zone 223 is maintained at a temperature to ensure flowability, a proper viscosity, and to reduce, or control the reaction, in line 229, which is a circulation loop for the precursor feed to the manifold 227.

In accordance with the process of this embodiment one or more nozzles in feed zone 223 may be vibrated in connection with distribution of the mixture by the nozzles. The vibration may be effected via vibration controller 228 which may be connected to one or more components in the feed zone area, including line 221, nozzle manifold 227 or the nozzles. The nozzle vibrator controller may be any such kind of controller known for providing and controlling vibration of the nozzles.

The nozzles should be shaped and sized to achieve a usable and generally spherical proppant product as contemplated. Preferably, the nozzle size will range between about 20 and 800 microns and most preferably between about 50 and 400 micron.

Nozzles contemplated for use in the manufacturing process include those manufactured by Buchi and by Brace, among others.

When fed through the one or more nozzles a bead is produced. Preferably, the selected nozzle will produce a bead that is approximately two times the size of the orifice.

The bead flows downwardly through cooling zone 224, which is kept with the aid of temperature control media 230. The beads exit cooling zone 224 into curing zone 225.

Curing zone 225 includes curing column 231 and heaters 232. The curing column may be constructed of any typical material to allow for the dropping and curing particles to form the contemplated shape of proppants. Curing columns may be fabricated or purchased from various suppliers.

The nozzles may be vibrated at a frequency of 5 to 300 Hz, preferably 15 to 200 Hz. It being understood that vibratory frequency, related to drop size, shooting flow rate, fluid viscosity and surface tension. For the manufacture of spherical beads having about 200 to about 1,000 micron diameters using the formulations of polysilocarb precursors, such as those disclosed in US Patent Publication No. 2014/0326453 (the entire disclosure of which is incorporated herein by reference) the nozzle vibratory frequency, for example, can be from about 700 Hz to about 1,500 Hz.

The curing column is maintained at a temperature. Heaters 232 are associated with the curing column to maintain the temperature with the column. The heaters may be arranged in one or more zones throughout the column. Preferably, the heaters are arranged in zones.

The beads exit curing zone 225 through downspout 233 onto ramp 234. Ramp 234 (which could be for example any type of conveyance systems such as a belt or screw conveyor) can be maintained at a constant and predetermined temperature. As shown by dashed symbol 235, there are contemplated several column assemblies that feed into ramp 234, bin 240 and both.

The beads exit ramp 234 and are collected in bin 240 or the like. At this point, the beads, which may be called green proppant, may be stored or further processed. Bin 240 can have a vent or over flow 242, or can be sealed, have a controlled atmosphere, or be used as a hold tank for holding the beads in a controlled holding atmosphere.

Alternatively, the beads may be further processed with additional treatment in order to effect the curing. For example, the beads by further exposed to a heat temperature to hard cure. The hard cure may be carried out in an inert atmosphere, such as Argon, and at low levels of oxygen. The beads may be exposed to one or more additional heat treatment steps, including exposure to temperature ranges between 1000 and 1100 degrees C.

A plate such as the embodiment of FIG. 1A may also be used. The diameter of the plate can be greater than 1 foot, greater than 2 feet, greater than 4 feet and greater than 6 feet. As larger diameters are used, e.g., greater than 2 feet, the ability to provide uniform heating to all of the beads across the width of the column as they fall through the column is addressed. It is preferable that the radiant heat applied to the beads across the width of the nozzle be uniform and flat, e.g., energy that beads are exposed to at any point along the length of the column is the same across the width of the column at that length. In considering the gas flow and temperature profiles of the column, factors such as bead formation kinetics, catalyst, material properties (e.g., composition, phase, viscosity, inner stress, etc.) should be considered. Turbulence in the column is a factor to consider, and in general should be controlled to prevent the beads from unnecessary contacting each other or the side walls, until at least they have been sufficiently formed so that such collisions do not adversely affect their shape. A potential source of turbulence is the added pressures that can arise in a column from the vaporization of the precursor in the column. For example, if there was a 10% vaporization of 300 g of precursor added to a column, the pressure in the column could be increased to about 190 psig. To address the issues that may arise from this increased pressures in the column, preferably the column can be operated under reduced pressure with the excess gases being removed from the column in a manner that controls pressure; reduces, mitigates, or controls any pressure increase in the column; and preferably addresses, reduces, eliminates or mitigates any pressure induced turbulence in the column.

For example a reduced pressure zone could be maintained at the top of the column near to the nozzle. In this manner the beads could form, and initially cure to having a shell, preferably a hard shell, before they fell into an area of the column with greater pressures, and greater flow, and turbulence. Further, laminar flow, in particular in the area of formation and in the area of high pressure could be used. This would further permit the beads to form, and cure without having unnecessary or damaging collisions.

Liquid-Liquid Systems

Generally, in the liquid-liquid type systems a liquid precursor is formed into a bead, droplet or particle, in a liquid, and then preferably cured in that liquid. The precursor bead, droplet or particle, may be initially exposed to a gas before being placed in the liquid; however, for these types of processes, it is preferred that the bead, droplet or particle be formed directly in the liquid, with the precursor not being exposed to any gas during formation and initial curing. Polymer emulsification, solution polymerization, solution bead forming, nano-emulsification, and similar types of system can be used to make small volumetric shapes from precursor formulations. In these systems a liquid phase—liquid phase process, forms small, and very small, i.e., a few inches, to microns, to submicron, size beads, droplets or particles, of the precursor formulation; and then preferably cures them in the second liquid phase. Thus, these types of systems in general form beads of liquid precursor material in another liquid, e.g., bulk liquid phase, second liquid, continuous phase, or continuum. The beads, upon forming, are then sufficiently cured in the second liquid phase, e.g., the continuous phase, so that their shape, and other predetermined properties, are locked in, to the extent needed for subsequent processing or use, e.g., storage, pyrolysis, machining, etc. Larger and smaller size beads may also be made.

Embodiments of bead, droplet and particle generating and forming apparatus, systems and devices that may be utilized with a liquid-liquid system include those discussed above for the tower systems.

Further, the liquid-liquid techniques can be combined with other forming and curing techniques. Thus, for example a liquid-liquid precursor suspension could be spray-dry to initiate cure and simultaneously drive off the excess H₂O. Similarly, the liquid-liquid precursor suspension could be used in the other forming and curing techniques and technologies, among those provided in this specification and others. Thus, in the liquid-liquid embodiments as well as others, the beads or particles can be formed in the liquid, cured in the liquid, formed in a non-liquid environment, cured in a non-liquid environment and combinations and variations of these.

Beads formed with the first and second liquid phase can be added to a third or fourth liquid phase to coat the particles or beads with another polymer, a surfactant and combinations of these and other materials, as well as to cure the particles.

Embodiments of the present systems control parameters relating to particle size distribution in these liquid-liquid systems, which include among other parameters, surface tension, viscosity, temperature, volume fraction of dispersed phase (e.g., the precursor), polymerization (e.g., curing), process, surfactants, the action of adsorbed surfactants, and the hydrodynamic flow conditions of the system.

In some embodiments it may be thermodynamically more favorable for bulk material separation, over a dispersion, due to the increased surface area (and consequential surface energy) associated with an emulsion. Consequently, energy input is required to generate an emulsion. Thus, it is theorized that the notion of a ‘stable’ emulsion is thermodynamically flawed, but kinetically possible via the addition of surfactants/emulsifying agents to the system, which prohibit coalescence of formed droplets into a bulk phase or agglomeration.

Preferably, in embodiments of the present systems, it is theorized that the ultimate particle size distribution is a result of the steady state formed between droplet break-up and droplet coalescence phenomena. By increasing the ease of droplet break-up and increasing the barrier to droplet coalescence, emulsions can be driven to smaller and smaller average particle sizes.

Generally, higher temperatures, volume fractions of the dispersed phase, and viscosities tend to increase average particle size. Higher surfactant concentrations and more energetic hydrodynamic flow conditions tend to decrease average particle size.

Typically, upon polymerization, e.g., curing, the polymer will exhibit solid colloidal properties that are distinct from the starting material phase, e.g., a monomer precursor, or for polysilocarb precursors a liquid polymer. Consideration should preferably be made of the adsorption and agglomeration properties of the cured precursor with respect to the liquid precursor to preferably ensure that the cured particles do not aggregate. For some embodiments aggregation or agglomeration may not be an undesirable result. Moreover, for some applications, if, for example, the agglomerate can be readily broken apart at a later time, such agglomeration can be very beneficial, both from safety issues, e.g., avoids handing very small particles and dusting issues, and from performance issues, e.g., requires little energy to break the agglomerate down to a smaller particle size preferred or required for use in some application.

While many sizes of particles are contemplated. Particle sizes, preferably obtained via liquid-liquid systems, e.g., emulsion and solution systems, can range from about 0.1 microns (μm) to about 4 mm (5 U.S. Mesh), although large and smaller sized may be obtained. Embodiments of various particle size systems, would include for example: micro-systems (e.g., about 10-100 nm dispersed particle size); mini-systems (e.g., about 100-1000 nm dispersed particle size); macro-systems (e.g., about 0.5-200 μm dispersed particle size; and, about 400 mesh (37 μm) to about 10 mesh (2,000 μm)). It should be noted that this nomenclature is to define a particle size range, and does not necessarily limit the process used to obtain that particle size.

Suspension polymerization type processes, e.g., the initiator of polymerization is soluble in the dispersed monomer phase, and emulsion polymerization type processes, e.g., the initiator is soluble in the continuous phase, can be used to form small volumetric precursor shapes, which can already be cured, or can then be cured, and pyrolized.

The following discussion and theories are provided to further explain and illustrate the liquid-liquid system processes by with PDC precursor volumetric shapes, PDC preforms, and preferably polysilocarb volumetric shapes, are made. It is noted that there is no requirement to provide such explanation or theory underlying the novel and groundbreaking features and properties that are the subject of, or associated with, embodiments of the present liquid-liquid systems for forming volumetric shape PDC preforms. Nevertheless, various theories are provided to further advance the art in this important area. These theories, unless expressly stated otherwise, in no way limit, restrict or narrow, the scope of protection to be afforded the claimed inventions.

Surface tension typically contributes a positive energy to the system, and thus, the free energy is minimized when the surface energy is minimized. It may prove advantageous in determining a system to model the Gibbs Free Energy of the system, and view this as having a number of contributions. Thus, looking at the bulk and surface energy contributions (in a constant temperature and pressure environment):

The bulk energy of the system is volume dependent. In the case of an emulsion, no volume change is occurring—merely the rearrangement of a given volume of liquid into different geometric orientations.

dG=dE_{Bulk}+dE_{surface}

However, surface energy content of the Gibbs energy does change as a function of geometry according to:

dE_{Bulk}−0

Where γ is the surface tension of the interface and A is the area.

It can thus be theorized that in general the minimum free-energy state requires a minimization of the surface area for a constant volume system. However, the presence of a global minimum in the Gibbs Free Energy surface does not preclude the formation of a metastable emulsion if the global minimum condition (i.e. bulk separation) is not kinetically accessible.

In general, there can typically be two types of quasi-stable emulsions, —metastable emulsions and steady state emulsions; although other characterizations and types can exist. In this context, stable means a relatively constant particle size distribution.

The first general type is a metastable emulsion. Via mechanisms that will be discussed below, the free energy of a particle in a continuous medium can have a local minimum. If this minimum is deep enough, the kinetic path to establishing the global minimum condition (or bulk condition) is inaccessible energetically and consequently a local equilibrium condition requiring no additional energy input, or metastable emulsion, can be produced. However, true metastability is rare in practical systems.

The second type of quasi-stable emulsions—steady state emulsions, is more typically observed. Thus, most ‘stable’ emulsions are not in thermodynamic equilibrium at all, but merely systems in a steady state condition where the rates of droplet “break-up” and the rate of droplet “coalescence” are equal. In some embodiments, it is generally sufficient, and preferable, that the emulsion remains in tact for sufficient time to cure the beads, or otherwise prevent their agglomeration prior to subsequent use or processing, e.g., hard curing, further curing, milling, or pyrolysis.

In a typical liquid-liquid emulsion process the to-be-dispersed phase, e.g., the monomer, or the polysilocarb precursor polymer, is introduced into the continuous phase, e.g., an aqueous phase, in bulk or larger than desired particle sizes. In order to achieve emulsification, energy generally should be added to the system to induce the break-up of the to-be-dispersed phase into smaller and smaller droplets due to the increase in surface area associated with smaller droplets. The minimum energy input to achieve a desired particle size can be quantified by the equation:

dE_{surface}=γdA

for constant surface tension (γ), which is reasonable to assume until typically micro-scales. Thus, achieving very small particle diameters, because of the rapid increase in surface area with decreasing diameters, requires high energy inputs.

The minimum energy shape of a droplet is a sphere due to the local minimization of surface area. Typically, in order to break-up a droplet it generally should first be made into a non-spherical shape, or elongated. The Laplace Pressure

$$Δ P = \frac{4 γ}{D}$$

where D is the particle diameter, resists elongation and is known as the maintenance force. The force applied to elongate the droplet is called the disruptive force and is typically described in terms of shear stresses.

The non-dimensional Weber Number

$$We = \frac{ρ {v}^{2} l}{γ}$$

where ρ is the density, v the velocity, and l the length scale of the system, can be a useful tool for understanding whether a droplet will be broken up when a certain energy input is provided. The Weber Number gives the ratio between disrupting forces and maintaining forces, such that above a certain Weber Number (achieved for a sufficient period of time), droplet breakup is induced.

There are several mechanisms by which disruptive forces can be provided to a droplet. The shear force can be provided in shear laminar flow conditions, turbulent eddies, or convergent/divergent flow systems, to name a few. Different homogenization/emulsification technologies leverage different mechanisms to induce shear-break-up. Various systems and apparatus can be utilized to provide these forces in larger systems, e.g., 100 gallons, 200 gallons, 500, gallons, 1,000 gallons and greater.

Typically, a particle will experience significant shear force if the length scales of the flow conditions are comparable to the diameter of the particle. Consequently, it is theorized that having a bulk flow of substantial energy that does not have short length scale components will not likely break-up droplets. It is thus proposed that a scale-dependent energy parameter is used to relate the magnitude of shear force provided by various technologies. This is the Specific Energy:

$${E}_{v} = \frac{P}{\dot{V}}$$

where P is the power of the system and V is the flow rate.

It has been empirically demonstrated that the mean droplet size is inversely proportional to Eᵥ. However, across different flow conditions (turbulent, convergent, etc.) specific aspects of geometry differentiate particle size beyond Eᵥ. The following figure demonstrates the effect of Eᵥ on particle size for a number of embodiments of processes to form polysilocarb preform droplets.

It should be noted that the presence of sufficient energy density to incite droplet break-up is necessary, but in some embodiments may not be sufficient for droplet break-up to occur. The kinetics of droplet break-up can be complex, but it has been empirically demonstrated that there is a characteristic time scale for break-up to occur, which depends on a number of material and mechanism parameters. Thus, in some embodiments long times (e.g., greater than 30 minutes, greater than 1 hour, greater than 2 hours and more) may be necessary to achieve steady state.

In a theoretical system with no thermodynamic driving force to a bulk condition, an emulsification would proceed via droplet break-up until the minimum length scale at which the minimum Weber Number is exceeded is reached. However, real systems are driven to ‘coalesce’ or agglomerate in order to minimize surface area and hence surface energy.

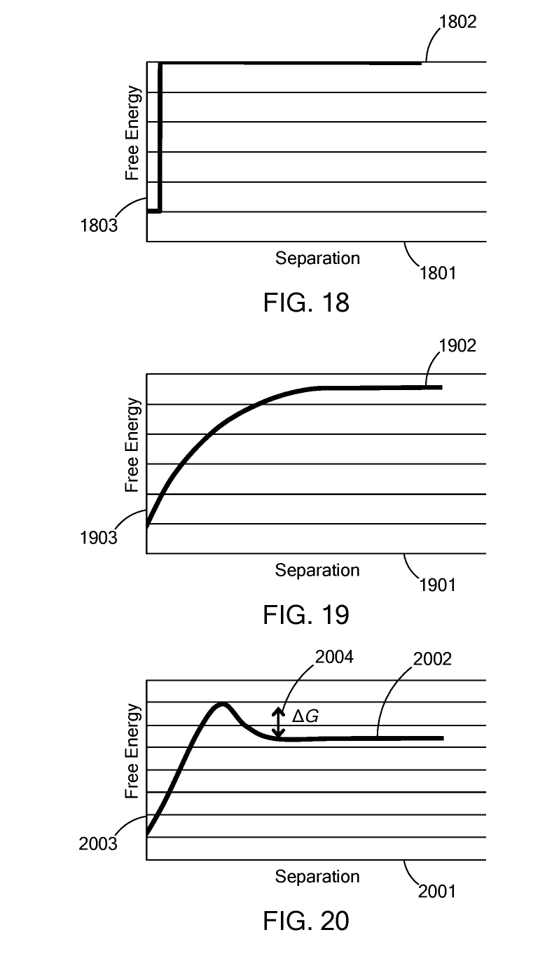

A system without attractive or repulsive forces would have a flat potential as a function of separation of two particles, with the exception of a point of overlap where the potential would be substantially negative with respect to the non-agglomerated particles (representing coalescence) see graph of FIG. 18, where Separation 1801 vs Free Energy 1803 provides plot 1802.

In such a system, generally, the driving forces for motion between particles are thermal and hydrodynamic (flow conditions of the medium). If two particles happen to come in contact, they will coalesce and remain in contact in the lower-energy state unless sufficient disruptive force is supplied.

However, real systems have attractive and repulsive forces that modify the Free Energy as a function of Separation.

Van-der-Waals forces (or induced dipole oscillation forces) act over very short distances and serve to attract non-polar particles to each other. The resulting plot looks qualitatively like that of the graph of FIG. 19, where Separation 1901 vs Free Energy provides plot 1902.

At very short distances, the atomic electron clouds begin to overlap and Born repulsion occurs. The resulting potential, including Van-der-Waals forces, is similar to the classic Lennard-Jones potential. However, in some embodiments this effect is not as great a factor to understanding coalescence for the larger particle sizes, e.g., mini-systems (e.g., hundreds of nm) and greater.

It is thus theorized that without the modification of the system to include additional repulsive forces, the free energy curve monotonically decreases as the particles come together; thus, typically, and inexorably leading to coalescence. In order to achieve metastability or a steady-state equilibrium particle size of desired dimensions, kinetic barriers to coalescence in general should be utilized. There are several sources of kinetic barriers in liquid-liquid systems, e.g., emulsion systems.

If the particles themselves, or more often the surfaces of the particles, are charged, then coulombic forces are present in the system and may act to repel particles. This coulombic repulsion acts over much larger distances than Van-der-Waals forces. The resulting Free Energy as a function of separation curve thus takes on the following character for systems with charged surfaces, as is shown in the graph of FIG. 20, where Separation 2001 vs Free Energy 2003 provides plot 2002, and where a kinetic barrier of ΔG 2004 is present. Thus, in order for two particles to reach a point of separation where coalescence is energetically favorable, typically, sufficient energy generally should be imparted to the system to overcome ΔG. This energy can come from, for example, hydrodynamic forces or thermal motion.

The source of charged surfaces in the system can be varied. Surface species can be directly ionized resulting in residual charge. This can be brought about via numerous mechanisms, but is typically pH dependent. Thus, modifying the pH of the continuous phase can result in charge-repulsion affects.

The presence of an ion of lower valence in the system can result in a negative charge if said ion is exchanged for the original.

The presence of adsorbed species that are charged can result in charged surface interactions and repulsions. This is one of generally two mechanisms by which emulsifying agents act to facilitate droplet break-up and disrupt droplet coalescence.

It is theorized that the permittivity of the intervening medium (the continuous phase) between particles modifies the effect of the coulomb repulsion in a standard fashion. However, the presence of the continuous phase has the additional impact of generating a charged-double layer. This effect serves to shield the surface charge by proximously locating inversely charged species. Thus, if the surface of the dispersed phase is negatively charged, positive charges in the continuous phase will form a double-layer to counter the negative charge. The thickness of this layer depends on the ionic concentration of the solution—the more ions present in the continuous phase, the thinner the layer due to the greater availability of shielding ions. The thicker the double-layer, the greater the repulsive effect due to charge on the system. Thus, a lower ionic concentration of the continuous phase results in greater electric repulsion and thus enhanced stability of the emulsion. The resulting potential of the double layer is known as the zeta potential.

In general, steric repulsion refers to the barrier imposed by the adsorption of a species onto the surface of a particle that serves to prohibit overlap of particles. There are generally two mechanisms of steric repulsion: modification of Van-der-Waals forces and entropic repulsion. If a thick layer of adsorbed species with properties similar to the continuous medium is present on the surface of the dispersed particle, then typically the Van-der-Waals force is shielded. Further, the compression of a polymer species adsorbed on the surface of a dispersed particle induced by contact with a neighboring particle reduces the entropy of the system from the equilibrium state and thus induces entropic repulsion. Thus, adsorbed species can serve as a shield to coalescence. The steric mechanism of repulsion is typically surfactant/emulsifier concentration dependent and in some embodiments may be highly surfactant/emulsifier concentration dependent.

When two particles are driven to coalesce they typically move through the continuous medium. As they do so they are displacing a liquid, thus resulting in energetic dissipation. Consequently, the energy required to induce coalescence is typically greater than it would be in the absence of a rheologically active continuum. Further, in the case of a liquid-liquid emulsion, the dispersed phase will undergo geometric distortion during the collision of particles, resulting in further rheological dissipation.

It is suggested that the physics of thin films can be used to explain coalescing phenomena, as the kinetic paths through which the surface is disrupted, leading to aggregation, are dictated by thin film phenomena. There is typically a critical film thickness beneath which the film spontaneously is disrupted.

The preceding discussion described theories and mechanisms by which collisional coalescence may be reduced or enhanced. However, additional mechanisms of coalescence may be active in an emulsion system.

For example, one of the additional mechanisms is Ostwald Ripening, or diffusive species transfer. The fundamental driving force of energy minimization due to surface area minimization is still the active motivation for mass transfer. This can be intuitively understood by recognizing that the larger percentage of the volume of a system present in larger diameter particles, the lower the overall surface area. Thus, the growth of a larger particle at the expense of a smaller particle is typically thermodynamically favored and diffusion is allowed to proceed by concentration gradients induced by the curvature of the particles. Diffusive transfer phenomena will tend to occur on longer time scales then collisional coalescence until very small diameters are present in the system. The rate of mass transfer stays roughly constant, and thus the rate of diameter change varies dramatically as a function of diameter.

In general, there can be two primary processes by which bead, droplet, or particle formation, polymerization, crosslinking, or curing, occurs in mini-systems and smaller systems. These processes are emulsion polymerization and suspension polymerization.

In emulsion polymerization type of processes for making PDC beads, droplets and particles, the dispersed phase is typically the precursor formulation and the continuous phase is typically aqueous. To initiate curing, an initiator (e.g., the catalyst, heat, or both) is added to the over all system, or activated. The initiator is preferably soluble in the continuous phase. Thus, it is theorized that, the surfaces of the precursor formulation polymers serve as nucleation sites, but particle polymerization or growth occurs in the continuous phase. The initial emulsion of the precursor formulation polymers serves as both nucleation sites and a reservoir for particle growth. In general, this can have implications for growth kinetics and particle size distribution of the PDC, e.g., polysilocarb, preform particle.

Because there is a set of controllable nucleation events, it is theorized that, nucleation can be initiated simultaneously for nearly all particles resulting in relatively mono-dispersed final particles. However, the growth rate of the particles is diffusively limited, and depending upon the specific embodiment of the system and precursors, the complete formation of the emulsion may take a long time (e.g., greater than 30 minutes, greater than 1 hour, greater than 12 hours, and more than 24 hours).

In suspension polymerization, the initiator, e.g., the catalyst, is soluble in the PDC precursor, e.g., the polysilocarb precursor, itself, and typically is added to, e.g., is already present in, the dispersed phase, prior to emulsification. Thus, curing occurs in-situ for the dispersed phase. The initiator, may be the catalyst, heat, and preferably both. Consequently, it is theorized that the particle size distribution is controlled directly by the dispersed phase distribution in the emulsion—these generally should become the final particles. It is further theorized that because there is no diffusive rate-limiting kinetics in this process, polymerization/cure can occur more rapidly than in emulsion polymerization.

Various embodiments of different systems and precursor formulations are contemplated to provide specific final, e.g., cured to the extent that can be used or subjected to further processing preferably without the risk of deformation and agglomeration, particle sizes and distributions. Several factors that may influence particle size, among others, are further addressed to serve to inform process decisions for various additional embodiments that fall within the ambit of the present systems.

For emulsion polymerization, the final particle size is typically primarily determined by nucleation and growth kinetics and not by the initial emulsion droplet distribution. An aspect, in some embodiments of emulsion polymerization growth is the simultaneous nucleation of particles. Additionally, the achievement of a stable steady state emulsion for the long period of time required for emulsion polymerization to proceed in some embodiments may be challenging. Generally, it is preferred to ensure, e.g., maintain, uniform thermodynamic and kinetic conditions in the reactor during polymerization to have monodisperse particle growth.

Due to the kinetics of particle growth in emulsion polymerization systems, it is theorized that, smaller particle sizes (a few hundred nanometers) tend to require lower yields than larger particle sizes. This can be understood by noting that a finite number of nucleation sites exist in the emulsion from which particles grow. The reaction is typically stopped when the desired particle size is reached, but unless the number of nucleation sites was high enough that this accounts for, uses up all of the total volume of initial precursor formulation polymer, there can I be excess precursor emulsified in the system that is not cured. For liquid-liquid precursor formulations where the curing reaction is taking place entirely, or essentially entirely (accounting for skin effects and surface effects) within the bead or particle, this generally will not be a consideration or factor.

In preferred embodiments, the particle size distribution can be approximately normal, e.g., a Gaussian distribution.

For suspension polymerization, generally the droplet size and distribution of the emulsion will directly correspond to the particle size of the system.

At a high level, it is theorized that, the droplet size and distribution is the result of a steady state between droplet break-up and droplet coalescence. Following are additional descriptions of the affects that various material properties, thermodynamic conditions, and emulsion mechanisms can have on break-up, coalescence, and particle size distribution. The droplet size distribution is in general process dependent, and relates, among other things, to the statistics of energy partition across length scales in a flowing system. The presence of surfactants/emulsifying agents in the system can have an affect on, and in some embodiments critically alters, both droplet break-up and droplet coalescence phenomena.

It is theorized that one of, and in some embodiments the primary contribution of surfactants to droplet break-up is the reduction of surface tension. It is theorized that the entropic impact of adsorption lowers the Free Energy of a system. Thus, the surface tension of the surface of a particle with adsorbed species on it is reduced.

The most common mechanism by which this reduction occurs is a surfactant having a lipophilic and a hydrophilic end. The lipohilic end associates with the precursor polymer and the hydrophilic end with the continuum or the continuous phase, e.g., the aqueous phase. Typically the larger the percentage of the surface of the particle covered with surfactant, the larger the reduction of surface tension.

Generally, the percentage of the surface of a particle adsorbed with surfactant depends on the activity of the surfactant (which is in turn dependent on the concentration) in the continuum. The larger the concentration of surfactant, the more a particle surface will be covered, and the lower the surface tension. Typically this is a nonlinear process with diminishing returns because of the thermodynamics of activity. Further, as will be discussed below, the addition of surfactants can modify the viscosity of the continuous phase further impacting break-up phenomena.

Some surfactants in specific systems have been shown to encourage spontaneous emulsification. This typically results in micro-emulsion character, which is theorized to be thermodynamically possible.

The adsorption of surfactant can also create additional kinetic barriers to coalescence as described above. This has the impact of frustrating coalescence phenomena and stabilizing the emulsion, enabling smaller droplet sizes. These barriers can be steric or electrostatic. Again, high surfactant concentrations can affect the viscosity of the continuous phase and this affect, and in some embodiments strongly impact coalescence phenomena, as will be described below.

Typically solid nanoparticles can be used in lieu of chemical surfactants due to their ability to provide coalescence disruption, though they can be less effective at reducing surface tension.

The appropriate surfactant for a given process is highly dependent upon the material systems in use, the temperature range of the process (described below), the desired particle size distribution, and further steps in the process (i.e. drying/powder formation), among other factors. Typically, and preferably, the surfactant with the greatest surface tension reduction is chosen, as this is a factor, and in some embodiments may be a critical parameter, affecting droplet size and required energy input.

Table 2, below, is a plot of typical empirical results tracking average particle size as a function of surfactant concentration with respect to the dispersed phase concentration.

There is typically a concentration of surfactant above which additional drop in droplet diameter is not seen, or is negligible. This is typically due to adverse affects of high-concentration on droplet break-up. It is theorized, based upon empirical demonstration that this concentration is independent of dispersed-phase volume fraction, and thus is related to the thermodynamics of adsorption.

For systems where the surfactant is ionic (inducing charge effects) no such threshold is believed to exist.

Generally, it is normally the case that energy input and emulsifier concentration can be used as independent levers to tune the particle diameter. Energy savings can be made by increasing emulsifier concentration, but can come with the consequences illustrated below.

High concentrations of emulsifiers can change the diffusivity of the continuum to the precursor formulation. This affects, and in some embodiments strongly affects, emulsion polymerization process kinetics, but typically does not impact, in some embodiments, the kinetics of suspension polymerization.

There also may be a minimum stable diameter of particle sizes before the thermodynamic driving force for diffusion is too large to allow the particle to remain metastable. This is influenced by and in some embodiments strongly influenced by the emulsifier concentration, because of the reduction of Free Energy differences between the bulk state and the dispersed state.

Because the introduction of large concentrations of emulsifying agents can be important to achieving a mini-emulsion, the impact of these chemicals on the process steps following polymerization generally should be taken into account. Specifically, certain classes of surfactants can make drying the particles more difficult, and thus can make powder formation processes more complex. It is a factor to choose emulsifying agents with a view toward subsequent process and end use requirements.

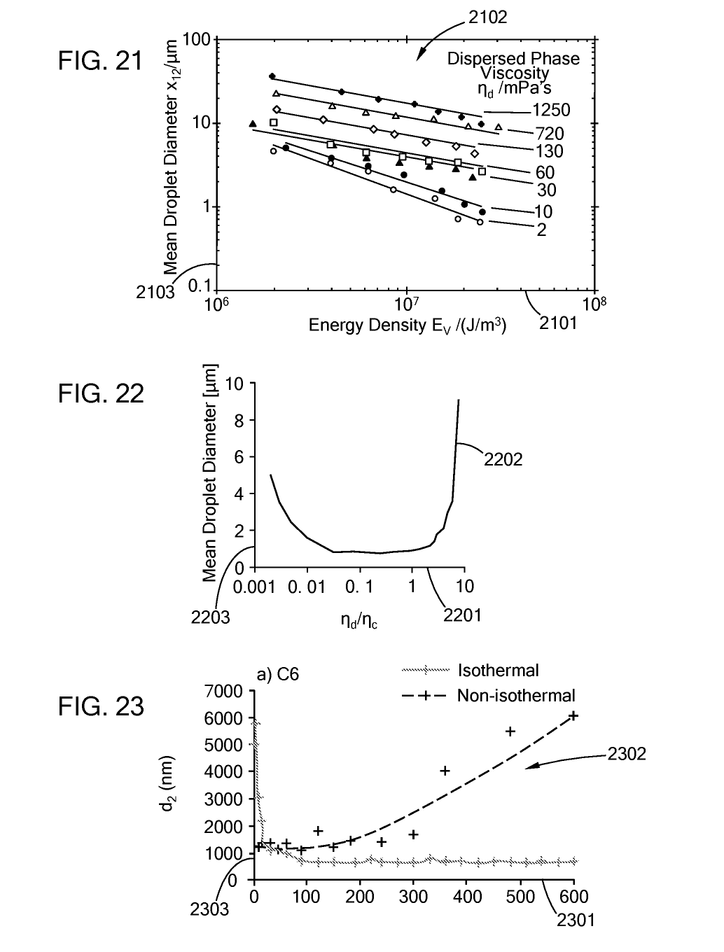

Viscosity can be a factor, and in some embodiments a critical parameter, in determining the final particle size distribution. For example, the dispersed phase viscosity, the continuous phase viscosity, and the relative viscosities of the two phases in turn are considered. The viscosity of the dispersed phase can have a direct correlation to particle size. It is noted that the Weber Number did not account for the viscosity of the dispersed phase. Rheological dissipation can occur when the viscosity of the dispersed phase is high. Consequently, additional energy is required to achieve the same droplet diameter as a lower viscosity dispersed phase. However, this same effect can also impact coalescence: rheological dissipation can occur for collisional coalescence, thus, it is theorized reducing the probability of a coalescing event. This effect typically is not as strong as the break-up effect, and is further offset by the presence of additional kinetic paths to coalescence (e.g., Ostwald Ripening), as can bee seen in the graph of FIG. 21, where Energy Density 2101 vs Mean Drop Diameter 2103 provides plots 2102.

Several factors can contribute to the viscosity of a system beyond the inherent viscosity of a homogenous medium.

Particle Interactions—For high dispersed-phase concentrations particles tend to interact. Steric repulsion and coulombic interactions lead to modified viscosity. Specifically, viewing this as two spheres in a liquid making contact, it can be theorized that they ‘bump into’ each other, leading to rheological dissipation and momentum transfer increasing the viscosity of the system. If two charged particles pass each other the additional force causes momentum transfer and adds to the viscosity of the system as well.

Emulsifier Concentration—The addition of emulsifier can, impact, and in some embodiments directly impact, the homogenous viscosity of the continuous medium. However, due to electroviscous and steric repulsion, the viscosity can be dependent on emulsifier concentration in different manners.

At large concentrations of dispersed phase, the particle interactions can induce non-Newtonian viscous behavior of the system. This can complicate the hydrodynamics of systems and tends to lead to larger average particle sizes.

In general, the primary independent impact of the viscosity of the continuous phase is in the viscous dissipation of energy input. The viscosity of the continuous phase can have a strong impact on the hydrodynamic conditions of the system, and can lead to modified turbulence and eddy length scales. However, this impact will typically be highly device specific, as convergent flow vs. turbulent mixing technologies have different geometries and flow conditions.

Of importance for some embodiments is the relative viscosity of the dispersed to the continuous phase. When substantially different, larger particle sizes tend to result. This can be due to inefficient communication of shear stress, or dissipation, across phase boundaries. Turning to FIG. 22, this is shown a typical plot 2202 of viscosity 2201 vs mean drop diameter 2203 (indicating the droplet size as a function of viscosity).

Temperature, can have an impact, and in some embodiments a significant impact on the kinetics of coalescing and break-up phenomena, and consequently the particle size distribution can depend on temperature, and it is theorized can be temperature depending in several ways.

It should also be noted that temperature can have an effect on cure rate, and the degree of cure, for polysilocarb precursor formulations.

Viscosity is typically a function of temperature, and different materials can have different magnitudes of change in viscosity associated with a given temperature change. Consequently, the independent viscosities, and relative viscosities, of the dispersed and continuous phases can be altered by temperature and impact droplet size.

The temperature reflects an average kinetic energy of the system. Most especially, in some embodiments, e.g., for small particles, this can directly impact Brownian motion of the particles leading to enhanced coalescence rate due to higher average kinetic energies to overcome kinetic barriers established by surfactants. Specifically, per the figure above, if the energy barrier ΔG is larger than a few kT (where k is Boltzmann's constant and T is the temperature), then coalescence in kinetically inhibited. However, as temperature (T) is increased, the magnitude of the required barrier is additionally increased.

The adsorption of surfactants to the surfaces of particles is often temperature dependent (as a consequence of the temperature dependence of activity). Typically, the adsorption is increased for higher temperatures, leading to thicker steric shells, though this can be system dependent. The impact of temperature on surfactants that are electrostatically active tends to be less negative than on systems which rely on steric mechanisms.

Diffusion is also temperature dependent (for thermally activated diffusion mechanisms) and consequently Ostwald Ripening can generally be enhanced with higher temperatures.

Nucleation rate varies with temperature. For emulsion polymerization processes, the nucleation of particles can be greatly enhanced at higher temperatures, thus reducing average particle size.

Because temperature impacts particle sizes in isothermal systems, the effects of temperature variation on particle distribution should be considered. In FIG. 23 there is shown plot tracking the average droplet size as a function of time in a non-curing system for isothermal and non-isothermal processes. In the non-isothermal process the temperature is steadily increasing with time.

Generally, in embodiments, an increase in temperature leads to larger average particle sizes. Thus, in some embodiments, this variation as a function of time can result in a less monodisperse batch of particles. Thus, FIG. 23 provides plots 2302 of isothermal and non-isothermal behaviors for particle size 2303 vs temperature 2301.

Further, it has been empirically demonstrated that non-isothermal emulsifications tend to have steeper transients when compared to isothermal systems. Higher temperatures reduce the viscosity of the dispersed phase, thus lowering the interfacial tension and enhancing break-up. However, the impact of temperature on coalescent phenomena in general in embodiments, can overwhelm the initial benefits at longer time intervals.

The impact of temperature is highly system dependent, and thus it should be recognized that these temperature effects, as well as, other temperature effects may be present to a greater or lessor extent, in various embodiments of emulsion systems. For example, temperature effects, should be balanced against the effect temperature may have on cure rate, and in particular the cure rate of polysilocarb precursor formulations.

A variety of factors can influence the temperature of a system. For example, some typical factors are the energetic dissipation from the homogenizer and exothermic polymerization reactions. It should be noted that the effect of exothermic reaction generally becomes a greater factor as the concentration of dispersed phase increases.

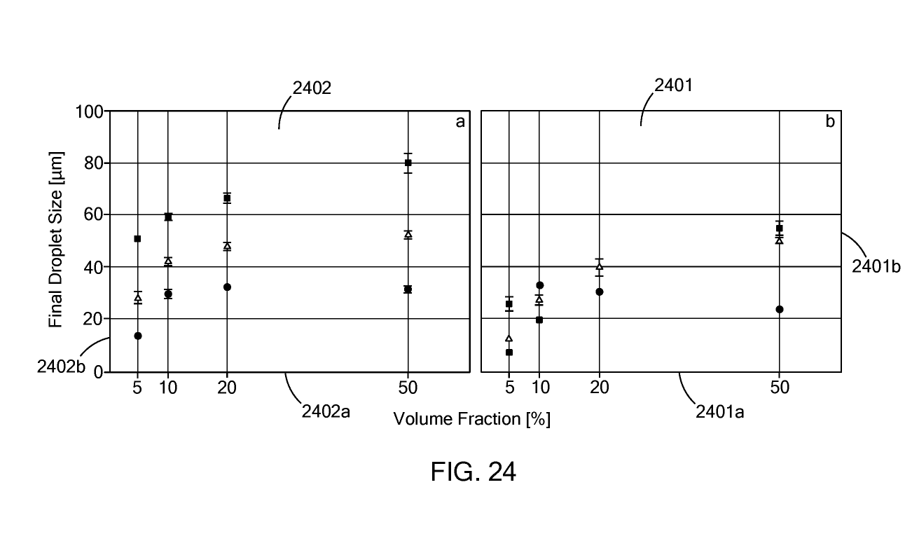

Volume fraction of the dispersed phase can impact the system, variations of the following can lead to a reverse emulation, in which case the disperse phase and continuous phase are reversed. Typically, large volume fractions can, among other things, induce non-Newtonian viscous effects, enhance viscosity, lead to temperature variation for exothermic systems, increase coalescence probability, reduce the ultimate efficacy of surfactants, and combinations and variations of these. In most embodiments, the impact of volume fraction on particle size tends to be negative—the larger the volume fraction the larger the average particle size. Typical results are shown in the graphs of FIG. 24, which plot drop size 2402b, 2401b, vs volume fraction 2402a, 2401a, for two different surfactant concentrations, 2402, 2401.

In general these theories and explanations are applicable to systems of solid and liquid dispersions within a liquid continuous phase. Thus, they find applicability across a wide range of PDC precursors. For polysilocarb precursors, the liquid dispersion is cured into a solid preferably in the liquid continuous phase. Thus, in this transition from liquid to solid, distinctions in some embodiments may arise, and will primarily relate to rheological considerations of the particle during collisional coalescence and particle breakup, among other factors.

As droplets form a skin and are recalculated through the mechanical emulsification mixer they may beak-up and form smaller non uniform particles.

Several aspects of viscosity evolution should be considered in determining the final particle size. As the polymerization or cure proceeds, the viscosity of the droplet increases. Further, it is theorized that in some embodiments an initial skin of cured material is formed first. These, and other changes occurring during curing, (e.g., transition for liquid state to semi-solid or solid state) leads to the modification of break-up and coalescent phenomena under the above principles. And example of one effect that may arise, is seen should the cure-time be substantial, inducing gradual viscous evolution, the steady state particle distribution size may creep. The emulsion may lose stability and coalesce.

The adsorption characteristics of a surfactant on the surface of a dispersed phase may vary between the polymerized solid and the monomer liquid. Consequently, the steric or electrostatic repulsive properties of the surfactant may be modified as a function of the degree of cure. This could potentially result in post---cure agglomeration. Surfactants that function both for the monomer liquid and polymer solid are thus preferred.

Another example, of these effects, relates to the factor that typically solids aggregate by different mechanism than liquids coalesce. Specifically, they adhere without a necessary reduction in surface area. This means that aggregation kinetics can vary, and in some embodiments vary strongly, from the liquid phase. A liquid-liquid emulsion may be stable yet the solid-liquid emulsion may naturally aggregate. Or may aggregate depending on the rate, and degree of cure, e.g., the cohesion of the initially cured solids, or skins on the solids.

Additionally, the tendency of solids to flocculate generally should also be considered. Typically, all other factor being the same, higher-density solid phase will naturally aggregate at the bottom of a reactor due to gravity should insufficient flow be present in the system. Once aggregated, Van-der-Waals forces may adhere the flocculate with enough force to require high shear to achieve the desired powder size distribution. Further, it is noted that in generally, as the size of the suspended liquid is reduced into the submicron range surface energy of the liquid droplet or cured droplet (solid) phases becomes increasingly important, as the surface area/gram increases. Minimization in system energy occurs through reduction in surface area through preferably a mechanism to minimize the particle/solvent surface energy.

Many embodiments and processes in droplet break-up and coalescence are kinetic in nature, and thus, have rates associated with them. As such, the impact that time-dependency has on emulsion systems is a factor that generally should be evaluated, utilized and considered.

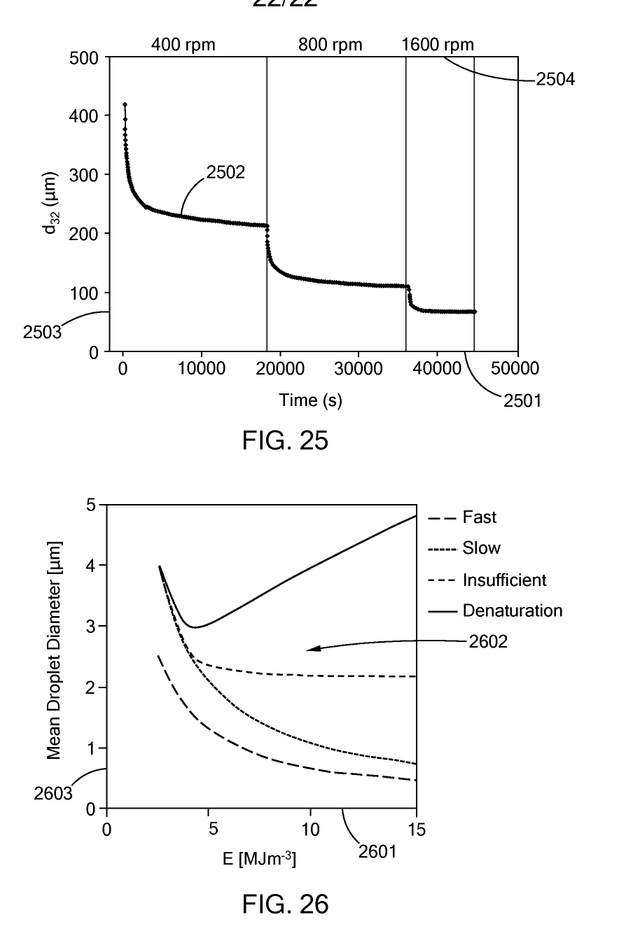

Typically, systems have a characteristic time associated with reaching steady state (for static thermodynamic conditions without polymerization). Factors influencing this include, for example, diffusive transfer, eddy formation, break-up kinetics and combinations and variations of these. The graph of FIG. 25 illustrates a plot 2502 of the particle distribution 2503 as a function of time 2501, and RPM 2504, for an example of an impeller-driven system. Here, impeller RPM directly corresponds to fluid velocity in the Weber Number calculation, and thus, it can be seen that an increase in RPM results in a decrease in average particle size due to the enhanced shear force and Specific Energy.

In many embodiments, and having all other factors generally constant, the evolution of particle size to the steady state can be, or behave as a time constant.

Surfactant adsorption can also be time dependent. “Quickly Adsorbing” surfactants adsorb readily due to, for example, thermodynamic or kinetic reasons. The impact of having quickly or slowly adsorbing species is a factor in determining the final particle size distribution. This can be understood by recognizing that once adsorbed, surfactant molecules, generally, do not permanently adhere to the surface of the droplet. Rather, they are continuously exchanged with the continuum. This typically occurs during events where the geometry is altered, such as collision or break-up. If the surfactant is not readily readsorbed, coalescence may occur.

An example of the impact of the speed at which species adsorb in an embodiment is qualitatively shown in the graph of FIG. 26, in which plots 2602 are shown for energy 2601 vs mean drop diameter 2603 for various rates at which species adsorb. Faster adsorbing species generally tend to reduce average particle size.

For dispersions with diameters less than approximately 1 micron, additional physics can be taken into account that can further impact particle size distribution and polymerization kinetics. At these smaller particle sizes, the curvature is substantial, which has an impact on the Free Energy of the system. This can affect the adsorption probabilities of surfactants, as well as, the polymerization kinetics of the curing reaction, among other things. Both effects typically are dependent upon and may vary with different precursors and systems.

Generally, from lab to large industrial scale production, (e.g., hundreds, thousands, and hundreds of thousands of pounds per day) of proppants, beads and particles, of various sizes and shapes, but preferably spherical, can be accomplished with solution forming systems. Systems of this type can, among other things, be used to make cured volumetric shapes, such as beads and particles, which may be used for example as pigments, as proppants in hydraulic fracturing, in hydrocarbon production, to provide high and ultra pure (e.g., >5 nines pure, >6 nines pure) SiOC, for example, as a source material to make high purity SiC and related electronic applications.

Typically, these systems require only minimal components, provide the ability to make large amounts of particles, beads, and proppants having, and if desired having very high uniformity, e.g., size distribution, for example, at least about 70% or more of the particles size distribution is within 5% size range, at least about 80% or more of the particles size distribution is within a 5% size range, at least about 90% or more of the particle size distribution is within a 5% size range. These narrow distributions can be obtained unfiltered, or unsieved, i.e., without the need for filtering, sieving or post processing.

In general, these systems have a vessel, which preferably is temperature controlled. The vessel can be, for example a tank, vat, trough, channel, and other shapes and types of structures, having a capacity of about 1 gallon or less, to 100 gallons or more, to 1,000 gallons, and larger. The vessels hold a liquid in which the precursor batch is formed into a volumetric shape and then cured. The liquid in the vessel can be any liquid, (this liquid has been referred to as the continuum, continuous phase, and may also be referred to as the forming liquid, unless specified otherwise all such terms are interchangeable) that permits the formation of discrete volumetric shapes of the precursor in the forming liquid. For PDC precursors formulations the forming liquid is preferably water, distilled water, deionized water, but could also be polar liquids, non-polar liquids, alcohols, and combinations and variations of these. Preferably for polysilocarb precursor formulations, an embodiment of the forming liquid is deionized water with reduced oxygen content (e.g., dissolved O₂), for example, preferably less than about O₂, less than about 10 ppm O₂, less than about 5 ppm O₂, less than about 1 ppm O₂, and less than about 0.1 ppm O₂. In some embodiments and for some precursor formulations higher O2 content may be used, such as for example 20 ppm, 50 ppm, 100 ppm, and 300 ppm and more. The forming liquid can also have, and preferably does have, a surfactant. Further, in conjunction with, or independent, from surfactants, other techniques or methodologies can be utilized, such as variations in pH, ionic strength and/or conductivity of the water. As well as, for example, additives to the continuous phase, such as rheology modifiers, thinning agents, defoamers, inhibitors, additional catalysts, reactive diluents, etc., can also be used. The surfactant can be any type of surfactant that has polar and non-polar functionalities. For example, in polysilocarb-water systems the surfactants can be Mono and diglycerides (e.g. ATMOS 300, ARLACEL 165), Sorbitan Fatty Acid Esters (e.g. SPAN 20, Span 80), Polyoxyethylene sorbitan fatty acid esters (e.g. Tween 80, Tween 61), Polyoxyethylene sorbitol esters (ARLATONE T, ATLAS GN-1441), Polyoxyethylene Acids (MYRJ 52, MYRJ 45), Polyoxyethylene alcohols (BRIJ 72, BRIJ 58, Renex 36), and Ionic Surfactants (sodium lauryl sulfate, Atlas GN-263). Generally, for cost and purity reasons, as little surfactant as is need should preferably be utilized. Generally, surfactants can be used in concentrations from about 0.1% surfactant to forming liquid (e.g., water) and more, 0.5% and more, 1% and more, 5% and more and 7.5% and more. The surfactant may also be added into the precursor formulation, be in the forming liquid and both. The same or different surfactants may be used in the precursor and forming liquid.

Surfactant may be added to the continuous phase in a continuous or batch process. The surfactant-continuous phase mixture may be recirculated and as particles or beads cure and are removed, additional surfactant is added to the continuous phase to replace surfactant lost on the cured particles.

Preferably, the forming liquid temperature is controlled, for example, by heating and cooling devices associated with the vessel. The temperature of the liquid should be controlled to address, among other things, any exotherms, and to enhance bead formation, and uniformity. Preferably, the forming liquid is, at atmospheric pressure (and more preferably with the surface being under an inert atmosphere), with its temperature being maintained from about 80° C., to about 90° C., to less than 100° C. Generally, the volumetric shapes, e.g., beads, are formed and cured to a greater or lessor degree in the forming liquid. By way of illustration, beads will be used as the volumetric shape, it being understood that this is without limitation to the forming of other types of volumetric shapes, and that the following is applicable to such other shapes. The beads may only be partially cured in the forming liquid, and later or subsequent curing prior to pyrolysis may take place, or as a preliminary step in pyrolysis. Depending upon the precursor formulation, storage of the partially cured, and cured beads should preferably be under reduced oxygen and held at cooler temperatures.

Mixing preferably is provided to agitate the forming liquid, provide shear to the precursor, and control among other things, particle size, coalescence, temperature uniformity, and size distribution. The precursor can be added to the liquid in various manners, from simple pouring through air, to injection nozzles located under the surface of the atmosphere, sparges, screens, distribution headers, droplets generated in a gas (e.g., the atmosphere) and then falling on to the surface of the continuous phase and combinations and variations of these and other apparatus and methods to introduce the precursor into the forming liquid. There may be a single precursor introduction device, two, three, four, tens, hundreds and more, and each precursor introduction device may have multiple introduction ports or openings, depending upon, among other things, the size of the system, the desired rate of production, rate of cure, intended particle size, intended size distribution, and other factors.

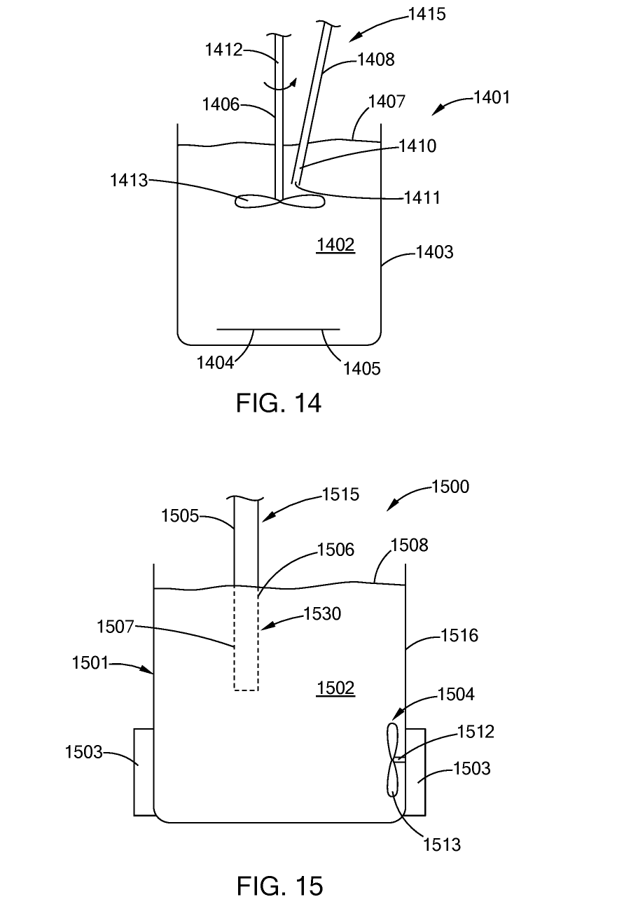

Turning to FIG. 14 there is shown a schematic of an embodiment of a type of solution formation system and process. This system may be used for batch and continuous production of cured beads. The solution formation system 1401 has a vessel 1403 that contains a forming liquid 1402. The forming liquid 1402 has a surface 1407, which as an atmosphere above it. The forming liquid, for example can be deionized water, with at about 1% surfactant, and preferably less than about 15 ppm O₂, less than about 10 ppm O₂, less than about 5 ppm O₂, less than about 1 ppm O₂, and less than about 0.1 ppm O₂.

The vessel 1403 has a temperature control apparatus 1404 having control and power cable 1405. It being understood that the temperature control apparatus can be in the vessel, as shown, located anywhere within the vessel, in the walls of the vessel, external to the vessel, on fluid inlet lines, on storage tanks, and combinations and variations of these. The vessel has an agitator 1406 located within the vessel 1403, the agitator has a drive member 1412, e.g., a drive shaft, and an impeller 1413. The agitator impeller 1413 is located below the surface 1407 of the liquid 1402 and near to the opening 1411 for the nozzle 1410 for the in-feed line 1408, e.g., the precursor introduction device 1415.

The precursor introduction device 1415, can have for example, an in feed line 1408, a nozzle 1410, that forms an opening 1411 for introduction of the precursor into the forming liquid 1402 below the surface 1407. The introduction device can have multiple in feed lines, these lines can be within the walls of the vessel, and thus, in essence form an opening in the walls of the vessel for introduction into the liquid. The vessel wall introduction openings can be on the sidewalls, bottom and both, of the vessel. A single in feed line may have one, two, three or more openings associated with it. The in feed lines are connected to the make up, holding or other handling facilities for the polymer. It should be noted that in general, when the precursor is in the in feed line it has been catalyzed. Although in some embodiments the addition of the catalysis could take place in other locations, such as for example in an inline mixer located in the in feed line.

It being understood that the agitator can be located in other positions relative to the forming liquid surface, the vessel, and the precursor introduction device. There also can be one, two, three or more agitators associated with a vessel. The agitators may be located entirely below the surface of the liquid, and preferably are so located, to minimize the entrainment of gas at the drive shaft surface interface. The agitators may be located at different levels, and when multiple agitators are used, for example, one may positioned adjacent to the precursor introduction device, and others may be removed from that device. The agitators may be operated at different speeds, for different periods of time and combinations and variations of these during a forming process, to facility particle formation, particle size distribution and curing, to name a few parameters and affects.

Turning to FIG. 15 there is shown a schematic of an embodiment of a type of solution formation system and process. The solution formation system 1500 has a vessel 1501 that contains a forming liquid 1502. The forming liquid 1502 has a surface 1508, which as a media above it. (Note that while the media is preferably a gas, it can be a liquid phase, a reduced pressure gas, a high pressure gas, a gas at ambient pressure, and a vacuum.) The forming liquid 1502, for example, can be deionized water, with a surfactant.

The vessel 1501 has a temperature control apparatus 1503 that wraps the wall 1516 of the vessel 1501. It being understood that the temperature control apparatus can be external and on the vessel, as shown, located anywhere within the vessel, in the walls of the vessel, on the forming liquid inlet line, in a storage tank, and combinations and variations of these. The vessel has an agitator assembly 1504 located within the vessel 1501, the agitator assembly 1504 has a drive member 1512, e.g., a drive shaft, and an impeller 1513. The entirety of the agitator assembly 1504 is located below the surface 1508 of the forming liquid 1502. It being understood that the agitator can be located in other positions relative to the forming liquid surface, the vessel, and the precursor introduction device.

The precursor introduction device 1515 has an in-feed line 1505 and a distribution assembly 1530. The distribution assembly 1530 has a screen 1506 that has a large number of openings, e.g., 1507, through which the precursor is feed, e.g., pumped, flowed, gravity feed, etc. The diameters of the openings can be used to size the particles, as well as contribute to, and determine the shape of the particles. For example, circular openings, among others, can be used to from spheres. Preferably the screen 1506 and the screen openings, e.g., 1507 are located below the surface 1508 of the forming liquid 1502.

The introduction device can have multiple in feed lines, these lines can be within the walls of the vessel, and thus, feed into a screen in the wall of the vessel for introduction into the forming liquid. The vessel wall introduction openings can be on the sidewalls, bottom and both, of the vessel. There can be one, two, three, four or more of these screen openings in the vessel walls.

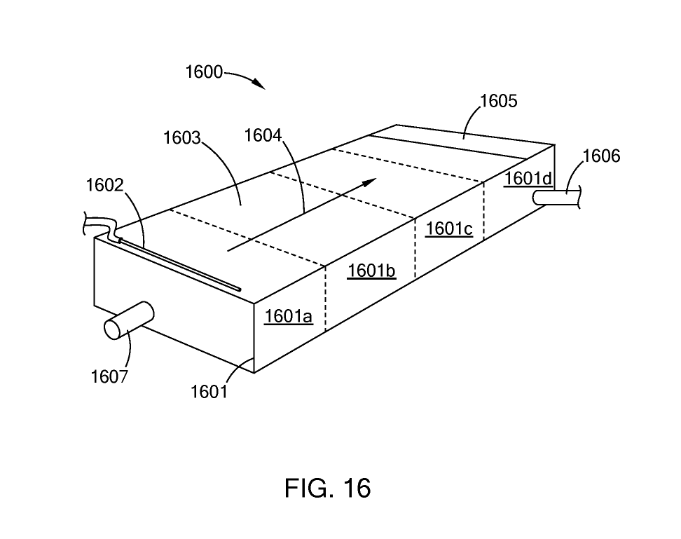

Turning to FIG. 16 there is shown a perspective view of an embodiment of a type of solution formation system and process. This embodiment, preferably, provides for continuous operation. The formation system 1600 has a vessel 1601, which in this case is a rectangular bath. The vessel 1601 has four zones 1601a, 1601b, 1601c, 1601d. The four zones can have the same conditions or different conditions. Thus, the four zones can have different temperatures, surfactant levels, degree of agitation, depth, temperature, flow rate and combinations and variations of these. For example, the first zone 1601a can be set up to have the best conditions for particle formation, and for a predetermined size of particle. The second zone 1601b can have the best conditions for initial curing. The third zone 1601c can have the best conditions to prevent agglomeration during final cure, and the fourth zone 1601d can be a removal or harvesting zone for the cured particles. The vessel 1601 contains a forming fluid 1603 that is flowing in the direction of arrow 1604. The fluid is agitated to a greater or lesser extent depending upon the zone, and the predetermined purpose or function of that zone, as well as other factors. The precursor is added to the forming fluid 1603 via distribution header 1602, which could be a screen, several screens, nozzles, slits, and combinations and variations of these and other devices to introduce precursors. The cured particles are removed from the system by particle removal device 1605, which could be a fine mesh collection system or a screen. A return line 1606 provides for the forming fluid to be returned and feed into the vessel by the inlet line 1607.

In this manner, the particles, e.g., proppant are formed, at or near the distribution header 1602 and are carried by the flowing forming fluid 1603 in the direction of arrow 1604. The various zones of the system 1600 provide the requisite conditions for creating the cured particles, e.g., cured proppant.

If the cured material is to be pyrolized and transitioned into a ceramic, preferably the excess water is removed; and more preferably the material is dry before pyrolysis takes place. To the extent the cured material is stored, it should be stored at less than 150° C., at less than 140° C., and at less than 100° C., preferably it should also be stored in a reduce O₂ atmosphere. Additional curing may also take place after the cured particles are removed from the forming fluid and prior to pyrolysis. This final, or further curing and pyrolysis can take place together, e.g., serially in the same furnace, or can be separate procedures, e.g., different furnaces, storage time between procedures.

Embodiments of the methods that can be practiced using systems like the embodiment of FIGS. 14, 15 and 16, can be used to produce spherical or non-spherical particles from precursors. For aqueous systems it is noted that the temperatures will generally be at, or below the boiling point for water, e.g., 100° C. (at standard temperature and pressure). For higher boiling temperature forming fluids, or increase pressures for aqueous fluids, higher temperatures can be used. In general, these systems can be used with any type precursor that is in liquid form, as long as the precursor does not react with the forming fluid at the processing temperatures, e.g., does not react water at or below 100° C. Typically, embodiments of aqueous systems using polysilocarb precursors can produce particles from about 5 mm diameter down to about 1 micron, although smaller and larger sizes are contemplated. The particles made by these embodiments can have different shapes and would include for example teardrop, spherical, dodecahedral, faceted, as well as other volumetric shapes.

Examples of polysilocarb precursor formulations that can be used in these systems, and in particular aqueous systems, are: 100% MHF; 95% MHF—5% TV; 46% MHF—34% TV—20% VT; 70% MHF—20% TV—10% VT; 75% MHF—15% TV—10% VT; 85/15 MHF/DCPD reaction blend; 70/30 MHF/DCPD reaction blend; and 65/35 MHF/DCPD reaction blend; 60/40 MHF/DCPD reaction blend; and 82/18 MHF/DCPD reaction blend. Additionally, to improve hardness of the cured beads, reduce cure time and both, 1% to 50% TV, 1% to 20% low molecular weight (MW<1000) VT can be added. Catalysis may include, for example 1-20 ppm platinum, dilute base, dilute acid, an amine catalyst, as well as other types of catalysts.

For example to following process parameters can be used to make 500 micron beads, this process can be scaled to larger volumes, which can then be cured to form proppant:
Mix 192 grams of 65/35 HHF/DCPD+8 grams of TV for a minimum of 5 minutes.
Add 1 gram of P01 catalyst and mix thoroughly for a minimum of 10 minutes
Separately, mix 400 grams of De-Ionized water with 4 grams of HLB 9.1 surfactant and stir vigorously with a mechanical stirrer to dissolve the surfactant.
Pour the catalyzed polymer into the water/surfactant mixture and stir with a mechanical stirrer at 100-500 rpm in order to break up the polymer into droplets of the desired size (typically 2-3 minutes of stirring)
Pour the polymer/water/surfactant mixture from above into 1 liter of de-ionized water that has been heated to 63-68° C. and agitate using a low shear agitation method for 45 minutes to 1 hour while keeping the entire batch of material in the range of 45° C. to 50° C.
After the beads have become hard and not sticky, pour off the liquid into a pan or through a set of sieves to separate out the beads and solidified siloxane from the water/surfactant mix
The beads should then be dried and further cured by heating to 50° C.-60° C. for 1-2 hours followed by 80-85° C. for 1-2 hours and a subsequent 1-2 hours at 115° C. to complete the curing.
The beads can then be pyrolized into ceramic.

HLB is the Hydrophile-Lipophile Balance. In general, an HLB number can be assigned to the group of ingredients that are going to be used to form an emulsion, and then a surfactant or blend of surfactants can be selected to match that number. In general, the HLB of an emulsifier is an expression of its Hydrophile-Lipophile Balance, e.g., the balance of the size and strength of the hydrophilic (water-loving or polar) and the lipophilic (oil-loving or non-polar) groups of the emulsifier. Typically, emulsifiers consist of a molecule that combines both hydrophilic and lipophilic groups.

An emulsifier that is lipophilic in character is assigned a low HLB number (below 9.0), and one that is hydrophilic in character is assigned a high HLB number (above 11.0). Those in the range of 9-11 are intermediates.

When two or more emulsifiers are blended, the resulting HLB of the blend is calculated. For example, the HLB value of a blend comprising 70% of TWEEN 80 (HLB=15) and 30% of SPAN 80 (HLB=4.3). The calculation would be:
TWEEN 80 SPAN 80

70%×15.0=10.5

30%×4.3=1.3 HLB of blend=11.8

In general, HLB numbers typically range from 0 to 20 for non-ionic surfactants and can exceed 50 for ionic surfactants. For example in embodiments of the present liquid-liquid systems, surfactants and surfactant combinations or blends can have HLB values from about 2 to about 18, about 5 to about 15, and preferably about 8 to about 12. Other HLP values outside these ranges can be utilized and may be preferred for certain types of precursors.

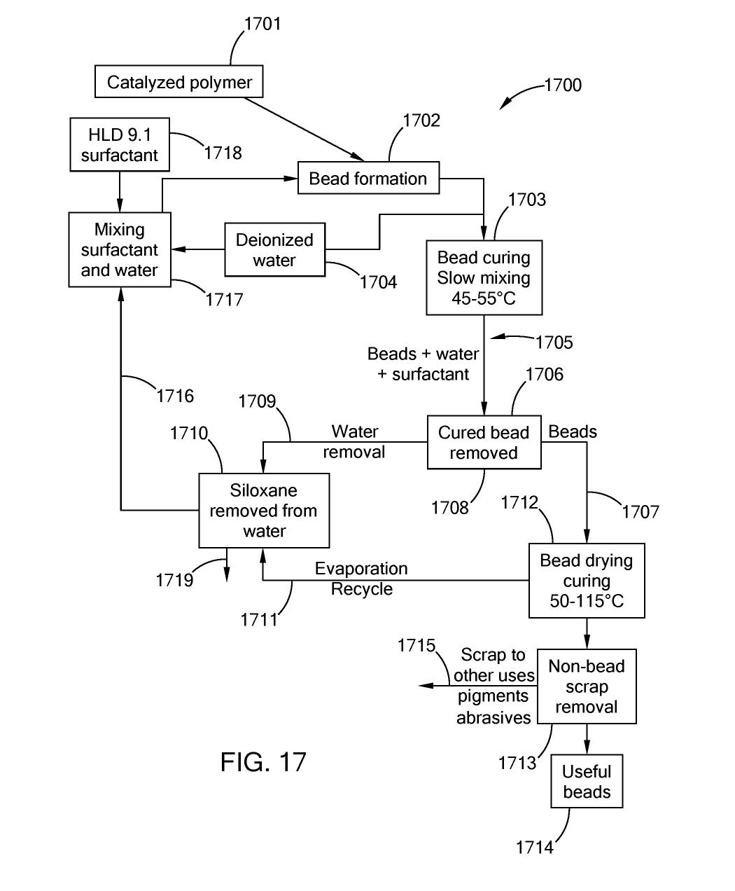

Turning to FIG. 17, there is shown a process flow diagram 1701 for an embodiment of a solution formulation system and process. Thus, the catalyzed precursor 1701 is formed into a bead 1702 the beads are cured 1703 (with slow mixing and a temperature of about 45-55° C.). The beads, water and surfactant are transferred 1705 and the cured beads 1708 are removed 1707. The removed water is transferred 1709, where the siloxane 1719 is removed 1710 from the water, which is returned 1716 to surfactant and water mixing station 1717. The beads are dried and further cured 1712, at about 50-115° C., after which non-bead scrap 1715 (which can be used as or further processed into pigments, abrasives, etc.) is removed 1713, from the use beads 1714. Station 1717 mixes water and surfactant, and has return deionized water 1704 as a water source. Surfactant, for example, HLD 9.1, 1718 is added to the water at station 1717. The water and surfactant are used for bead forming 1702.

Spray Forming Systems

Spray forming techniques can be used to form cured, and pyrolized small volumetric shapes. For example, spray drying processes and systems can be used to form small, uniform, or both, polymer derived ceramic shapes. In particular, spray curing techniques can be used to form cured volumetric shapes using polysilocarbs. Spray drying techniques can be used with net precursor formulations, filled precursor formulations, partially catalyzed precursor formulation, emulsions of precursor formulations, suspensions of precursor formulations, and others.

Using spray drying techniques, solid, substantially round, spherical and other shaped particles can be produced from polymer derived ceramics, and in particular from polysilocarbs. The polysilocarb precursor is processed with spray drying, e.g., curing methods into solid, substantially round, spherical and pyrolized particles having an average particle size, greater than about 200 microns. Larger and small sizes may be made from for example sub-micron to 1,000 microns.

Spray drying involves the atomization of a precursor fluid feedstock into sprays of droplets, which are cured to individual PDC perform particles on contact with hot gas. Prior to the present inventions it is believed that spray drying of PDCs, to spray cure the material; and in particular, the spray curing of polysilocarb precursors, was unknown.

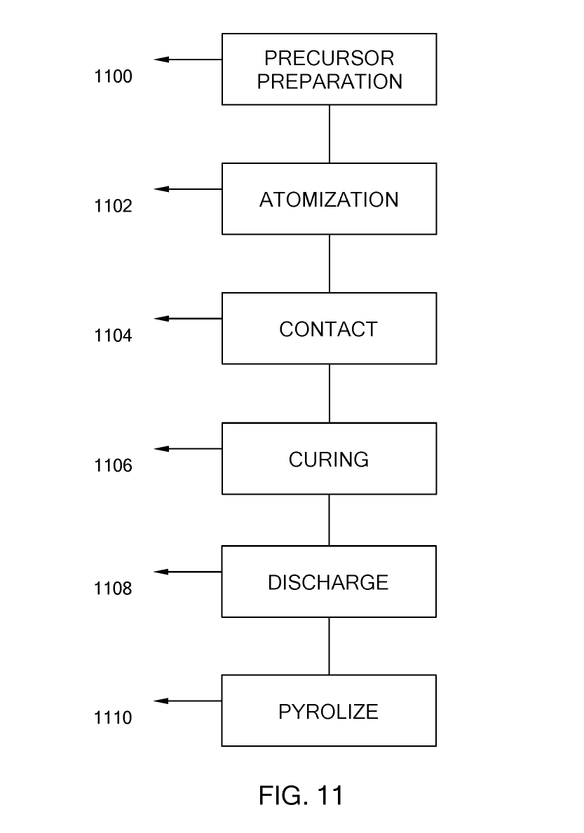

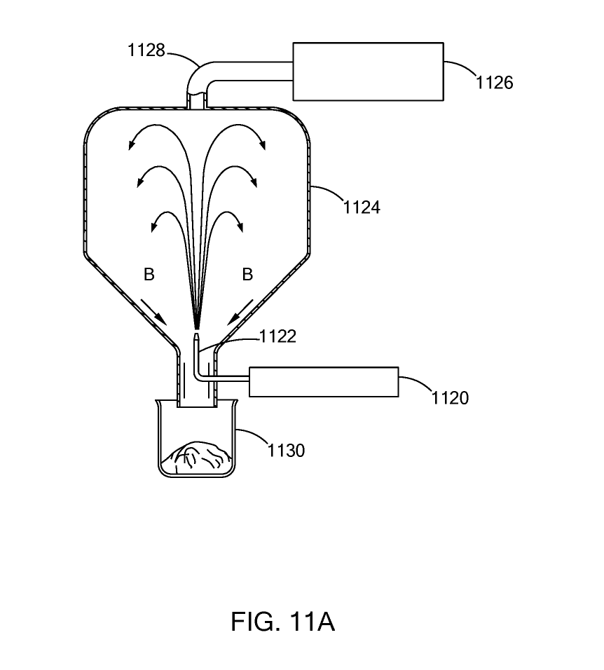

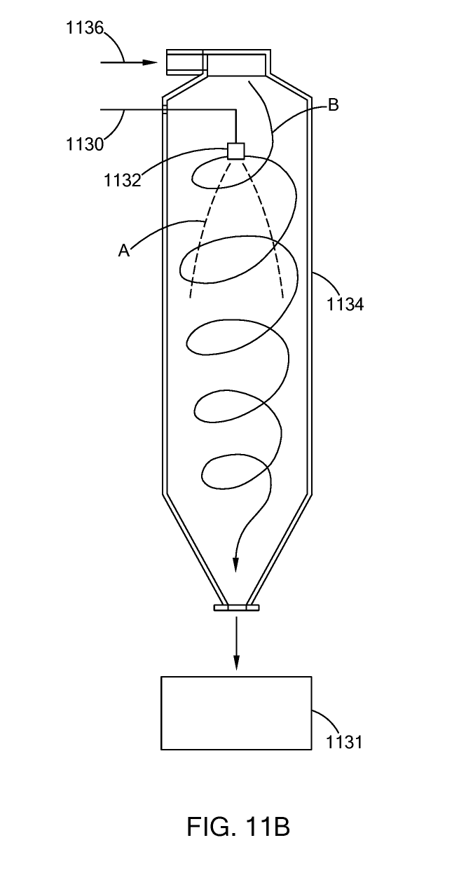

FIG. 11 is a diagram of a method for making cured solid PDC particles that are substantially round and spherical using a spray curing process as described herein. FIG. 11A illustrates a curing chamber providing a combination of co-current and counter-current flow for use in spray curing methods as described herein. FIG. 11B illustrates a curing chamber providing a co-current flow for use in spray curing methods as described herein.

In particular, spray curing methods for making substantially round and spherical, solid, PDC particles having an average particle size of greater than or less than about 200 microns, are contemplated. In certain embodiments, the particles have an average particle size of greater than about 300 microns, or greater than about 400 microns. As used herein, unless specifically stated otherwise, the phrase “average particle size” describes a particle size calculated from the sieve distribution of a batch of the particles.

As used herein, unless specifically stated otherwise, the phrase “solid ceramic particle” describes ceramic particles having an interior void that is less than about 10% by volume of the particle. In certain embodiments, the solid ceramic particles have an interior void that is less than about 5% by volume of the particle.

Referring now to FIG. 11, a method for making a solid ceramic particle that is substantially round and spherical using a spray curing process includes precursor preparation 1100, atomization 1102, contact 1104, curing 1106, discharge 1108, and pyrolysis 1110.

In precursor preparation 1100, a precursor is prepared comprising a PDC formulation, preferably a polysilocarb. The viscosity of the PDC formulation is limited to those that will make the formulation suitable for pumping through a pressure nozzle or rotating wheel in atomization process 1102, and will allow for the production of green particles that can be pyrolized to form solid ceramic particles that are substantially round and spherical.

In the atomization process 1102, the precursor formulation is fed to atomizing equipment. Suitable atomizing equipment includes but is not limited to a rotary wheel atomizer, a pressure nozzle atomizer, a twin disc atomizer and a dual fluid nozzle atomizer. Rotary wheel, pressure nozzle and dual fluid nozzle atomizers are known to those of skill in the spray drying art, and include those in spray dryers commercially available from a variety of sources, such as Niro, Inc.

Whether to use a rotary wheel, pressure nozzle, or dual fluid nozzle atomizer depends upon properties desired in the final dried PDC particle, such as size, distribution, and shape, along with the desired production capacity. Generally, rotary wheel atomizers produce fine particles, while pressure nozzles and dual fluid nozzles operated under pressure can produce comparatively larger particles.

When a rotary wheel atomizer is used, PDC precursor is fed to the center of the rotating wheel of the atomizer, and moves to the periphery of the wheel by centrifugal force. Atomization takes place at the wheel edge. The size of droplets and the size distribution of droplets in the resulting spray depend upon the amount of energy imparted to the precursor and the frictional effects between the newly formed droplets and the turbulent gas flow near the wheel. Sprays of droplets are ejected horizontally from the wheel but quickly follow the gas flow patterns created by a gas disperser, which directs the hot gas down into a chamber, e.g., for curing, pyrolizing and both, in a controlled manner. The particle size of particles produced in spray dryers with rotary wheel atomizers increases with decrease in atomizer wheel speed. Typically, the effect of feed rate is not great within the optimum working range of the given atomizer wheel, and fluctuations in feed rate during operation do not change the size distribution of the ceramic powder produced. Chamber diameters used with rotary wheel atomizers should generally be large enough to prevent the formation of semi-wet deposits at the chamber wall at the atomizer level. In contrast, chambers of smaller diameter but larger cylindrical height can be used with pressure nozzle and dual fluid nozzle atomizers.

When a pressure nozzle atomizer is used, precursor is fed to the nozzle under pressure. In the case of a dual fluid nozzle, precursor and curing gas are fed through separate nozzles. The feed of gas is pressurized, while the feed of precursor can be pressurized or a siphon/gravity feed. In the embodiments described herein as using a dual fluid nozzle, the precursor feed was pressurized.

The pressure energy is converted into kinetic energy, and the precursor flows from the nozzle orifice as a high-speed film that readily disintegrates into droplets. The droplet size produced from a pressure nozzle atomizer or pressurized dual fluid nozzle varies inversely with pressure and directly with feed rate and feed viscosity. The capacity of a pressure nozzle or pressurized dual fluid nozzle varies with the square root of pressure. In certain embodiments where high feed rates and/or high-capacity spray curing is desired, multi-nozzle systems can be used.

Turning now to contact 1104, a spray of droplets of precursor exiting the atomizing equipment meets hot curing gas entering a curing chamber. How the droplets and curing gas are initially contacted, and how the droplets/particles move throughout the curing chamber can generally be described as either co-current, counter-current, or a combination thereof.

In certain embodiments, such as the one illustrated in FIG. 11A, a curing chamber providing a combination of co-current and counter-current flow is illustrated in use with a pressure nozzle atomizer.

FIG. 11A is a simplified diagram of a spray curing apparatus comprising a curing chamber 1124, e.g., curing, pyrolizing or both, and a pressure nozzle 1122. Spray dryers typically include additional components, which need not be detailed herein, as spray dryers and their components are known to those of ordinary skill in the spray drying art. In FIG. 11A, precursor is fed from a feed source 1120 through a pressure nozzle 1122. Although only one pressure nozzle is illustrated in FIG. 11A, multiple nozzles can be used. Various types of equipment suitable for feeding a precursor are known to those of ordinary skill in the art, and can include, for example, a feed pump with or without a filter. The pressure nozzle 1122 atomizes the precursor into droplets and sprays the droplets upward into the dryer chamber 1124, which is illustrated by arrows A. Hot gas is fed into the curing chamber 1124 from an gas source 1126, through an inlet 1128 and enters the curing chamber 1124 where it contacts the precursor droplets. Thus, the hot gas enters from a point above the point at which the precursor is sprayed into the curing chamber, and flows in a generally downward direction in the chamber. Initially, the precursor droplets flow in a generally upward direction in the curing chamber, thereby establishing a counter-current flow. At some point, however, the droplets will exhaust their vertical trajectory, and begin to flow in a generally downward direction in the chamber, thereby establishing a co-current flow. Droplets in a curing chamber such as that illustrated in FIG. 11A have an extended vertical trajectory, which allows a longer airborne time for curing. Although FIG. 11A illustrates a pressure nozzle atomizer in use with a combination co-current and counter-current curing chamber, such curing chambers can also be used with rotary wheel atomizers and dual fluid nozzle atomizers.

In certain embodiments, such as that illustrated in FIG. 11B, a co-current curing chamber is used with a pressure nozzle atomizer. FIG. 11B is a simplified diagram of a spray curing apparatus comprising a curing chamber 1134 and a pressure nozzle 1132. Precursor is fed from a feed source 1130 through a pressure nozzle 1132. The pressure nozzle 1132 atomizes the precursor into droplets and sprays the droplets in a generally downward direction (illustrated at “A”) into the dryer, e.g., curing, chamber 1134. Hot gas is fed into the curing chamber 1134 from a gas source 1136, and flows into the curing chamber 1134 in a generally downward direction (illustrated at “B”). Thus, the hot gas and the precursor droplets flow in a generally downward direction in the chamber, thereby establishing a co-current flow. Although

FIG. 11B illustrates a pressure nozzle atomizer in use with a co-current curing chamber, co-current curing chambers can also be used with rotary wheel atomizers and dual fluid nozzle atomizers.

Various types of equipment suitable for feeding hot gas into the curing chamber for curing of the droplets are known to those of ordinary skill in the art, and can include, for example, a heater with or without a gas filter.

Typically with spray drying technologies, the droplets generally do not rotate as they are projected through the curing chamber, thus, the potential exists for one side of the droplet to be exposed to gas from the inlet that is hotter than the gas to which the other side of the droplet is exposed (referred to herein as the “hot side” and the “cool side”, respectively). In such instances, curing may be faster on the hot side, and the film that forms on the surface of the droplet thickens. e.g., cures, more rapidly on the hot side than on the cool side. Liquid and solids in the droplet migrate to the hot side. At this point, it would be expected that the cool side would be drawn inward, which would result in a hollow green particle with a dimple, rather than the solid green particles described herein. However, according to the methods described herein, the particles can be solid, uniform, and spherical, rather than hollow or irregular shapes, because of one or more of the curing and formulating parameters are adjusted to mitigate this potential for uneven curing.

Regarding the gas inlet temperatures, the temperature of the gas entering a curing chamber is controlled and preferably predetermined. Thus, in certain embodiments, the gas inlet temperature is in a range of from about 100° C. to about 200° C., or from about 200° C. to about 300° C., or from about 300° C. to about 400° C., or from about 400° C. to about 500° C. In other embodiments, the gas inlet temperature is in a range of from about 150° C. to about 200° C. or from about 200° C. to about 250° C. Preferably, temperatures in the lower end of such ranges are used in order to slow the rate of curing of the particles, which in turn contributes to the production of green ceramic particles that can be pyrolized to produce solid ceramic particles that are substantially round and spherical.

Referring again to FIG. 11, discharge 1108 includes separation and discharge of green ceramic particles from the dryer chamber. In certain embodiments, a two-point discharge system is used. In a two-point discharge system, primary discharge of the coarsest fraction of the green ceramic particles is achieved from the base of the chamber and discharge of the finer fraction is achieved from the base of a cyclone and baghouse system. In certain other embodiments, a single-point discharge system is used. In a single-point discharge system, recovery of the green ceramic particles is accomplished from the dryer chamber. For example, in the schematic illustrated in FIGS. 11A and 11B, the green ceramic particles are discharged from the curing chamber into a discharge 1130 and 1131 at least in part under the influence of gravity.

In addition to the components illustrated in FIGS. 11A and 11B, suitable curing arrangements can further include fans and ducts, exhaust gas cleaning equipment (cyclones, baghouses, scrubbers), and control instrumentation. Such further components and equipment, are know to those of skill in the art.

After discharge 1108, the green ceramic particles are then pyrolized 1110 using conventional pyrolizing equipment to form solid ceramic particles that are substantially round and spherical.

The green beads can them be pyrolized, to form PDC, and preferably polysilocarb derived ceramic proppants, pigments, and high purity starting materials for transformation into SiC.

The systems methods and apparatus set forth in U.S. Pat. No. 7,387,752 can be use with polymer derived ceramic precursors to make small volumetric shaped cured materials, for use in making proppants, pigments, and ultra pure SiOC and SiC. In particular these apparatus, systems and methods can be used to make polysilocarb ceramic preforms and ceramics. The entire disclosure of U.S. Pat. No. 7,387,752 is incorporated herein by reference.

Injection and Reaction Molding Systems

Injection molding processes are well known and have been developed for molding plastic parts. These processes generally involve melting plastic or resin pellets by feeding the pellets through a heated screw barrel utilizing a rotating screw. The heated barrel together with the heat supplied by the shear of the plastic pellets heats the resin pellets above their melting point. The screw is supported axially with a load and as the material moves to the front of the screw, the buildup in pressure forces the screw backwards until a desired volume of plastic has been developed in front of the screw. At this point, the rotating screw is stopped and the molten plastic is injected by moving the screw forward to force plastic through the nozzle into the cooled mold cavity to provide the desired molded part. The mold cavity is cooled and the injected plastic is fixed to the desired shape of the part. Such known technology and operations require that the forward motion of the screw generally should fill the mold cavity to obtain a good quality, dense molded part.

For the injection molding of PDC formulations to form injection molded PDC preforms, the typical injection molding machine is modified and utilized in accordance with the teaching of the present inventions. Examples of such molding machines that may be utilized as PDC preform molding machines are found in U.S. Pat. Nos. 8,328,548, 6,267,580 and Patent Publication No. 2009/0011064 and 2002/0030295. Embodiments of PDC molding machines and processes of the present inventions are generally design to deliver a liquid to the mold cavity, and the mold cavity is maintained at an elevated temperature to cure the PDC formulation, to form a cured PDC preform. Typically, the liquid formulation is catalyzed in the liquid PDC formulation portion of the machine, or just prior to being added to that portion of the machine. The liquid may be headed in the liquid PDC formulation portion, to control viscosity and final cure time in the mold, or it may not be, and may be kept at ambient, or below ambient, for example, 60 F. The liquid PDC formulation is injected into the mold, the mold is maintained at the cure temperature for the PDC formulation, and the PDC formulation is cured to a preform in the mold. The preform can be a hard cure, a final cure, a green cure, and variations and combinations of these and other levels of cure, for example only the outer skin can be cured.

For example, polysilocarb formulations made from among other things, can be injection molded equipment (including reaction injection molding equipment). The molds may be made from, for example, steel, aluminum, epoxy, and urethanes.

In an embodiment there is provided an injection molding machine for molding micro-cured-PDC-preforms containing a PDC shot volume of between about 0.001 to 3.5 cubic centimeters per volumetric shape made. Specifically, the micro injection molding machine utilizes pneumatic cylinder or cylinders for the delivery of the PDC formulation to the injection portion of the molding machine. A linear motor drives the injection portion to inject the PDC formulation through the nozzle into the mold cavity to complete the injection molding of the micro-cured-PDC-preform.

Plastic molding technologies, machines, methods and processes, and in particular, such technologies for molding, in preferably injection molding, small, very small, e.g., micromolding parts, can be used to make PDC small volumetric parts, e.g., cured PDC preforms, and in particular polysilocarb ceramic volumetric shapes and preforms.

In embodiments, molding machines for molding PDC micropreforms (e.g., micro-cured-PDC-preforms) containing, for example, between less than about 0.1 cubic centimeters (cc), less than about 0.01 cc, less then about 0.001 cc, less than about 0,0001 cc, from about 5 cc to about 0.0001 cc, from about 4 cc to about 0.0015 cc, from about 3.5 cc to about 0.001 cc, of liquid PDC shot volume includes a liquid PDC formulation portion operatively connected to an injection portion and a mold portion. A valve member is provided to open and close the connection between the liquid PDC formulation portion and the injection portion. A linear motor member is associated with the injection portion to permit molding times of about 0.01 seconds, about 0.0015 second, (greater and lesser times may be utilized depending for example on the viscosity of the liquid PDC formulation) at pressures up to about 100,000 psi (although these pressures are typically needed for the injection of plastic, while the present liquid PDC formulations, and the ability of the present invention to control and preselect the viscosity of these liquids, could require less pressure, e.g., less than 100,000 psi, less than 50,000 psi, less than 25,000 psi.) during injection of the PDC formulation into the mold portion.

The prior art processes for injection molding are typically adequate for molding normal size parts utilizing shot sizes in excess of 3.5 to 5,0 cubic centimeters; however, when the micro-cured-PDC-preforms require very small shot volumes of less than less than about 5 cc, less about 4 cc, less than about 3.5 cc, and smaller, there are significant problems with prior larger scale processes and technology. For example, the screw or auger means used to transport the PDC formulation generally should be miniaturized in diameter to accept and process the PDC formulation. (It being noted that in some embodiments, a PDC formulation may be a solid or semi-sold and could be processed in a manner similar to resin pellets in the molding machine, however, the presently preferred PDC formulations are liquid formulations that are more preferably catalyzed). If the screw is too large, it will contain to large a volume of PDC formulation relative to the part being molded. In such a situation, the PDC formulation being catalyzed, and potentially remaining heated in the barrel after each molding cycle, will cure over time when held. However, if the screw or auger is miniaturized and the screw flight depths are smaller than the pellet size, if pellets are used, problems exist concerning accepting the pellets and feeding the precursor or pellets into the auger to allow compression and melting of the precursor. Further, because the PDC precursors are typically liquids the screw assembly my be replaced with a plunger, or piston, type assembly. In general, catalyzed PDC formulations are relatively, to very, shear insensitive, and the smaller size considerations of the miniaturized screws should not be an issue.

Additionally, for molding micro-cured-PDC-preforms often require a thin wall thickness ranging from about 0.025 to 0.30 mm. It is desirable to force and inject the liquid into these thin walled micro-cured-PDC-preforms without premature curing, solidification. In some molds and configuration this could require higher pressures and short injection times. The formulation, amount of catalyst and temperature can also be controlled to control cure rate, including thickening, in these situations. Thus, many of these requirements can be addressed with the PDC's ability to have its viscosity predetermined and controlled and its cure rate predetermined and controlled.

Accordingly, to injection mold micro-cured-PDC-preforms the injection molding machine preferably creates a high enough injection pressure and possess controlled injection speed profiles substantially less than 0.5 seconds. Also, existing technology and processes utilize hydraulic pressures to create the injection pressures and injection speed profiles. However, hydraulic fluids are not readily compatible with clean room facilities. Thus, the injection molding of medical grade devices, ultra pure materials, and related micro-cured-PDC-preforms is severally limited with existing technology.

In one embodiment of a molding machine to overcome the problems of these known injection molding machines and processes for making micro molded preforms, it is suggested that the injection machine include a system wherein the precursor is introduced into the front of an injection plunger. This system, under the present invention would be modified for the manufacture of PDC preforms. Such machines utilize or require air cylinders to drive the injection plunger, a structure and mechanism. Such injection molding machines cannot stop the injection process as the mold cavity is filled except by the increase in pressure buildup during the molding process. The control of the molding process by measuring the increase in pressure yields, is a less preferred methods, as a high variability in the molded parts, a result which is unsatisfactory for most molded operations.

Thus, embodiments provide, among other things, injection molding machines an processes for molding micro-cured-PDC-preforms, for molding micro-cured-PDC-preforms which utilize PDC formulation shot volumes of between about 0.001 to 3.5 cubic centimeters, and for molding micro-cured-PDC-preforms which is comprised of a liquid PDC formulation portion and an injection portion which permits the utilization of precursor shot volumes of between about 0.00015 to 4.5 cubic centimeters.

An embodiment of the injection portion of the molding machine includes an injection cylinder, which is positioned and secured within the cylinder block in axial alignment with the resin flow channel which cooperates with the nozzle to permit the PDC formulation to be injected into the mold. The injection portion is maintained on the centerline of the mold. A precision fitted injection pin member is fitted within the bore of the injection cylinder and is maintained in very close tolerance with respect to the bore, within the range of about 0.012 mm or less. This precision fitting of the injection pin within the bore of the injection cylinder as well as the utilization of a linear motor engaging the injection pin permits the application of high pressures at very high speeds during the injection phase of the molten resin through the resin flow channel and nozzle into the mold portion. Also, the precision fitting prevents back flow between the injection pin and the cylinder bore during the molding process. The valve member, positioned between the injection portion and the liquid PDC formulation portion is closed during the injection process to prevent back flow of the PDC formulation into the lower pressure capacity liquid PDC formulation cylinder. The valve member is a tapered valve, which is, preferably, powered by an air cylinder. The valve member is positioned inside the liquid PDC formulation cylinder block and is maintained at the proper uniform temperature.

When the PDC formulation is forced by the liquid PDC formulation cylinder into the resin flow channel and the injection cylinder, the valve member is closed and the injection pin is driven forwardly to pressure the flow of precursor through the nozzle and sprue into the closed mold cavity.

The injection pin is driven by an electric motor means. The term electric motor means may be used to describe a rotary motor coupled to a ball screw device which converts the rotary motion to a linear motion. However, it is a preferred embodiment of the present invention that the electric motor means is a linear motor which directly provides linear motion to the injection pin. The term “linear motor” is used to describe a motor that is electrically driven in a linear motion rather than in a rotary motion. One type of linear motor useful in the present invention is a linear servo or stepper motor manufactured and sold by Trilogy Linear Motor, Webster, Tex. The linear motor provides a linear motion which engages and controls the speed and pressure engaging the injection pin.

The electronic control of the linear motor provides for the very high speed movement of the injection pin while maintaining precision control and location of the injection pin. The position of the injection pin is continuously monitored and fed to the electronic control system by a linear measuring device, such as an LVDT. The injection pin is engaged and pushed by the linear motor, but is not necessarily directly coupled to the linear motor. If desired, the elimination of direct coupling between the injection pin and linear motor avoids the necessity of precise alignment with respect to the injection pin and the linear motor. The forward axial movement of the injection pin within the resin flow channel injects between about 0.00015 to 4.5 cubic centimeters of shot volume into the mold, as desired.

After completion of the mold cycle, the injection pin is axially moved rearwardly under load as the valve member is opened and PDC formulation from the liquid PDC formulation cylinder enters the resin flow channel to force the injection pin rearwardly from the mold portion. The flow of the formulation into the resin flow channel returns the injection pin during the reloading cycle of a predetermined shot volume of PDC formulation from the liquid PDC formulation portion into the injection portion.

After the flow of liquid PDC formulation into the resin channel, known as the preparation of a predetermined shot volume of PDC formulation, the mold portion is moved axially away from the nozzle and the mold is opened to permit ejection of the molded micro-cured-PDC-preform from the molding cavity. Thereafter, the valve member is closed and the mold portion is moved axially to engage the nozzle to repeat the molding and cure cycle for the predetermined shot volume.

As set forth above, the injection nozzle cooperates with the injection pin to facilitate injection of the heated resin or precursor material through the sprue opening into the mold cavity. The mold cavity is designed such that the molded micro-cured-PDC-preform may be readily removed from the mold cavity by ejection pins or suction after each cycle of operation. By utilizing precursor or resin flow channels of about 0.5 to 6.0 mm in diameter, precursor shot volumes of between about 0.00015 to 4.5 cubic centimeters may readily be achieved. Moreover, because of the reduced size of the flow channel, the number of parts that can be molded, utilizing the PDC formulation contained within the liquid PDC formulation chamber, is reduced thereby insuring maximum molding efficiency without unintended curing of the PDC formulation between loadings.

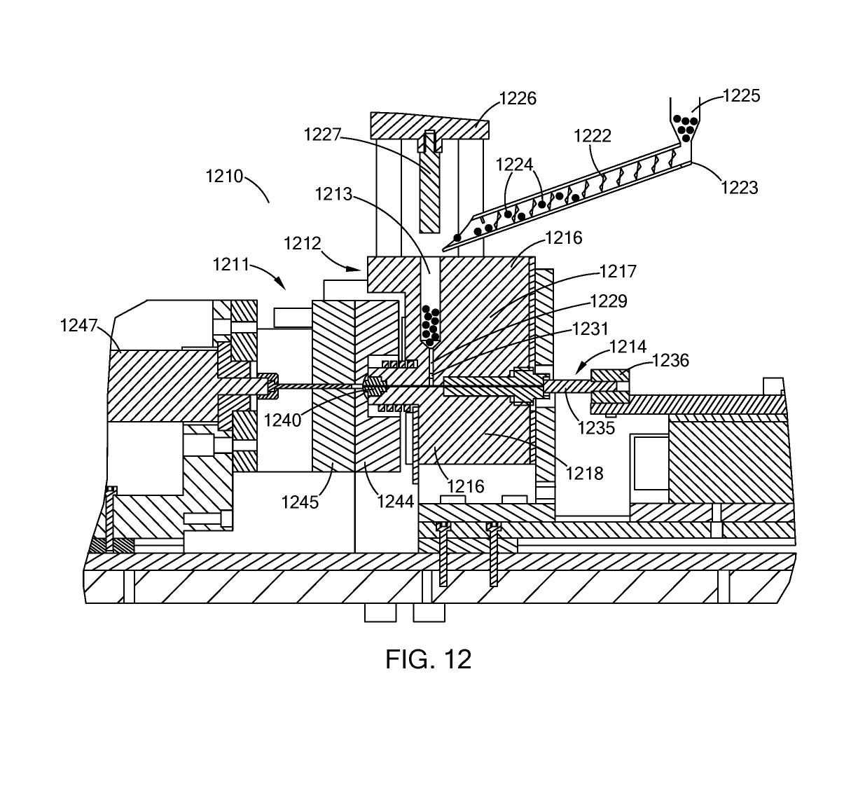

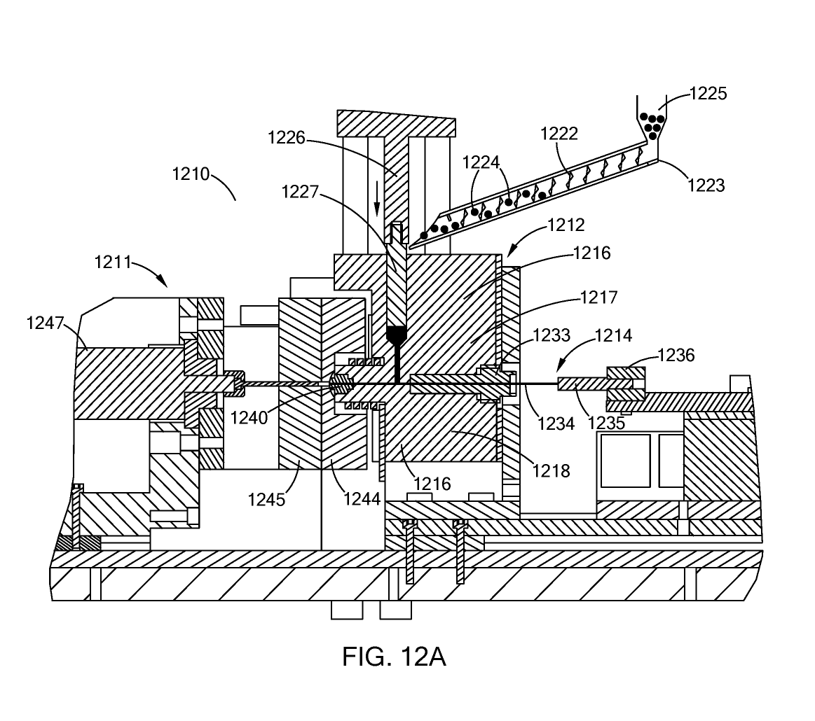

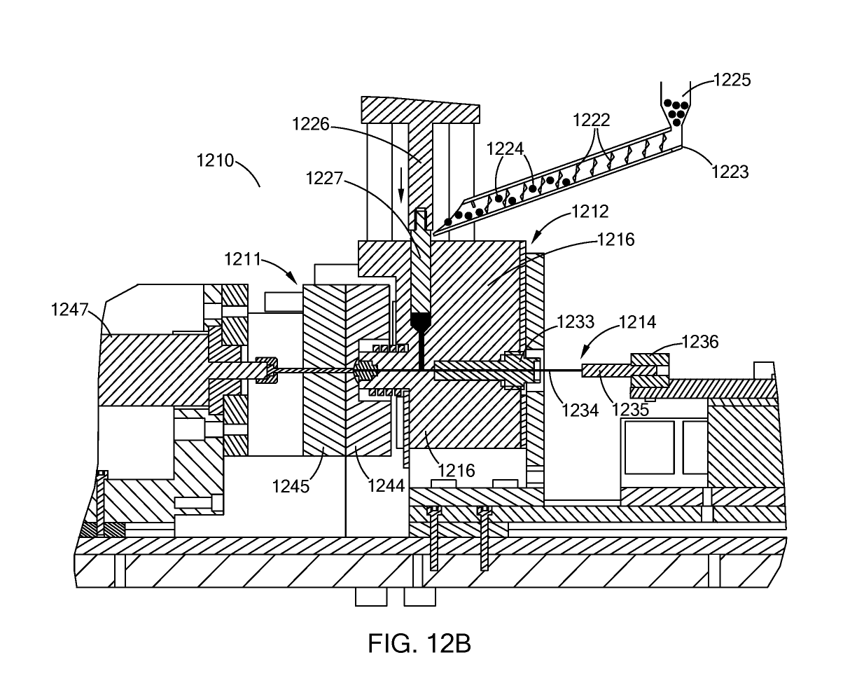

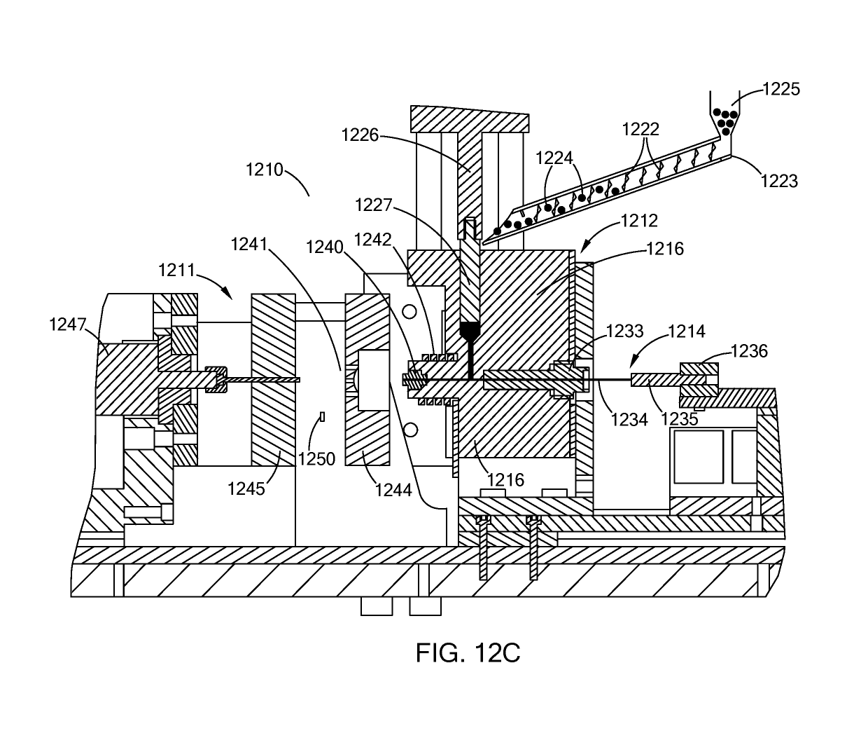

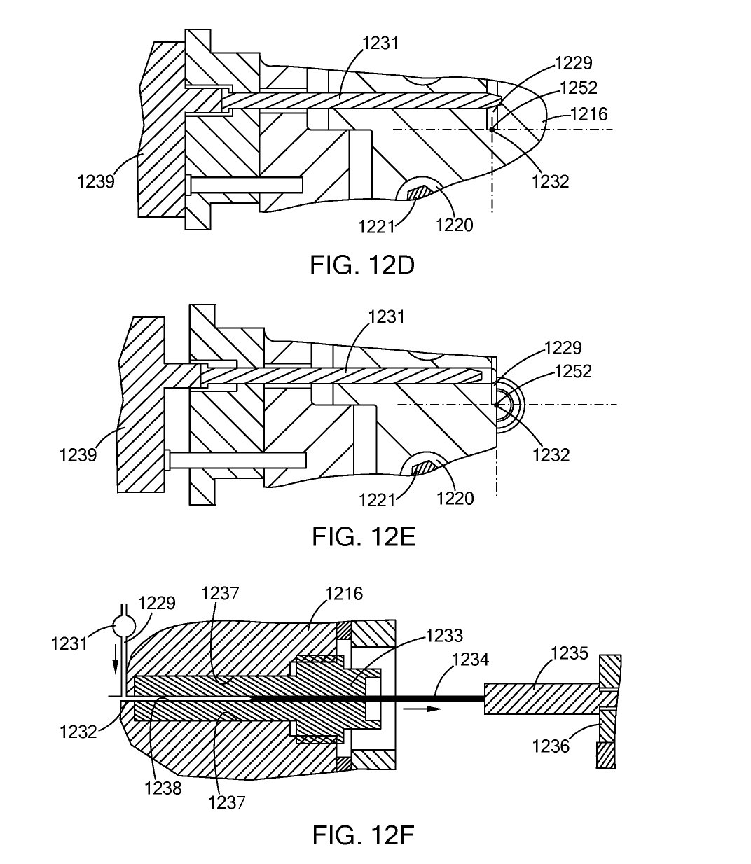

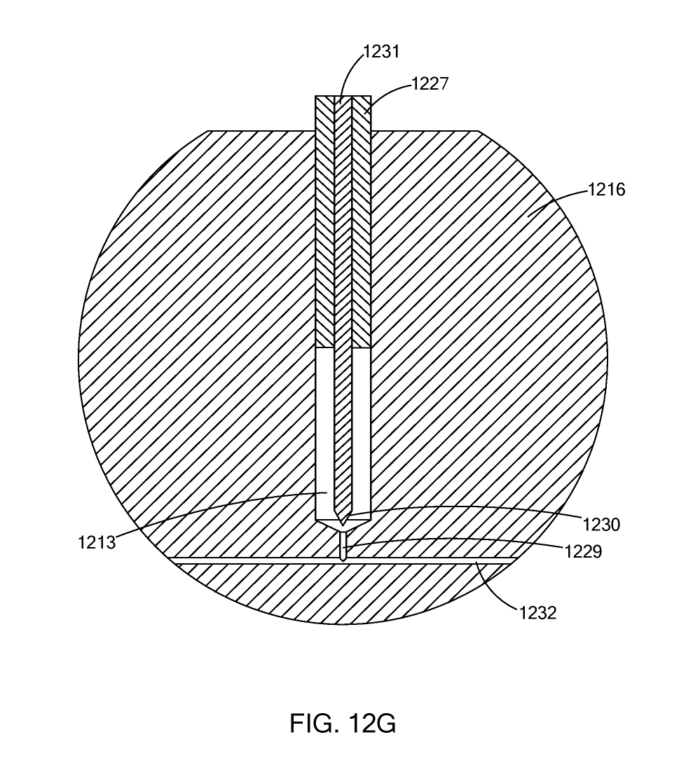

Turning to FIG. 12 there is a cross-sectional view of an embodiment of an injection molding machine illustrating the loading of liquid or pellets into the liquid PDC formulation portion of the injection molding machine. FIG. 12A is a cross-sectional view of the injection molding machine of FIG. 12, illustrating the temperature control in the liquid PDC formulation portion and the filling of the injection portion with a predetermined shot volume of PDC formulation. FIG. 12B is a cross-sectional view of the injection molding machine of FIG. 12, illustrating the injection of PDC formulation through the resin flow channel and nozzle into the mold by movement of the linear electric motor. FIG. 12C is a cross-sectional view of the injection molding machine of FIG. 12 illustrating axial movement of the mold portion from the injection portion and the opening of the mold to eject the molded micro-cured-PDC-preform. FIG. 12D is an enlarged fragmentary view illustrating the valve member closed between the liquid PDC formulation portion and the injection portion of the injection molding machine of FIG. 12. FIG. 12E is an enlarged fragmentary view illustrating the valve member opened between the liquid PDC formulation portion and the injection portion to permit the flow of a predetermined shot volume of PDC formulation into the injection portion in the injection molding machine of FIG. 12. FIG. 12F is an enlarged fragmentary view illustrating the position of the injection pin during filling of the resin flow channel with PDC formulation from the liquid PDC formulation portion in the injection molding machine of FIG. 12. FIG. 12G is an enlarged fragmentary view illustrating the positioning of a valve member between the liquid PDC formulation portion and the injection portion in the injection molding machine of FIG. 12.

Turning now to FIGS. 12, 12A to 12G, wherein like numerals have been used throughout the several views to designate the same or similar parts. The embodiment of FIGS. 12, 12A to 12G, is directed to an injection molding machine for molding micro-cured-PDC-preforms and a process for making these preforms. The micro-cured-PDC-preforms are generally solid, and may be proppants, pigments, additives, and other solid volumetric shapes, they also may have wall thickness ranging between about 0.025 to 0.3 mm. As shown in FIGS. 12-12C of the drawings, the micro injection molding machine 1210 is comprised of a liquid PDC formulation portion 1212, an injection portion 1214 and a mold portion 1211. The liquid PDC formulation portion 1212 is adapted control feed PDC formulation into the injection portion of the molding machine. The injection molding machine 1210 includes a heated cylinder block 1216 comprised of an upper portion 1217 and a lower portion 1218 which are integral to one another. The upper and lower portions of the cylinder block 16 preferably include heater holes 1220 therein, see, e.g., FIGS. 12D and 12E. The heating holes are positioned throughout the block 1216 and are adapted to receive electrical cartridge heaters 1221 therein to provide uniform temperature of the cylindrical block.

The liquid PDC formulation portion 1212 includes a spiral screw or auger feeder member 1222 which is driven for clockwise rotation by a stepper motor (not shown). The upper end 1223 of the spiral screw member is adapted to receive the PDC formulation 1224 from a hopper 1225 containing a supply of PDC formulation. The liquid PDC formulation portion 1212 further includes a liquid PDC formulation air cylinder 1226 which drives a liquid PDC formulation plunger 1227 within the liquid PDC formulation chamber or bore 1213, positioned within the temperature controlled cylinder block 1216 and containing the PDC formulation. The bore 1213 is adapted to receive the PDC formulation 1224 from the spiral screw member 1222, the position as shown in FIG. 12. The liquid PDC formulation plunger 1227 cooperates with the bore 1213 in the cylinder block 1216 to the position as shown in FIG. 12A. The liquid PDC formulation plunger 1227 is sized with respect to the bore 1213 to permit trapped air to escape past the plunger and bore wall during the compression and potential heating of the precursor.

Also, see e.g., FIGS. 12 and 12F, a conduit 1229 exits the bore 1213 and communicates with the resin flow channel 1232 of the injection portion 1214 of the injection molding machine 1210. Located within the conduit 1229 is a high pressure valve member 1231 which is operable between an open and closed position, as shown in FIGS. 12D and 12E. The conduit 1229 is adapted to intersect the resin flow channel 1232 to deliver and fill the injection channel with PDC formulation material, as will hereinafter be described.

The injection portion 1214 of the molding machine 1210 is comprised of a resin flow channel 1232, an injection cylinder 1233 and an injection pin 1234 which is engageable with a push pin 1235 coupled to a linear drive means or motor means 1236, see e.g., FIGS. 12-12C and 12F. The injection cylinder 1233 is removably mounted to a bore 1237 positioned between the upper portion 1217 and lower portion 1218 of the cylinder block 1216. The injection cylinder 1233 includes a bore 1238 extending the length thereof (FIG. 12F) which defines the resin flow channel 1232 therein and which is adapted to receive injection pin 1234 for back and forth movement therein. The resin flow channel 1232 is axially aligned with a nozzle 1240, which engages a sprue 1241 in mold member 1244 to permit injection of the PDC formulation or PDC formulation through the sprue into the mold defined by mold members 1244 and 1245, best shown in FIG. 12C. If necessary, temperature controllers 1242 may be provided about the cylinder block where the resin flow channel engages the nozzle 1240 to facilitate and maintain the formulation, which is most preferably catalyzed at that point in the process. The temperature control is shown in FIGS. 12-12C.

The injection pin member 1234 is adapted to be received within the bore 1238 of the injection cylinder 1233 and to maintain a very close tolerance with respect to the bore within the range of about 0.012 mm or less. This precision fitting of the injection pin within the injection cylinder permits for the application of high pressures at very high speeds during the injection phase while preventing backflow of the PDC formulation between the injection pin and the injection cylinder 1233 during the injection operation. As shown in FIG. 12D, the valve member 1231, positioned in the conduit 1229 of the liquid PDC formulation portion 1212, is closed during the injection step (FIG. 12B) to prevent backflow of the PDC formulation into the lower pressure capacity liquid PDC formulation cylinder. As shown in FIGS. 12D and 12E, the valve member 1231 is a tapered valve which is powered by an air cylinder 1239. The valve member 1231 is positioned inside the heated cylinder block and is maintained at a proper uniform temperature.

In another embodiment of the present invention, the valve member 1231 is positioned concentrically with the liquid PDC formulation cylinder 1226 and plunger 1227 to control, in a predetermined manner, the flow of PDC formulation through conduit 1229 from the liquid PDC formulation portion to the injection portion. In FIG. 12G, the tapered end 1230 of the valve member 1231 is structurally arranged to engage the entrance to conduit 1229 to block the flow of PDC formulation into the injection portion during the injection step (FIG. 12B) and to prevent backflow of the PDC formulation into the pressure capacity liquid PDC formulation cylinder.

The process of filling the injection portion is shown in FIG. 12A. The PDC formulation 1213 are compressed by the liquid PDC formulation plunger 1227 and valve member 1231 is opened, as shown in FIGS. 12E and 12G, the liquid PDC formulation plunger 1227 forces the PDC formulation into the resin flow channel 1232 and the injection cylinder 1233 of the injection portion 1214. This fills the resin flow channel, the position as shown in FIG. 12A and illustrated in FIG. 12F.

The liquid PDC formulation plunger 1227 is moved into the chamber or bore 1213 in the upper portion 1217 by an air cylinder 1226. The cylinder block 1216, surrounding the liquid PDC formulation plunger and chamber, is temperature controlled to the proper temperature for the particular catalyzed PDC formulation being molded. The force acting upon the liquid PDC formulation plunger 1227 by the liquid PDC formulation air cylinder 1226 and the temperature control, facilitates stability within the chamber or bore 1213.

The valve member 1231, positioned either in conduit 1229 (FIGS. 12-12E) or associated with conduit 1229 (FIG. 12G), and which is located between the resin flow channel and injection cylinder and the liquid PDC formulation chamber bore 1213, is opened while the nozzle is maintained against the mold member 1244 and sprue 1241. The valve member 1231 is moved between the open and closed position by air cylinder 1239 or by a concentric mounted cylinder, not shown in FIG. 12G. During the period of time valve member 1231 is open, the injection portion is receiving and filled with liquid precursor and the nozzle 1244 is positioned against the mold while the PDC preform previously molded is cooling. This prevents precursor material from exiting the nozzle 40 into the mold during the filling step.

A linear motor 1236 controls the motion of the injection pin 1234. During filling of the injection portion with precursor, a small load or pressure against the injection pin is maintained by the linear motor 1236. Because a greater pressure is applied to the precursor in the liquid PDC formulation chamber by the liquid PDC formulation plunger during filling, the PDC formulation entering the injection portion 1214 pushes back the injector pin 1234 away from the nozzle 1240, the position of the flow channel arrow in FIG. 12F. This forcing of the injector pin and linear motor away from the nozzle aids in preventing voids from forming in the PDC formulation contained in the liquid PDC formulation chamber or bore 1213. Also, the engagement of the injection pin with the linear motor provides for the predetermined control of the required shot volume for the part to be molded. As the injection pin is forced axially rearwardly within the injection cylinder, a linear position encoder sensor feed back to the linear motor controller stops the injection pin at a predetermined location. Because the formulation is held under pressure as the injection pin moves axially rearwardly from the nozzle, the consistency of the precursor shot volume within the resin flow channel for subsequent molding of the next micro-cured-PDC-preform is properly and predeterminely controlled. When the linear motor 1236 reaches the proper position for the desired shot volume to be injected through the resin flow channel, nozzle and sprue into the mold, the linear motor is stopped and the load on the liquid PDC formulation cylinder is removed. Then, the valve member 1231 is closed (FIG. 12D) to remove the load on the liquid PDC formulation cylinder. Thereafter, the linear motor 36 moves axially rearwardly from the injection cylinder approximately 1 mm to relieve pressure on the formulation in front of the injection pin.

As shown in FIG. 12C, after the filling of the shot volume into the injection portion and the completion of the injection of precursor into the mold (FIG. 12B), the mold members 1244 and 1245 are moved axially from the nozzle 1240 and opened with respect to one another. During opening of the mold cavity, an ejector or lifter pin 1243 or a suction hose (not shown) is applied to remove the molded micro-cured-PDC-preform 1250 from the molded cavity. The nozzle 1240 is maintained during this period of time a distance from the mold, which is heated to, or maintained at the cure temperature, to prevent the heating of the nozzle and the subsequent hardening, e.g., curing of the PDC formulation contained in the nozzle. The mold members are coupled together in axially aligned relationship and are axially moved relative to the nozzle by mold air cylinder 1247.

When the mold is closed and axially moved to engage the nozzle, the injection pin is in the rearward position. The engagement of the mold against the nozzle by air cylinder 1247 prevents leakage of precursor between the nozzle 1240 and sprue 1241. Precursor is then injected into the cavity of the mold by actuating the electric motor means 1230 to drive the ejector pin forward.

The term “electric motor means” may be used to describe a rotary motor coupled to a ball screw device which converts the rotary motion to a linear motion. However, it is a preferred embodiment of the present invention that the electric motor means is a linear motor 1236 which directly provides linear motion to the injection pin 1234. The term “linear motor” is used to describe a motor that is electrically driven in a linearly motion rather than in a rotary motion. One type of linear motor useful in the present invention is a linear servo or stepper motor manufactured and sold by Trilogy Linear Motor, Webster, Tex. The linear motor provides a linear motion which engages and controls the speed and pressure engaging the injection pin.

In order to achieve a high quality molded micro-cured-PDC-preform, the control of the filling of the mold and the pressure maintained as the formulation is cured to the preform is accomplished. Typically, during the first portion of the filling the mold cavity with precursor, the linear motor 1236 moves the piston forward at a preset speed independent of the pressure developed in the precursor. This preferably is at a very high speed (up to 125 cm/second velocity) for small, thin-walled micro-cured-PDC-preforms and for solid shapes. The linear motor speed can be controlled with a servo drive to change the velocity of the motor at predetermined steps during the filling stage. This is required when complex geometry micro-cured-PDC-preforms are molded because it is desirable to have a constant flow front of precursor as the mold is filled.

When the mold cavity is nearly filled, on the order of 95% filled, the injection motion is switched from a velocity control to a load or pressure control. This is accomplished by sensing the position of the injection pin 1234 with a linear encoder and when the predetermined position where the mold cavity is nearly filled is reached, the control system switches to a pressure control. Then, the pressure applied to the injected precursor is controlled by time steps correlated to different values. Typically, initially a higher pressure and then a lower pressure is desired. This permits formulation from the injection cylinder to flow into the micro-cured-PDC-preform as it is cured.

The linear motor or rotary motor coupled to a ball screw device are ideally suited for molding micro-cured-PDC-preforms because of their control of velocity, position and load from a single servo controller. These types of motors are capable of applying upwards of 100,000 psi and achieving an injection time of 0.01 second when a molded micro-cured-PDC-preform. Also, these type of motors provide the ability to start and stop very quickly as required for the small shot size volume of formulation in accordance with embodiments of the present invention. After the formulation is injected into the mold and the holding pressure time completed, the mold is heated to cure the PDC formulation. While this curing is being accomplished, the molding process repeats the step of filling the injection portion with PDC formulation and ejecting the molded part, as previously described.

The present embodiment of the injection molding machine 1210 utilizes air cylinders to drive the movement of the liquid PDC formulation plunger and to drive the axial movement of the mold portion with respect to the injection portion. The injection pin movement is accomplished utilizing a linear motor to provide high speed and high pressure during injection. Such use of air cylinders and electric motor means facilitates a clean room atmosphere, if such is desirable, but which is not needed for shapes such as proppants and pigments, to permit molding of all types of micro-cured-PDC-preforms, for all types of uses and applications, including medical and the electric electronic fields,

Additionally, the positioning of the injection cylinder, injection pin, resin flow channel, the nozzle and mold at the centerline 1252 (FIGS. 12D and 12E) of the heated cylinder block 16, prevents misalignment of the various parts as the temperature of the components change. This centerline positioning reduces the dimensional differences between the various parts to less than 0.1 mm. This enhanced position is facilitated by mounting the heated cylinder block 16, containing the injection cylinder, injection pin, resin flow channel and nozzle as one centerline position on the molding machine frame 1252, (FIGS. 12D-12E) and ensuring the axial alignment and cooperation with the mold portion 1211.

Other Forming Technologies

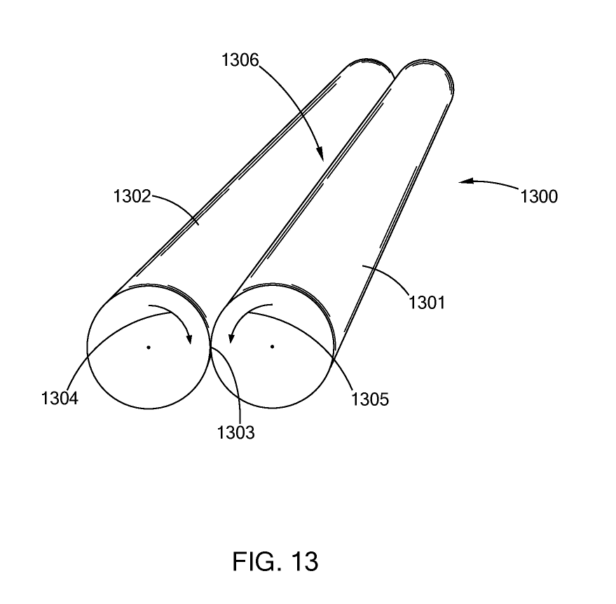

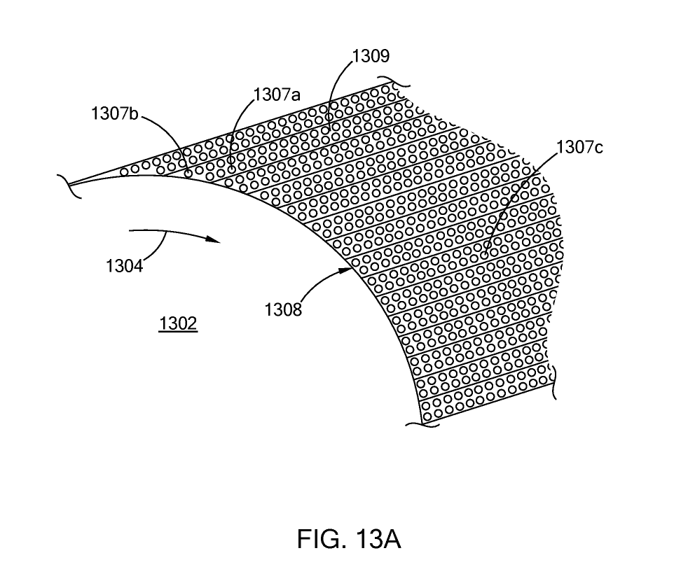

Printing technologies, screen technologies, substrate technologies, nip technologies, as well as the other technologies for example as provided in FIGS. 8, and 13-13A, can be used to make small volumetric shaped structures from polymer derived ceramic precursors, to make small volumetric shaped preforms, and in particular to make such structures from polysilocarb precursor formulations.

Thus, for example the following technologies, equipment and methods can be used to form small volumetric preforms: printing technologies, such as rotogravure; 3-D printing; laser induced cavitation, e.g., US Patent Application Publication No. 2012/0236299 (the entire disclosure of which is incorporated herein by reference); nip based technologies; flexible substrate based technologies; spray chilling; and ionic gelation.

Turning to FIGS. 13 and 13A there is a perspective view of a nip forming assembly and system 1300, and a detailed perspective view of one of the rollers 1302. The nip forming system 1300 has a first roller 1301 and a second roller 1302, that are counter rotated as shown by arrows 1305, 1304. One or both of the roller surfaces has a surface, e.g., 1309 that has a series of forming cells, e.g., 1307a, 1307b, 1307c, e.g., small indentations, cups, vessels, receptacles. In operation as the two rollers 1301, 1302, are engaged and counter rotated a nip 1303 is formed. Precursor is feed into the top of the nip 1303, by a distribution assembly, as shown by arrow 1306. The nip 1303 forces the precursor into the forming cells, e.g., 1307a, 1307b, 1307c. The forming cell preferably cover the entirety of the roller surface 1309, and may be contained in an insert assembly or row 1308 having a collection of forming cells. In this way should cells become clogged or damage the row can be removed, cleaned, replaced and operation continued.

Within the rollers 1301, 1302 there are zones of higher and lower pressure so that the precursor can be held in the forming cells while cured and then ejected from the forming cells upon cure.

Substrate base forming technologies may be used to make small volumetric shapes. Generally, in these systems a base that can be ridged, flexible or continuous can be used. For example a continuous screen (such as a metal, e.g., brass or, synthetic fourdriner wire, depending upon temperature, purity and other processing and end use requirements), a solid surface, or a flexible substrate can be used to hold or carry the precursor material, e.g., a thin layer or film of a liquid PDC precursor is spread or otherwise placed on the surface of the substrate. These substrates or bases can be moving, belt like, continuous or batch like, e.g. a tray. The precursor material can be cured, and hard cured in the openings in the wire, or on the surface of the substrate and then removed from the substrate. In the wire embodiment the cured material can be ejected from the wire. In the wire and other embodiments the cured material can be mechanically removed, ultrasonically removed, vibrated off, or otherwise separated from the substrate. Further, depending upon the type of curing, the cured material may spall, and thus, through spallation separate itself from the substrate.

For these approaches the substrate can be disposable, e.g., it does not need to be physically removed from the cured PDC material; instead it is consumed, and thus, removed during curing, and more preferably during pyrolysis. These systems provide a manner to make thin, and very thin sheets and platelets of PDC cured and pyrolized materials. Thus, these systems can make sheets and platelets that are thinner than 1 mm, thinner than 0.1 mm, thinner than 100 microns, thinner than 50 microns, thinner than 10 microns, thinner than 1 micron, and thinner than 0.1 microns, as well as thicker and thinner films, discs and platelets and other essentially planar volumetric shapes.

The thin film or layer of a liquid PDC precursor can be formed on the substrate by any film forming apparatus, such as a distribution heeder, slice, air knife, rollers, sprayers, to name a few.

The thin film or layer of PDC precursor on the substrate can be cured with any of the heating and curing techniques and conditions describe herein. Further, because of the thin nature of the PDC precursor, in may be preferable to use electromagnetic radiation as source of energy to cure, pyrolize, or both, the thin film of PDC precursor. Thus, for example microwaves, coherent light, monochromatic light, broad spectrum light (e.g., high intensity white light) and other forms of elector magnetic radiation can be used. If white light is used, the white light can have a broad band of wavelengths, e.g., from near UV to near IR, from 390 nm to 790 nm, from about 400 nm to about 760 nm, having a wavelength band of at least about 100 nm, a wavelength band at least about 200 nm, a wavelength band at least about 300 nm, and combinations and variations of these. Light in the UV wavelengths (generally about 10 nm to 400 nm) can also be used, thus UV lamps, UV lasers, UV-LEDs or UV radiative sources can be used. To enhance UV curing a UV active catalysts (e.g., one that absorb best between 380 to 405 nm) can be added to the precursor. Wavelengths from 360-420 (UV to violet) can be used. The high intensity electromagnetic radiation, e.g., light can pulsed or continuous. The electro magnetic energy wavelength, or wavelengths, may also be selected to provide a predetermined amount of energy absorption by the PDC precursor. The PDC precursor may also have additives, such as colorants, that increase, or selectively determine, the amount of energy, e.g., electromagnetic energy, that is absorbed. Thus, the PDC precursor and the electromagnetic wavelength may be predetermined and matched to optimize curing, spallation and both, as well as other features of the end or intermediate PDC material. The substrate may also be transmissive to the electromagnetic radiation, and thus, the film of PDC precursor can be cured from both sides. Additionally, the substrate can be horizontal, vertical, or at an angle between horizontal and vertical when the PDC precursor material is applied. The substrate may also be circular, e.g., along the lines of a Yankee dryer paper making drum.

Turning to FIG. 8, there is shown an embodiment of a substrate forming apparatus and process 800. This system 800 has a forming unit 803 that provides a thin layer of PDC precursor 802 on a moving substrate 803 (e.g., a continuous belt in this embodiment). An energy source 804 (e.g., heat source, RF, light source, etc.) is provided to cure the PDC thin film 802, and cause the formation of platelets 805, when the PDC precursor is separated from the substrate.

It should be understood that the use of headings in this specification is for the purpose of clarity, and is not limiting in any way. Thus, the processes and disclosures described under a heading should be read in context with the entirely of this specification, including the various examples. The use of headings in this specification should not limit the scope of protection afford the present inventions.

### EXAMPLES

The following examples are provided to illustrate various embodiments of polysilocarb precursors that can be formed into cured preforms, and pyrolized materials, by embodiments of the present forming systems and methods of the present inventions. These examples are for illustrative purposes and should not be viewed as, and do not otherwise limit the scope of the present inventions. It should be understood the term polysilocarb batch includes both catalyzed and uncatalyzed batches. The percentages used in the examples, unless specified otherwise, are weight percents of the total batch, preform or structure.

### Example 1

A polysilocarb batch having 75% MH, 15% TV, 10% VT and 1% catalyst (10 ppm platinum and 0.5% Luprox 231 peroxide).

### Example 2

A polysilocarb batch having 70% MH, 20% TV, 10% VT and 1% catalyst (10 ppm platinum and 0.5% Luprox 231 peroxide).

### Example 3

A polysicocarb batch having 50% by volume fly ash is added to a polysilocarb batch having 70% MH, 20% TV, 10% VT and 1% catalyst (10 ppm platinum and 0.5% Luprox 231 peroxide).

### Example 4

40% by volume AL₂O₃ having a diameter of 0.5 μm is added to a polysilocarb batch having 70% MH, 20% TV, 10% VT and 1% catalyst (10 ppm platinum and 0.5% Luprox 231 peroxide).

### Example 5

A polysilocarb batch having 100% TV.

### Example 6

A polysilocarb batch having 10% of the MH precursor (molecular weight of about 800), 73% of the methyl terminated phenylethyl polysiloxane precursor (molecular weight of about 1,000), and 16% of the TV precursor, and 1% of the OH terminated.

### Example 7

A polysilocarb batch having 100% TV and less than about 0.5% peroxide catalysis.

### Example 8

A polysilocarb reaction blend batch having 85/15 MHF/PCPD.

### Example 9

A polysilocarb reaction blend batch having 85/15 MHF/PCPD with 1% P01 catalyst and 1% peroxide catalyst.

### Example 10

A polysilocarb reaction blend batch having 85/15 MHF/DCPD with 1% P01 catalyst and 3% TV (which functions as a curie rate accelerator).

### Example 11

A polysilocarb reaction blend batch having 65/35 MHF/PCPD.

### Example 12

A polysilocarb reaction blend batch having 70/30 MHF/PCPD.

### Example 13

A polysilocarb batch having 50-65% MHF; 5-10% Tetravinyl; and 25-40% Diene (Dene=Dicyclopentadiene or Isoprene or Butadiene), preferably catalyzed with P01 or other Platinum catalyst.

### Example 14

A polysilocarb batch having 60-80% MHF and 20-40% Isoprene, preferably catalyzed with P01 or other Platinum catalyst.

### Example 15

A polysilocarb batch having 50-65% MHF and 35-50% Tetravinyl, preferably catalyzed with P01 or other Platinum catalyst.

### Example 16

A polysilocarb reaction blend batch having 85/15 MHF/PCPD, and preferably using P01 and Luperox® 231 catalysts.

### Example 17

A polysilocarb reaction blend batch having 65/35 MHF/PCPD, and preferably using P01 and Luperox® 231 catalysts.

### Example 18

Using the reaction type process a precursor formulation was made using the following formulation. The temperature of the reaction was maintained at 72° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Methyltriethoxysilane (FIG. 37) | 0.00 | 0.0% | 178.30 | — | 0.00% | — | — |
| Phenylmethyldiethoxysilane | 0.00 | 0.0% | 210.35 | — | 0.00% | — | — |
| (FIG. 38) | | | | | | | |
| Dimethyldiethoxysilane (FIG. | 56 | 7.2% | 148.28 | 0.38 | 17.71% | 0.38 | 0.76 |
| 42) | | | | | | | |
| Methyldiethoxysilane (FIG. 39) | 182 | 23.2% | 134.25 | 1.36 | 63.57% | 1.36 | 2.71 |
| Vinylmethyldiethoxysilane | 64 | 8.2% | 160.29 | 0.40 | 18.72% | 0.40 | 0.80 |
| (FIG. 40) | | | | | | | |
| Triethoxysilane (FIG. 44) | 0.00 | 0.0% | 164.27 | — | 0.00% | — | — |
| Hexane in hydrolyzer | 0.00 | 0.0% | 86.18 | — | | | |
| Acetone in hydrolyzer | 0.00 | 0.0% | 58.08 | — | | | |
| Ethanol in hydrolyzer | 400.00 | 51.1% | 46.07 | 8.68 | | | |
| Water in hydrolyzer | 80.00 | 10.2% | 18.00 | 4.44 | | | |
| HCl | 0.36 | 0.0% | 36.00 | 0.01 | | | |
| Sodium bicarbonate | 0.84 | 0.1% | 84.00 | 0.01 | | | |

### Example 19

A polysilocarb formulation has 0-20% MHF, 0-30% TV, 50-100% H62 C and 0-5% a hydroxy terminated dimethyl polysiloxane.

### Example 20

A polysilocarb formulation has 40% MHF, 40% TV, and 20% VT and has a hydride to vinyl molar ratio of 1.12:1, and may be used as to form strong ceramic beads, e.g., proppants for use in hydraulically fracturing hydrocarbon producing formations.

### Example 21

A polysilocarb formulation has 42% MHF, 38% TV, and 20% VT and has a hydride to vinyl molar ratio of 1.26:1, and may be used as to form strong ceramic beads, e.g., proppants for use in hydraulically fracturing hydrocarbon producing formations.

### Example 22

A polysilocarb formulation has 55% MHF, 25% TV, and 20% VT and has a hydride to vinyl molar ratio of 2.36:1, and may be used as to form strong ceramic beads, e.g., proppants for use in hydraulically fracturing hydrocarbon producing formations.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

It is also noted that although the present specification focuses on small PDC volumetric shapes, to solve the long-standing need for methods and systems to obtain such articles, the systems, technologies and methods of the present specification can have application for larger shapes and structures. Thus, the scope of protection for the present inventions should not be limited to, and extend to and cover larger shapes and volumes, unless specially state otherwise.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and with existing equipment or activities which may be modified, in-part, based on the teachings of this specification. Further, the various embodiments set forth in this specification may be used with each other in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

What is claimed:

1. A system for making small volumetric structures from a polymer derived ceramic precursor, the system comprising:
a. a polymer derived ceramic precursor delivery apparatus, the apparatus comprising a chamber in fluid communication with a delivery port; wherein the chamber is capable of delivering a liquid polymer derived ceramic precursor;
b. a forming apparatus, the forming apparatus comprising a forming chamber having an opening; the chamber defining a cavity; wherein the cavity is in fluid communication with the chamber opening;
c. the chamber opening in fluid communication with the delivery port; whereby the system is capable of delivering the liquid polymer derived ceramic from the delivery port to the cavity as a liquid;
d. a temperature control apparatus thermally associated with the forming apparatus; wherein the cavity is capable of being maintained at a predetermined temperature; and,
e. whereby, the system is capable of providing a liquid polymer derived ceramic precursor to the cavity in a predetermined volumetric shape; and wherein the system is capable of curing the polymer derived ceramic precursor in the cavity.

2. The system of claim 1, wherein the delivery apparatus comprises a nozzle.

3. The system of claim 1, wherein the delivery apparatus comprises a pressure-driven droplet forming device

4. The system of claim 1, wherein the delivery apparatus comprises a flow driven droplet forming device.

5. The system of claim 1, wherein the delivery apparatus comprises an acoustic droplet ejection device.

6. The system of claim 1, wherein the forming apparatus comprises a shear induced droplet creation device.

7. The system of claim 1, wherein the delivery apparatus comprises a droplet creation device.

8. The system of claim 1, wherein the delivery apparatus comprises a droplet creation device; and the droplet creation device comprises an actuator; wherein the actuator is selected from the group consisting of piezo-electric, pressure reservoir, syringe, positive displacement, vibratory, electromagnetic, and phase change.

9. The system of claim 1, wherein the delivery apparatus comprises a droplet creation device selected from the group consisting of piezo-electric, pressure reservoir, syringe, positive displacement, vibratory, electromagnetic, and phase change.

10. The system of claim 1, wherein the forming apparatus comprises a droplet creation device.

11. The system of claim 1, wherein the forming apparatus comprises a droplet creation device; and the droplet creation device comprises an actuator; wherein the actuator is selected from the group consisting of piezo-electric, pressure reservoir, aerosol, syringe, positive displacement, vibratory, electromagnetic, and phase change.

12. The system of claim 1, wherein the forming apparatus comprises a droplet creation device selected from the group consisting of piezo-electric, pressure reservoir, syringe, aerosol, positive displacement, vibratory, electromagnetic, and phase change.

13. The system of claim 1, comprising a droplet creation device.

14. The system of claim 1, comprising a droplet creation device; and the droplet creation device comprises an actuator; wherein the actuator is selected from the group consisting of piezo-electric, pressure reservoir, syringe, positive displacement, aerosol, vibratory, electromagnetic, and phase change.

15. The system of claim 1, comprising a droplet creation device selected from the group consisting of piezo-electric, pressure reservoir, syringe, positive displacement, aerosol, vibratory, electromagnetic, and phase change.

16. The system of claim 1, comprising a droplet creation device selected from the group consisting of water-atomizer, gas-blast atomizer, atomizer, gas-assist atomizer, ultrasonic nebulizer, ultrasonic extruder, inkjet, and fogger.

17. The system of claim 1, wherein the port is configured to deliver a volumetric shape of precursor having a volume of less than about 0.25 inch³.

18. The system of claim 2, wherein the port is configured to deliver a volumetric shape of precursor having a volume of less than about 500 mm³.

19. The system of claim 3, wherein the port is configured to deliver a volumetric shape of precursor having a volume of less than about 100 mm³.

20. The system of claim 15 wherein, the port is configured to deliver a volumetric shape of precursor having a volume of less than about 4,000 microns³.

21. The system of claim 1, wherein the port is configured to deliver a volumetric shape of precursor having a volume of less than about 50 microns³.

22. The system of claim 1, wherein the delivery apparatus is configured to deliver a volumetric shape of precursor having a volume of less than about 0.25 inch³.

23. The system of claim 1, wherein the delivery apparatus is configured to deliver a volumetric shape of precursor having a volume of less than about 100 mm³.

24. The system of claim 10, wherein the delivery apparatus is configured to deliver a volumetric shape of precursor having a volume of less than about 50 microns³.

25. The system of claim 1, wherein the delivery apparatus is configured to deliver a volumetric shape of precursor having a volume of less than about 10 microns³.

26. The system of claim 1, wherein the forming apparatus is configured to cure a volumetric shape of precursor having a volume of less than about 0.25 inch³.

27. The system of claim 1, wherein the forming apparatus is configured to cure a volumetric shape of precursor having a volume of less than about 4,000 microns³.

28. The system of claim 1, wherein the forming apparatus comprises a forming liquid.

29. The system of claim 1, wherein the forming apparatus comprises a forming liquid consisting essentially of water and a surfactant.

30. The system of claim 1, wherein the forming apparatus comprises a forming liquid and a mixer.

31. The system of claim 1, wherein the temperature control apparatus comprises a controller for providing a predetermined temperature profile.

32. The system of claim 1, wherein the temperature control apparatus comprises a controller for providing a predetermined temperature profile, the temperature profile comprising a first heating rate, a first hold time, a second heating rate and a second hold time.

33. The system of claim 28, wherein the temperature control apparatus comprises a controller for providing a predetermined temperature profile, the temperature profile comprising a first heating rate, a first hold time, a second heating rate and a second hold time.

34. A system for making volumetric structures from a polymer derived ceramic precursor, the system comprising:
a. a polymer derived ceramic delivery apparatus, the apparatus comprising a liquid polymer derived ceramic precursor, a chamber and a port, wherein the chamber is capable of holding a liquid polymer derived ceramic precursor for delivery by the port into a volumetric shape having a predetermined volume;
b. a precursor solidifying apparatus, the solidifying apparatus comprising: a cavity; a temperature control apparatus; wherein the cavity is maintained at a predetermined temperature sufficient to cure the volumetric shape of polymer derived ceramic precursor to form a preform; and
c. the port in fluid communication with the cavity;
d. whereby, the system is capable of forming and curing the liquid polymer derived ceramic precursor into a predetermined volumetric shape structure.

35. The system of claim 34, comprising a droplet creation device selected from the group consisting of piezo-electric, pressure reservoir, syringe, aerosol, positive displacement, vibratory, electromagnetic, and phase change.

36. The system of claim 34, wherein the chamber is a tube.

37. The system of claim 34, wherein the port is a nozzle.

38. The system of claim 34, wherein the port is located inside of the cavity.

39. The system of claim 34, wherein the cavity contains a forming liquid.

40. The system of claim 34, wherein the cavity contains a forming liquid, having a surface; and the port is located below the surface.

41. The system of claim 34, wherein the volumetric shape is a shape selected from the group consisting of spheres, pellets, rings, lenses, and disks.

42. The system of claim 34, wherein the volumetric shape is a shape selected from the group consisting of channels, hollow sealed chambers, hollow spheres, blocks, sheets, and coatings.

43. The system of claim 34, configured to provide preforms having a predetermined size and to provide at least about 90% of the preforms at the predetermined size.

44. The system of claim 34, configured to provide preforms having a predetermined size and to provide at least about 95% of the preforms at the predetermined size.

45. The system of claim 34, configured to provide preforms having a predetermined size and to provide at least about 99% of the preforms at the predetermined size.

46. The system of claim 34, wherein the volumetric shape of precursor has a volume of less than about 0.25 inch³.

47. The system of claim 34, wherein the volumetric shape of precursor has a volume of less than about 500 mm³.

48. The system of claim 39, wherein the volumetric shape of precursor has a volume of less than about 100 mm³.

49. The system of claim 39, wherein the volumetric shape of precursor has a volume of less than about 4,000 microns³.

50. The system of claim 39, wherein the volumetric shape of precursor has a volume of less than about 10 microns³.

51. The system of claim 1, wherein the system comprises an extruder; wherein the delivery apparatus and the forming apparatus are components of the extruder.

52. The system of claim 34, wherein the system comprises an extruder; wherein the delivery apparatus and the solidifying apparatus are components of the extruder.

53. A system for making volumetric structures from a polymer derived ceramic precursor material, the system comprising:
a. a polymer derived ceramic delivery apparatus, the apparatus comprising a first chamber in fluid communication with a delivery port, and an amount of a liquid polymer derived ceramic precursor;
b. a forming and curing apparatus, the forming and curing apparatus comprising a forming chamber having an opening; and the chamber defining a cavity, wherein the cavity is in fluid communication with the chamber opening and contains a volumetric shape of a polymer derived ceramic precursor;
c. the chamber opening in fluid communication with the delivery port;
d. a temperature control source thermally associated with the forming apparatus; wherein the cavity is maintained at a predetermined temperature sufficient to cure the volumetric shape of the polymer derived ceramic precursor; and,
e. whereby, the system is capable of providing a liquid polymer derived ceramic precursor material into the cavity in a predetermined volumetric shape, and wherein the polymer derived ceramic precursor material is cured in the cavity.

54. The system of claim 53, wherein the liquid polymer derived ceramic precursor is selected from the group consisting of silanes, polysilanes, silazanes, polysilazanes, carbosilanes, polycarbosilanes, siloxanes, and polysiloxanes.

55. The system of claim 53, wherein the liquid polymer derived ceramic precursor is a polysilocarb.

56. The system of claim 53, wherein the liquid polymer derived ceramic precursor is a net polysilocarb.

57. The system of claim 53, wherein the liquid polymer derived ceramic precursor is a reinforced polysilocarb.

58. The system of claim 53, wherein the liquid polymer derived ceramic precursor comprises a polysilocarb and contains hydride groups.

59. The system of claim 53, wherein the liquid polymer derived ceramic precursor comprises a polysilocarb, is solvent free, and contains hydride groups.

60. The system of claim 53, wherein the liquid polymer derived ceramic precursor comprises a polysilocarb and contains vinyl groups.

61. The system of claim 53, wherein the liquid polymer derived ceramic precursor comprises a polysilocarb having hydride and vinyl groups and wherein the molar ratio of hydride groups to vinyl groups is about 1.50 to 1.

62. The system of claim 53, wherein the liquid polymer derived ceramic precursor comprises a polysilocarb having hydride and vinyl groups and wherein the molar ratio of hydride groups to vinyl groups is about 3.93 to 1.

63. The method of claim 53, wherein the liquid polymer derived ceramic precursor comprises a polysilocarb having hydride and vinyl groups and wherein the molar ratio of hydride groups to vinyl groups is about 1.75 to 1 to about 23.02 to 1.

64. A system for making small volumetric structures from a polymer derived ceramic precursor material, the system comprising:
a. a polymer derived ceramic delivery apparatus, the apparatus comprising a first chamber in fluid communication with a delivery port, and an amount of a liquid polymer derived ceramic precursor;
b. a forming apparatus, the forming apparatus comprising a chamber having an opening; and the chamber defining a cavity, wherein the cavity is in fluid communication with the chamber opening and contains a volumetric shape of a polymer derived ceramic precursor;
c. the chamber opening in fluid communication with the delivery port; and,
d. whereby, the system is capable of providing a liquid polymer derived ceramic precursor into the cavity.

65. The system of claim 64, wherein the liquid polymer derived ceramic precursor is selected from the group consisting of silanes, polysilanes, silazanes, polysilazanes, carbosilanes, polycarbosilanes, silazanes, polysilazanes, siloxanes, and polysiloxanes.

66. The system of claim 64, wherein the liquid polymer derived ceramic precursor is a polysilocarb.

67. The system of claims 66, wherein the volume is less than about 0.25 inch³.

68. The system of claims 66, wherein the volume is less than about 500 mm³.

69. The system of claims 66, wherein the volume is than about 50 microns³.

70. A system for making small volumetric structures from a polymer derived ceramic precursor, the system comprising:
a. a means for delivering a liquid polymer derived ceramic;
b. a forming apparatus, the forming apparatus comprising a forming chamber having an opening; and the chamber defining a cavity, wherein the cavity is in fluid communication with the chamber opening;
c. the chamber opening in fluid communication with the delivery means, whereby the delivery means is capable of delivering the liquid polymer derived ceramic into the cavity; and,
d. a temperature control source thermally associated with the forming apparatus, wherein the cavity is maintained at a predetermined temperature;
e. whereby, the system is capable of providing a liquid polymer derived ceramic precursor material into the cavity in a predetermined shape, and fixing the polymer derived ceramic in the predetermined shape; thereby making a volumetrically shaped polymer derived ceramic preform.

71. A system for making small volumetric structures from a polymer derived ceramic precursor, the system comprising:
a. a polymer derived ceramic delivery apparatus, the apparatus comprising a first chamber in fluid communication with a delivery port; wherein the first chamber is capable of holding a liquid polymer derived ceramic precursor;
b. a means for forming a volumetric shaped structure, the forming means comprising a forming chamber having an opening; and the chamber defining a cavity, wherein the cavity is in fluid communication with the chamber opening;
c. the chamber opening in fluid communication with the delivery port, whereby the system is capable of delivering the liquid polymer derived ceramic from the delivery port into the cavity, as a liquid;
d. a temperature control source thermally associated with the forming apparatus, wherein the cavity is maintained at a predetermined temperature; and,
e. whereby, the system is capable of providing a liquid polymer derived ceramic precursor material into the cavity in a predetermined volumetric shape, and wherein the polymer derived ceramic precursor material is cured in the cavity.

72. A system for making small volumetric structures from a polymer derived ceramic precursor, the system comprising:
a. a means for delivering a liquid polymer derived ceramic;
b. a means for forming a volumetric shaped structure, the forming means comprising a forming chamber having an opening; and the chamber defining a cavity, wherein the cavity is in fluid communication with the chamber opening;
c. the chamber opening in fluid communication with the delivery port, whereby the system is capable of delivering the liquid polymer derived ceramic from the delivery port into the cavity, as a liquid;
d. a temperature control source thermally associated with the forming apparatus, wherein the cavity is maintained at a predetermined temperature; and,
e. whereby, the system is capable of providing a liquid polymer derived ceramic precursor material into the cavity in a predetermined volumetric shape, and wherein the polymer derived ceramic precursor material is cured in the cavity.

73. A system for making small volumetric structures from a polymer derived ceramic precursor, the system comprising:
a. a means for forming a small volumetric shaped structure of polymer derived ceramic precursor; and,
b. a means for curing the small volumetric shaped structure of polymer derived ceramic precursor material into a volumetric shaped preform.

74. A system for making small volumetric structures from a polymer derived ceramic precursor, the system comprising:
a. a means for forming a small volumetric shaped structure of polymer derived ceramic precursor;
b. a means for curing the small volumetric shaped structure of polymer derived ceramic precursor material into a volumetric shaped preform; and,
c. a means for pyrolizing the preform.

75. A system for making small volumetric structures from a polymer derived ceramic precursor, the system comprising:
a. a liquid holding receptacle;
b. the liquid holding receptacle containing a forming liquid;
c. a precursor delivery apparatus, comprising a precursor, a channel, and a delivery port, the channel in fluid communication with the delivery port, whereby the precursor can be delivered from the delivery port; and,
d. the delivery port in fluid communication with the liquid holding receptacle.

76. A method for making small volumetric structures from a polymer derived ceramic precursor, the method comprising:
a. providing a liquid polymer derived ceramic precursor to a delivery apparatus, the apparatus comprising a chamber in fluid communication with a delivery port;
b. forming the liquid precursor into a predetermined liquid volumetric shape; and delivering the liquid volumetric shape to a chamber defining a cavity; and,
c. curing the liquid volumetric shape in the cavity to form a polymer derived ceramic preform.

77. The method of claim 76, wherein the preform is the same shape as the volumetric shape.

78. The method of claim 76, wherein the preform is substantially the same shape as the volumetric shape.

79. The method of claim 76, wherein the preform is green cured.

80. The method of claim 76, wherein the preform is hard cured.

81. The method of claim 76, wherein the preform is final cured.

82. The method of claim 76, comprising pyrolizing the preform to form a polymer derived ceramic.

83. The method of claim 76, wherein the delivery apparatus comprises a nozzle.

84. The method of claim 76, wherein in the forming of the volumetric shape comprising particle creation selected from the group of forming processes consisting of piezo-electric, pressure reservoir, syringe, positive displacement, aerosol, vibratory, electromagnetic, and phase change.

85. The methods of claim 76, wherein, the volumetric shape of precursor has a volume of less than about 0.25 inch³.

86. The methods of claim 76, wherein, the volumetric shape of precursor has a volume of less than about 50 microns³.

87. The methods of claim 76, wherein, the volumetric shape of precursor has a volume of less than about 10 microns³.

88. The method of claim 76, wherein the cavity comprises a forming liquid.

89. The method of claim 76, wherein the cavity comprises a forming liquid consisting essentially of water and a surfactant.

90. The method of claim 76, wherein the cavity comprises a forming liquid and a mixer.

91. The method of claim 76, wherein the cavity is an extruder cavity.

92. The method of claim 76, wherein the cure is conducted with a predetermined cure temperature profile.

93. The method of claim 76, wherein the cure is conducted with a predetermined cure temperature profile comprising a first heating rate, a first hold time, a second heating rate and a second hold time.

94. The method of claim 76, wherein the volumetric shape is a shape selected from the group consisting of spheres, pellets, rings, lenses, and disks.

95. The method of claim 76, wherein at least about 90% of the preforms are a predetermined size.

96. The method of claim 76, wherein at least about 95% of the preforms are a predetermined size.

97. The method of claim 76, wherein at least about 99% of the preforms are a predetermined size.

98. The method of claim 76, wherein the liquid polymer derived ceramic precursor is a polysilocarb.

99. The method of claim 76, wherein the liquid polymer derived ceramic precursor is a net polysilocarb.

100. The method of claim 76, wherein the liquid polymer derived ceramic precursor is a reinforced polysilocarb.

101. The method of claim 76, wherein the liquid polymer derived ceramic precursor comprises a polysilocarb and contains hydride groups.

102. The method of claim 76, wherein the liquid polymer derived ceramic precursor comprises a polysilocarb, is solvent free, and contains hydride groups.

103. The method of claim 76, wherein the liquid polymer derived ceramic precursor comprises a polysilocarb and contains vinyl groups.

104. The method of claim 76, wherein the liquid polymer derived ceramic precursor comprises a polysilocarb, is solvent free, and contains vinyl groups.

105. The method of claim 76, wherein the liquid polymer derived ceramic precursor comprises a polysilocarb having hydride and vinyl groups and wherein the molar ratio of hydride groups to vinyl groups is about 1.50 to 1.

106. The method of claim 76, wherein the liquid polymer derived ceramic precursor comprises a polysilocarb having hydride and vinyl groups and wherein the molar ratio of hydride groups to vinyl groups is about 3.93 to 1.

107. The method of claim 76, wherein the liquid polymer derived ceramic precursor comprises a polysilocarb having hydride and vinyl groups and wherein the molar ratio of hydride groups to vinyl groups is about 0.08 to 1 to about 1.82 to 1.

108. The method of claim 76, wherein the molar ratio of hydride groups to vinyl groups is about 1.12 to 1 to about 2.36 to 1.

109. The method of claim 76, wherein the molar ratio of hydride groups to vinyl groups is about 1.75 to 1 to about 23.02 to 1.

110. A method for making small volumetric structures from a polymer derived ceramic precursor, the system comprising:
a. a step for forming a liquid polymer derived ceramic to a liquid predetermined volumetric shape; and,
b. a step for curing the liquid predetermined volumetric shape into a preform having essentially the same volumetric shape.

111. A method for making small volumetric structures from a polymer derived ceramic precursor, the system comprising:
a. a step for forming a small volumetric shaped structure of polymer derived ceramic precursor;
b. a step for curing the small volumetric shaped structure of polymer derived ceramic precursor material into a volumetric shaped preform; and,
c. a step for pyrolizing the preform.

112. A method for making small volumetric structures from a polymer derived ceramic precursor, the system comprising:
a. forming a net small volumetric shaped structure of polymer derived ceramic precursor;
b. curing the net small volumetric shaped structure of polymer derived ceramic precursor material into a volumetric shaped preform; and,
c. pyrolizing the preform.

113. A method for making small volumetric structures from a polymer derived ceramic precursor, the system comprising:
a. providing a polymer derived ceramic precursor to a liquid holding receptacle;
b. the liquid holding receptacle containing a forming liquid;
c. the precursor forming essentially upon contact with the forming liquid a predetermined volumetric shape; and,
d. curing the volumetric shape to form a preform.

114. The method of claim 113, wherein the volumetric shape is a bead.

115. The method of claim 113, comprising pyrolizing the preform.

116. The method of claim 113, wherein the volumetric shape is a sphere and comprising pyrolizing the sphere.

117. A system for forming polymer derived ceramic platelets, the system comprising:
a. a means for forming a thin film of liquid polymer derived ceramic precursor material on a substrate means; and,
b. a means for providing electromagnetic radiation to the thin film of liquid polymer derived ceramic;

118. The system of claim 117, wherein the means for forming the thin film is a distribution header.

119. The system of claim 117, wherein the means for forming the thin film is a distribution roller assembly.

120. The system of claim 117, wherein the means for forming the thin film is an air knife assembly.

121. The system of claim 117, wherein the electromagnetic radiation is white light.

122. The system of claim 117, wherein the electromagnetic radiation is broad band light, having a wavelength band of at least about 100 nm, between the wavelengths of about 300 nm and about 800 nm.

123. A method of forming a cured polymer derived ceramic from a liquid polymer derived ceramic precursors, the method comprising:
a. a step for forming a thin layer of a liquid polymer derived ceramic precursor on a substrate; and,
b. a step for curing the thin layer with electromagnetic radiation.
